(19) United States
(12) Patent Application Publication
(10) Pub. No.: US 2010/0311903 A1
(43) Pub. Date: Dec. 9, 2010

(54) Photonic Shell-Core Cross Linked and Functionalized Nanostructures for Biological Applications

(76) Inventor: Raghavan Rajagopalan, St. Louis, MO (US)

Correspondence Address: Mallinckrodt Inc., 675 McDonnell Boulevard, HAZELWOOD, MO, 63042, US

(21) Appl. No.: 12/740,476

(22) PCT Filed: Nov. 7, 2008
(86) PCT No.: PCT/US08/12575

§ 371 Date: Apr. 29, 2010

Related U.S. Application Data
(60) Provisional application No. 60/986,171, filed on Nov. 7, 2007.
(60) Provisional application No. 61/106,842, filed on Oct. 20, 2008.

(51) Int. Cl. C08F 287/00

(52) U.S. Cl. 525/54.1; 525/375; 525/54.2; 977/773

(57) ABSTRACT

The present invention provides optical agents comprising optically functional cross linked supramolecular structures and assemblies useful for a range of imaging, diagnostic, and therapeutic applications. Supramolecular structures and assemblies of the present invention include optically functional shell-cross linked micelles wherein optical functionality is achieved via incorporation of one or more linking groups that include one or more photoactive moieties. The present invention further includes imaging, sensing and therapeutic methods using one or more optical agents of the present invention including optically functional shell cross-linked micelles. The present invention includes in situ monitoring methods, for example, wherein physical and/or structural changes in an optically functional shell-cross linked micelle generated in response to changes in chemical environment or physiological conditions causes a measurable change in the wavelengths or intensities of emission from the micelle.

### CROSS-REFERENCES TO RELATED APPLICATIONS

This application claims the benefit of U.S. Provisional Application Nos. 60/986,171 and 61/106,842, filed Nov. 7, 2007 and Oct. 20, 2008, respectively, which are incorporated by reference to the extent not inconsistent herewith.

### BACKGROUND

Self assembled nanostructures are a class of nanomaterials having chemical and physical properties potentially beneficial for biomedical applications. Amphiphilic polymer micelle supramolecular structures, for example, have been proposed as a versatile nanomaterials platform for encapsulating, solubilizing, and facilitating delivery of poorly water soluble drugs, including chemotherapeutic agents. Incorporation of targeting ligands into amphiphilic polymer micelle supramolecular structures has promise to provide an effective route for targeted delivery of pharmaceuticals to specific cell types, tissues and organs. Although use of micelle supramolecular structures for drug formulation and delivery applications is currently the subject of considerable research, the development of self assembled nanostructures for other biomedical applications is substantially less well developed.

Polymer micelle supramolecular structures are typically formed via entropically driven self assembly of amphiphilic polymers in a solution environment. For example, when block copolymers, having spatially segregated hydrophilic and hydrophobic domains are provided in aqueous solution at a concentration above critical micelle concentration (CMC) the polymers aggregate and self align such that hydrophobic domains form a central hydrophobic core and hydrophilic domains self align into an exterior hydrophilic corona region exposed to the aqueous phase. The core-corona structure of amphiphilic polymer micelles provides useful physical properties, as the hydrophobic core provides a shielded phase capable of solubilizing hydrophobic molecules, and the exterior corona region is at least partially solvated, thus imparting colloidal stability to these nanostructures.

A number of amphiphilic polymer systems, including block copolymers and cross linked block copolymer assemblies, have been specifically engineered and developed for biomedical applications, such as drug formulation and delivery applications. The following references provide examples of amphiphilic polymer drug delivery systems, including block copolymer drug delivery systems, which are hereby incorporate by reference in their entireties: (1) Li, Yali; Sun, Guorong; Xu, Jinqi; Wooley, Karen L., Shell Crosslinked Nanoparticles: a Progress Report on their Design for Drug Delivery; Nanotechnology in Therapeutics (2007), 381-407; (2) Qinggao Ma, Edward E. Remsen, Tomasz, Kowalewski, Jacob Schaefer, Karen Wooley Nano Lett. 2001, 1, 651 Jones, M.-C.; Leroux J.-C.; (3) “Polymeric Micelles: A New Generation of Colloidal Drug Carriers” Eur. J. Pharm. Biopharm. 1999, 48, 101-111; and (4) Kwon, G. S.; Naito, M.; Kataoka, K.; Yokoyama, M.; Sakurai, Y.; Okano, T. “Block Copolymer Micelles as Vehicles for Hydrophobic Drugs” Colloids and Surfaces, B: Biointerfaces 1994, 2, 429-34.

### SUMMARY

The present invention provides optical agents, including compositions, preparations and formulations, for imaging, visualization, diagnostic monitoring and phototherapeutic applications. Optical agents of the present invention include photonic nanostructures and nanoassemblies including supramolecular structures, such as shell-cross linked micelles, that incorporate at least one linking group comprising one or more photoactive moieties that provide functionality as exogenous agents for a range of biomedical applications. Optical agents of the present invention comprise supramolecular structures having linking groups imparting useful optical and structural functionality. In an embodiment, for example, the presence of linking groups function to covalently cross link polymer components to provide a cross linked shell stabilized supramolecular structure, and also impart useful optical functionality, for example by functioning as a chromophore, fluorophore, photosensitizer, and/or a photoreactive species. Some optical agents of the present invention further comprise one or more targeting ligands covalently or noncovalently associated with a photonic nanostructure or nanoassembly, thereby providing specificity for administering, targeting and/or localizing the optical agent to a specific biological environment, such as a specific organ, tissue, cell type or tumor site. Optical agents of the present invention optionally include bioconjugates.

Optical agents of the present invention are useful for a variety of in vivo, in vitro and ex vivo biomedical diagnostic, visualization and imaging applications, such as tomographic imaging, monitoring and evaluating organ functioning, anatomical visualization, coronary angiography, fluorescence endoscopy, and the detection and imaging of tumors. In an embodiment, for example, photonic nanostructures and nanoassemblies of the present invention comprising shell-cross linked micelles provide compositions for chemical and physiological sensing applications, for example, enabling the in situ monitoring of pH and/or the monitoring of organ function in a patient. Alternatively, photonic nanostructures and nanoassemblies of the present invention comprising shell-cross linked micelles provide organic optical probes and contrast agents for optical imaging methods, including multiphoton imaging, and photoacoustic imaging. Optical agents of the present invention are useful for a variety of therapeutic applications including phototherapeutic treatment methods, image guided surgery, administration and target specific delivery of therapeutic agents, and endoscopic procedures and therapies. In an embodiment, for example, photonic nanostructures and nanoassemblies of the present invention comprising shell-cross linked micelles provide optical agents for absorbing electromagnetic radiation provided to a target biological environment, organ or tissue, and transferring it internally to a phototherapeutic agent capable of providing a desired therapeutic effect.

In one aspect, the present invention provides an optical agent that includes a cross linked supramolecular structure having bifunctional linking groups for covalently cross linking polymer components and for providing useful optical functionality. An optical agent of this aspect comprises cross linked block copolymers, each of which comprises a hydrophilic block and a hydrophobic block. Further, the optical agent of this aspect comprises linking groups that covalently cross link at least a portion of the hydrophilic blocks of the block copolymers. With regard to some optical agents, at least a portion of the linking groups connecting hydrophilic blocks of the block copolymers include one or more photoactive moieties, such as fluorophores or photosensitizers capable of excitation in the visible region (e.g. 400 nm to 750 nm) and/or the near infrared region (e.g., 750-1300 nm). The compositions of block copolymer and linking group components are selected such that the optical agent forms a supramolecular structure in aqueous solution. This resulting supramolecular structure has an interior hydrophobic core that includes the hydrophobic blocks of the block copolymers. Also, the resulting supramolecular structure has a covalently cross linked hydrophilic shell that includes the hydrophilic blocks of the block copolymers. In an embodiment, the optical agent forms a supramolecular structure in aqueous solution comprising an optically functional micelle, a vesicle, a bilayer, a folded sheet, a tubular micelle, a toroidal micelle or a discoidal micelle. Optical agents of the present invention include, for example, shell-cross linked micelles, optionally having cross sectional dimensions selected from the range of 5 nanometers to 100 nanometers capable of functioning as a chromophore, fluorophore or phototherapeutic agent, and optionally capable of excitation in the visible region (e.g. 400 nm to 750 nm) and/or the near infrared region (e.g., 750-1300 nm). Selection of the physical dimensions of micelle-based optical agents of the present invention may be based on a number of factors such as, toxicity, immune response, biocompatibility and/or bioclearance considerations.

Selection of the composition of linking groups and extent of cross linking, at least in part, determines the optical, physical, physiological and chemical properties of supramolecular structures and assemblies of optical agents of the present invention, such as their excitation wavelengths, emission wavelengths, Stokes shifts, quantum yields, cross sectional dimensions, extent of cross linking, stability, biocompatibility, physiological clearance rate upon administration to a patient, etc. Useful photoactive moieties of the linking groups for optical agents of the present invention include dyes, fluorophores, chromophores, photosensitizers, photoreactive agents, phototherapeutic agents, and conjugates, complexes, fragments and derivatives thereof. In an embodiment, for example, the stoichiometric ratio of the linking groups to monomers of the hydrophilic blocks is selected over the range of 0.1:100 to 75:100, optionally 1:100 to 75:100, optionally 10:100 to 75:100 and optionally 30:100 to 75:100.

In an embodiment attractive for diagnostic, imaging and physiological sensing applications, at least a portion of the linking groups of the present optical agents comprise one or more chromophores and/or fluorophores. Useful linking groups of this aspect include visible dyes and/or near infrared dyes, including fluorescent dyes. In an embodiment, for example, the linking groups are chromophore and/or fluorophore functional groups capable of excitation upon absorption of electromagnetic radiation having wavelengths selected over the range of 400 nanometers to 1300 nanometers, and optionally capable of emission of electromagnetic radiation having wavelengths selected over the range of 400 nanometers to 1300 nanometers. Incorporation of linking groups that are excited upon absorption of electromagnetic radiation having wavelengths over the range of about 700 nanometers to about 1200 nanometers, optionally for some applications 400 nm to 900 nm, and optionally for some applications 700 nm to 900 nm, is particularly useful for certain diagnostic and therapeutic applications as electromagnetic radiation of these wavelengths is effectively transmitted by some biological samples and environments (e.g., biological tissue). In an embodiment, an optical agent of the invention includes one or more fluorophores having a Stokes shift selected over the range of, for example, 10 nanometers to 200 nanometers, optionally for some applications 20 nm to 200 nm, and optionally for some applications 50 nm to 200 nm. Useful photoactive moieties of the linking groups for optical agents of the present invention include, but are not limited to, a phenylxanthene, a phenothiazine, a phenoselenazine, a cyanine, an indocyanine, a squaraine, a dipyrrolo pyrimidone, an anthraquinone, a tetracene, a quinoline, a pyrazine, an acridine, an acridone, a phenanthridine, an azo dye, a rhodamine, a phenoxazine, an azulene, an azaazulene, a triphenyl methane dye, an indole, a benzoindole, an indocarbocyanine, a Nile Red dye, a benzoindocarbocyanine, and conjugates, complexes, fragments and derivatives thereof. In an embodiment, an optical agent of the present invention comprises a pyrazine-based linking group that cross links the hydrophilic blocks of the block copolymers, optionally a pyrazine-based amino linking group, such as a pyrazine-based diamino linking group or a pyrazine-based tetra amino linking group.

A range of linking chemistry is useful in the shell-cross linked supramolecular structures of optical agents of the present invention. Cross linking can be achieved, for example, via chemical reaction between the hydrophilic blocks of copolymers and cross linking reagents(s) containing one or more amine, imine, sulfhydryl, azide, carbonyl, imidoester, succinimidyl ester, carboxylic acid, hydroxyl, thiol, thiocyanate, acrylate, or halo group. Cross linking can be achieved, for example, via chemical reaction between cross linking reagents(s) and the hydrophilic block of the copolymer containing one or more monomers having one or more ester sites for conjugation to the linking group via amidation. In an embodiment the hydrophilic block of the copolymer includes N-acryloxysuccinimde monomers for conjugation to the linking groups. In some embodiments, for example, the hydrophilic block of the copolymers are cross linked via carboxamide or disulfide linkages between the at least a portion of the monomers of the hydrophilic blocks and the linking groups. Linking groups of the present invention optionally include spacer moieties, such as a C₁-C₃₀ poly(ethylene glycol) (PEG) spacer, or substituted or unsubstituted C₁-C₃₀ alkyl chain. Linking groups of the present invention optionally include one or more amino acid groups or derivatives thereof. In an embodiment, for example, an optical agent of the present invention incorporates linking groups having one or more basic amino acid groups or derivatives thereof including, but not limited to, arginine, lysine, histidine, ornithine, and homoarginine. Use of linking groups containing one or more basic amino acids is beneficial in the present invention for achieving high extents of cross linking between monomers of the hydrophilic groups of the block copolymers.

In an embodiment attractive for phototherapeutic applications, the photoactive moiety(ies) of the linking groups for the optical agents comprise(s) one or more photoreactive moieties such as phototherapeutic agents or precursors of phototherapeutic agents, optionally capable of excitation via absorption of electromagnetic radiation having wavelengths in the visible region (e.g. 400 nm to 750 nm) and/or the near infrared region (e.g., 750-1300 nm). In some embodiments, for example, the linking groups are capable of absorbing electromagnetic radiation and initiating a desired therapeutic effect such as the degradation of a tumor or other lesion. In an embodiment, for example, an optical agent of the present invention comprises linking groups containing one or more photosensitizer that absorbs visible or near infrared radiation and undergoes cleavage of photolabile bonds and/or energy transfer processes that generate reactive species (e.g., radicals, ions, nitrene, carbine etc.) capable of achieving a desired therapeutic effect. In an embodiment, an optical agent comprises a phototherapeutic agent comprising linking groups that generates reactive species (e.g., radicals, ions, nitrene, carbine etc.) upon absorption of electromagnetic radiation having wavelengths selected over the range of 700 nanometers to 1200 nanometers, optionally for some applications 400 nm to 900 nm, and optionally for some applications 700 nm to 900 nm.

Useful photoreactive moieties for linking groups of optical agents of this aspect of the present invention include, but are not limited to, Type-1 or Type-2 phototherapeutic agents such as: a cyanine, an indocyanine, a phthalocyanine, a rhodamine, a phenoxazine, a phenothiazine, a phenoselenazine, a fluorescein, a porphyrin, a benzoporphyrin, a squaraine, a corrin, a croconium, an azo dye, a methine dye, an indolenium dye, a halogen, an anthracyline, an azide, a C₁-C₂₀ peroxyalkyl, a C₁-C₂₀ peroxyaryl, a C₁-C₂₀ sulfenatoalkyl, a sulfenatoaryl, a diazo dye, a chlorine, a naphthalocyanine, a methylene blue, a chalcogenopyrylium analogue, and conjugates, complexes, fragments and derivatives thereof.

Selection of the composition of block copolymers in part determines the optical, physical, physiological and chemical properties of supramolecular structures and assemblies of optical agents of the present invention, such as the excitation wavelengths, emission wavelengths, Stokes shifts, quantum yields, cross sectional dimensions, extent of cross linking, stability, biocompatibility, physiological clearance rate upon administration to a patient etc. In an embodiment, the present invention provides an optical agent that is a supramolecular structure or assembly, such as a shell-cross linked micelle composition, wherein at least a portion of the polymer components comprise diblock copolymers each having a hydrophilic block directly or indirectly linked to a hydrophobic block. In the context of this description, directly linked refers to block copolymers wherein the hydrophilic and hydrophobic block are linked to each other directly via a covalent bond, and indirectly linked refers to block copolymers wherein the hydrophilic and hydrophobic block are linked to each other indirectly via a spacer or linking group. Hydrophilic blocks and hydrophobic blocks of block copolymers of the present invention can have a wide range of lengths, for example, lengths selected over the range of 10 to 250 monomers. Hydrophilic blocks of supramolecular structures and assemblies of the present optical agents are capable of effective cross linking between the block copolymers, for example using EDC (1-Ethyl-3-[3-dimethylaminopropyl]carbodiimide hydrochloride) coupling reactions or photoinitiated cross linking reactions. Useful hydrophilic blocks of optical agents of the present invention include, but are not limited to, a poly(acrylic acid) polymer block, a poly(N-(acryloyloxy)succinimide) polymer block; a poly(N-acryloylmorpholine) polymer block; a poly(ethylene glycol) polymer block, polyp-vinyl benzaldehyde) block and a poly(phenyl vinyl ketone) block; or a copolymer thereof. Useful hydrophobic blocks of optical agents of the present invention include, but are not limited to, a poly(p-hydroxystyrene) polymer block; a polystyrene polymer block; a polyacrylate polymer block, a poly(propylene glycol) polymer block; a poly(amino acid) polymer block; a poly(ester) polymer block; a poly (ε-caprolactone) polymer block, and a phospholipid; or a copolymer thereof.

Hydrophilic blocks and hydrophobic blocks of the present invention optionally have a composition specifically engineered to provide additional chemical and/or physical properties useful for selected biomedical applications, such as in situ sensing and monitoring of organ function or physiological condition(s). In an embodiment, the hydrophilic blocks, hydrophobic blocks or both of the block copolymers comprise functional groups responsive to a specific chemical environment or physiological state, such that the supramolecular structure undergoes a change in structure, such as swelling or contracting, in response to a change in the chemical environment or physiological state. In a specific optical agent of the present invention, for example, the hydrophilic block, hydrophobic block or both comprises one or more acidic or basic functional groups responsive to pH, wherein the supramolecular structure undergoes a change in volume in response to a change in the pH of the aqueous solution. This feature of the certain optical agents of the present invention is used in some methods for sensing and/or monitoring a chemical environment or physiological state, for example for in situ pH monitoring.

Optical agents of the present invention optionally include bioconjugates capable of targeted administration and delivery, such as tissue-specific, organ-specific, cell-specific and tumor-specific administration and delivery. In an embodiment, for example, an optical agent of the present invention further comprises one or more targeting ligands coupled to the supramolecular structure or assembly, such as a shell-cross linked micelle. Targeting ligands of the present invention may be covalently bonded to, or non-covalently associated with, the hydrophilic blocks of at least a portion of the block copolymers of the present optical agents. Useful targeting ligands include, but are not limited to, a peptide, a protein, an oligonucleotide, an antibody, carbohydrate, hormone, a lipid, a drug and conjugates, complexes, fragments and derivatives thereof.

Compositions of the invention include formulations and preparations comprising one or more of the present optical agents provided in an aqueous solution, such as a pharmaceutically acceptable formulation or preparation. Optionally, compositions of the present invention further comprise one or more pharmaceutically acceptable surfactants, buffers, electrolytes, salts, carriers and/or excipients. Optical agents of the present invention include supramolecular structures and assemblies, including shell-cross linked micelles, wherein a therapeutic agent is physically associated with or covalently linked to one or more of the blocks of the copolymers. In an embodiment, the optical agent of the present invention further comprises one or more therapeutic agents at least partially encapsulated by the supramolecular structure, such as a hydrophobic drug or combination of hydrophobic drugs, hydrophobic biologic agent, or hydrophobic phototherapeutic agent. The present invention includes, for example, optical agents wherein a therapeutic agent is non-covalently associated with the hydrophobic core. Therapeutic agents of this aspect of the present invention optionally include phototherapeutic agents, such as Type-1 or Type-2 phototherapeutic agents, or chemotherapy agents.

In another aspect, the present invention provides an optical imaging method. In this method, an effective amount of an optical agent of the present invention is administered to a mammal (e.g., a patient undergoing treatment). In this aspect, at least one photoactive moiety of the optical agent includes at least one chromophore and/or fluorophore, optionally capable of excitation via absorption of electromagnetic radiation having wavelengths in the visible region (e.g. 400 nm to 750 nm) and/or the near infrared region (e.g., 750-1300 nm). The optical agent that has been administered is exposed to electromagnetic radiation. Electromagnetic radiation transmitted, scattered or emitted by the optical agent is then detected. In some embodiments, fluorescence may be excited from the optical agent (e.g., due to the electromagnetic radiation exposure), optionally via multiphoton excitation processes. Use of electromagnetic radiation having wavelengths selected over the range of 400 nanometers to 1300 nanometers may be useful for some in situ optical imaging methods of the present invention, including biomedical applications for imaging organs, tissue and/or tumors, anatomical visualization, optical guided surgery and endoscopic procedures.

In another aspect, the present invention provides a method of providing photodynamic therapy. In this method, an effective amount of an optical agent of the present invention is administered to a mammal (e.g., a patient undergoing treatment). In this aspect, at least one photoactive moiety of the optical agent includes one or more phototherapeutic agents, optionally capable of excitation via absorption of electromagnetic radiation having wavelengths in the visible region (e.g. 400 nm to 750 nm) and/or the near infrared region (e.g., 750-1300 nm). The optical agent that has been administered is exposed to electromagnetic radiation. In some embodiments, the optical agent may be targeted to a selected organ, tissue or tumor site in the mammal, for example by incorporation of an appropriate targeting ligand in the optical agent. Use of electromagnetic radiation having wavelengths selected over the range of 400 nanometers to 1300 nanometers may be useful for some phototherapeutic treatment methods of the present invention. Exposure of the optical agent to electromagnetic radiation activates the phototherapeutic agent(s) causing, for example, release of the phototherapeutic agent and/or cleavage of one or more photolabile bonds of the phototherapeutic agent, thereby generating one or more reactive species (e.g., free radicals, ions etc.).

In another aspect, the present invention provides a method of monitoring a physiological state or condition. In this method, an effective amount of an optical agent of the present invention is administered to a mammal (e.g., a patient undergoing treatment). Further, the optical agent that has been administered is exposed to electromagnetic radiation. In addition, electromagnetic radiation transmitted, scattered or emitted by the optical agent is detected. In some embodiments, a change in the wavelengths or intensities of electromagnetic radiation emitted by the optical agent that has been administered to the mammal may be detected, measured and/or monitored as a function of time. In some embodiments, the hydrophilic block, hydrophobic block or both comprise(s) one or more functional groups responsive to pH, and wherein the supramolecular structure undergoes a change in structure in response to a change in a physiological condition or chemical environment that causes a measurable change in the intensities or wavelengths of electromagnetic radiation emitted by the optical agent administered to the mammal. In one embodiment, for example, the change in structure in response to the change in physiological condition or chemical environment quenches or enhances fluorescence of the optical agent, or alternatively changes the emission wavelengths of fluorescence of the optical agent. Methods of this aspect of the present invention include in situ pH monitoring methods and methods of monitoring renal function in the mammal, wherein the optical agent is cleared renally by the mammal.

In another aspect, the present invention provides a method for making an optical agent. In this method, a plurality of block copolymers are dissolved in aqueous solution, wherein each of the block copolymers comprises a hydrophilic block and a hydrophobic block, and wherein the block copolymers self assemble in the aqueous solution to form a supramolecular structure, such as a micelle structure. The block copolymers of the supramolecular structure are then contacted with a cross linking reagent comprising one or more photoactive moieties, optionally contacted with a pyrazine-based amino cross linker such as a pyrazine-based diamino or tetramino cross linker. Optionally, at least a portion of the monomers of the hydrophilic group comprise N-acryloxysuccinimide (NAS) monomers. Further, at least a portion of the hydrophilic blocks of the block copolymers of the supramolecular structure are cross linked via linking groups generated from the cross linking reagent, thereby making the optical agent. In some embodiments, the block copolymers self assemble in the aqueous solution to form a micelle structure, which is subsequently cross linked to form a shell-cross linked micelle. Optionally, the cross linking may be carried out via EDC coupling reactions or via photoinitiated cross linking reactions. Optionally, the cross linking may achieve an extent of cross linking of the hydrophilic blocks of the copolymers selected over the range of 1 to 75%, and optionally 20 to 75%. In some embodiments, the dissolving may be carried out at a pH greater than 7. In such embodiments, the pH of the block copolymers dissolved in the aqueous solution may be subsequently slowly decreased to a pH of about 7.

In another aspect, the invention provides an optical agent for use in a medical optical imaging procedure. In an embodiment, a procedure of the present invention comprises: (i) administering to a mammal an effective amount of the optical agent as described herein, wherein the one or more photoactive moieties comprise one or more chromophores and/or fluorophores; (ii) exposing the optical agent administered to the mammal to electromagnetic radiation; and (iii) detecting electromagnetic radiation transmitted, scattered or emitted by the optical agent.

In another aspect, the invention provides an optical agent for use in a medical photodynamic therapy procedure. In an embodiment, a procedure of the present invention comprises: (i) administering to a mammal an effective amount of the optical agent as described herein, wherein the one or more photoactive moieties comprise one or more phototherapeutic agents; and (ii) exposing the optical agent administered to the mammal to electromagnetic radiation.

In another aspect, the invention provides an optical agent for use in a medical procedure for monitoring a physiological state or condition. In an embodiment, a procedure of the present invention comprises: (i) administering to a mammal an effective amount of the optical agent as described herein; (ii) exposing the optical agent administered to the mammal to electromagnetic radiation; and (iii) detecting electromagnetic radiation transmitted, scattered or emitted by the optical agent.

In another aspect, the invention provides a shell-cross linked micelle comprising: (i) cross linked block copolymers, wherein each of the block copolymers comprises a poly(acrylic acid) polymer block directly or indirectly bonded to a hydrophobic block; and (ii) pyrazine-containing linking groups covalently cross linking at least a portion the poly(acrylic acid) polymer blocks of the block copolymers; wherein the pyrazine-containing linking groups are bound to monomers of the poly(acrylic acid) polymer block by carboxamide bonds. In an embodiment of this aspect, the mole ratio of the pyrazine-containing linking groups to monomers of the poly(acrylic acid) polymer block is selected over a range of 1:100 to 75:100.

### BRIEF DESCRIPTION OF THE FIGURES

FIG. 1 illustrates an example of SCK formation. Amphiphilic block copolymers self-assemble into micelles having a hydrophobic core. The block copolymers are then functionalized to form cross linking between the individual polymers. The cross linking of the copolymers forms a shell surrounding the hydrophobic core.

FIG. 2 provides examples of bifunctional optical probe moieties useful for photonic shell cross linking in the present methods and compositions.

FIG. 3 provides a schematic diagram illustrating a synthetic pathway for the formation of photonic shell containing SCKs via cross linking chemistry with a photonic linking group of the present invention.

FIG. 4A illustrates an exemplary photonic shell cross linked nanoparticle structure.

FIG. 4B illustrates effects of raising and/or lowering the pH on a photonic shell cross linked nanoparticle.

FIG. 5 shows assembly of micelles from poly(acrylic acid)-b-poly(p-hydroxystyrene) in water, with an adjustment of the solution pH, followed by the construction of pH-responsive SCKs upon shell crosslinking with fluorophores.

FIG. 6A shows a representative AFM image of a photonic SCK micelle of the present invention, having an average height of 8 nm. FIG. 6B shows the hydrodynamic diameter of 2 (left), 3 (middle), and 4 (right) as a function of pH. FIG. 6C shows normalized fluorescence emission of SCKs 3 and 4, and PAA/Xlinker as a function of pH. For each data set, the fluorescence intensity of the crosslinker as a small molecule is normalized to the value that would be observed for the crosslinker in solution at the concentration of crosslinker within the SCK shells.

FIG. 7 illustrates the swelling/deswelling of photonic SCKs as a function of pH.

FIG. 8 shows normalized fluorescence emission of SCKs 3 and 4 as a function of pH and fluorophore loading (left: 6.25 mol % pyrazine relative to acrylic acid residues, right: 12.5 mol % pyrazine relative to acrylic acid residues).

FIG. 9 depicts data showing the fluorescence measurements of II-a and II-b as a function of pH.

FIG. 10 depicts a synthetic scheme showing synthesis of Photonic Cross-Linker of Examples 1 and 2.

FIG. 11 depicts a synthetic scheme showing synthesis of Photonic Cross-Linker Example 3.

FIG. 12 depicts a synthetic scheme showing synthesis of Photonic Cross-Linker Example 4.

FIG. 13 depicts a synthetic scheme showing synthesis of Photonic Shell Cross-Linked Nanoparticle Example 5.

FIG. 14 depicts a synthetic scheme showing synthesis of Photonic Shell Cross-Linked Nanoparticle Example 6.

FIG. 15 depicts a synthetic scheme showing synthesis of Photonic Shell Cross-Linked Nanoparticle Example 7.

FIG. 16 depicts a synthetic scheme showing synthesis of Photonic Shell Cross-Linked Nanoparticle Example 8.

FIG. 17 depicts data showing the optical absorbance and fluorescence of Photonic Cross-Linker Example 2 as a function of pH.

FIG. 18 depicts data showing the optical absorbance and fluorescence of Shell Cross-Linked Nanoparticle Example 5 as a function of pH.

FIG. 19 depicts data showing the optical absorbance and fluorescence of Photonic Cross-Linker Example 3 as a function of pH.

FIG. 20 depicts data showing the optical absorbance and fluorescence of Shell Cross-Linked Nanoparticle Example 6 as a function of pH.

FIG. 21 depicts data showing the optical absorbance and fluorescence of Shell Cross-Linked Nanoparticle Example 7 as a function of pH.

FIG. 22 depicts data showing the optical absorbance and fluorescence of Shell Cross-Linked Nanoparticle Example 8 as a function of pH.

FIG. 23 provides TEM images of micelles generated from compounds 4 of Example 5 and vesicles generated from compound 5 of Example 5.

### DETAILED DESCRIPTION

In general the terms and phrases used herein have their art-recognized meaning, which can be found by reference to standard texts, journal references and contexts known to those skilled in the art. The following definitions are provided to clarify their specific use in the context of the invention.

“Optical agent” generally refers to compositions, preparations and/or formulations for coupling electromagnetic radiation into and/or out of an environment and/or sample. For some applications, for example, the present optical agents are administered to a biological environment or sample, such as a patient, mammal, an organ, tissue, tumor, tumor site, excised tissue or cell material, cell extract, and/or biological fluid, colloid and/or suspension, for coupling electromagnetic radiation into and/or out of a biological sample. In some embodiments, optical agents of the present invention absorb, transmit and/or scatter electromagnetic radiation provided to a biologic sample and/or biological environment. In some embodiments, optical agents of the present invention are excited by electromagnetic radiation provided to a biologic sample and/or biological environment, and emit electromagnetic radiation via fluorescence, phosphorescence, chemiluminescence and/or photoacoustic processes. In some embodiments, optical agents of the present invention absorb electromagnetic radiation provided to a biologic sample and/or biological environment, and become activated, for example via photofragmentation or other a photoinitiated chemical reaction, including photocleavage of one or more photolabile bonds or photofragmentation to generate reactive species such as nitrenes, carbine, free radicals and/or ions. In some embodiments, optical agents of the present invention absorb electromagnetic radiation provided to a biologic sample and/or biological environment and radiatively or nonradiatively transfer at least a portion of the absorbed energy to a moiety, molecule, complex or assembly in proximity.

Optical agents of the present invention include, but are not limited to, contrast agents, imaging agents, dyes, photosensitizer agents, photoactivators, and photoreactive agents; and conjugates, complexes, biconjugates, and derivatives thereof. Optical agents of the present invention include photonic nanostructures and nanoassemblies including supramolecular structures, such as micelles, shell-cross linked micelles, vesicles, bilayers, folded sheets and tubular micelles, that incorporate at least one linking groups comprising a photoactive moiety, such as a fluorophores, chromophores, photosensitizers, and photoreactive moiety.

“Supramolecular structure” refers to structures comprising an assembly of molecules that are covalently linked, physically associated or both covalently linked, and physically associated. Supramolecular structures include assemblies of molecules, such as amphiphilic polymers, including block copolymers having a hydrophilic block and hydrophobic group. In some supramolecular structures of the present invention, hydrophilic portions of the block copolymers are oriented outward toward a continuous aqueous phase and form a hydrophilic shell or corona phase, and hydrophobic portions of the block copolymers are oriented inward and form a hydrophobic inner core. Supramolecular structures of the present invention include, but are not limited to, micelles, vesicles, bilayers, folded sheets, tubular micelles, toroidal micelles and discoidal micelles. Supramolecular structures of the present invention include self assembled structures. Supramolecular structures include cross linked structures, such as shell-cross linked micelle structures.

“Polymer” refers to a molecule comprising a plurality of repeating chemical groups, typically referred to as monomers. Polymers may include any number of different monomer types provided in a well defined sequence or random distribution. A “copolymer”, also commonly referred to as a heteropolymer, is a polymer formed when two or more different types of monomers are linked in the same polymer. “Block copolymers” are a type of copolymer comprising blocks or spatially segregated domains, wherein different domains comprise different polymerized monomers having different compositions, chemical properties and/or physical properties. In a block copolymer, adjacent blocks are constitutionally different, i.e. adjacent blocks comprise constitutional units derived from different species of monomer or from the same species of monomer but with a different composition or sequence distribution of constitutional units. Different blocks (or domains) of a block copolymer may reside on different ends or the interior of a polymer (e.g. [A][B]), or may be provide in a selected sequence ([A][B][A][B]). “Diblock copolymer” refers to block copolymer having two different polymer blocks. “Triblock copolymer” refers to block copolymer having three different polymer blocks. “Polyblock copolymer” refers to block copolymer having at least two different polymer blocks, such as two, three, four, five etc. different polymer blocks. Optical agents of the present invention include supramolecular structures comprising diblock copolymers, triblock copolymers and polyblock copolymers. Optionally, block copolymers of the present invention comprise a PEG block (i.e., CH₂CH₂O)_{b}—).

“Photoactive moiety” generally refers to a component of a molecule having optical functionality. Photoactive moieties include, for example, functional groups and substituents that functioning as a fluorophore, a chromophore, a photosensitizer, and/or a photoreactive moiety in the present compositions and methods. Photoactive moieties are capable of undergoing a number of processes upon absorption of electromagnetic radiation including fluorescence, activation, cleavage of one or more photolabile bonds and energy transfer processes. Photoreactive in this context refers to compositions and components thereof that are activated by absorption of electromagnetic radiation and, subsequently undergo chemical reaction or energy transfer processes. The present invention includes optical agents comprising supramolecular structures, such as shell cross-linked micelles, having linking groups comprising photoactive moieties that are excited upon absorption of electromagnetic radiation having wavelengths in the visible region (e.g. 400 nm to 750 nm) and/or the near infrared region (e.g., 750-1300 nm).

As used herein “hydrophilic” refers to molecules and/or components (e.g., functional groups, monomers of block polymers etc.) of molecules having at least one hydrophilic group, and hydrophobic refers to molecules and/or components (e.g., functional groups of polymers, and monomers of block copolymers etc.) of molecules having at least one hydrophobic group. Hydrophilic molecules or components thereof tend to have ionic and/or polar groups, and hydrophobic molecules or components thereof tend to have nonionic and/or nonpolar groups. Hydrophilic molecules or components thereof tend to participate in stabilizing interactions with an aqueous solution, including hydrogen boding and dipole-dipole interactions. Hydrophobic molecules or components tend not to participate in stabilizing interactions with an aqueous solution and, thus often cluster together in an aqueous solution to achieve a more stable thermodynamic state. In the context of block copolymer of the present invention, a hydrophilic block is more hydrophilic than a hydrophobic group of an amphiphilic block copolymer, and a hydrophobic group is more hydrophobic than a hydrophilic block of an amphiphilic polymer.

“Targeting ligand” refers to a component that provides targeting and/or molecular recognition functionality. Targeting ligands useful in the present compositions and methods include one or more biomolecules or bioactive molecules, and fragments and/or derivatives thereof, such as hormones, amino acids, peptides, peptidomimetics, proteins, nucleosides, nucleotides, nucleic acids, enzymes, carbohydrates, glycomimetics, lipids, albumins, mono- and polyclonal antibodies, receptors, inclusion compounds such as cyclodextrins, and receptor binding molecules.

When used herein, the term “diagnosis”, “diagnostic” and other root word derivatives are as understood in the art and are further intended to include a general monitoring, characterizing and/or identifying a state of health or disease. The term is meant to encompass the concept of prognosis. For example, the diagnosis of cancer can include an initial determination and/or one or more subsequent assessments regardless of the outcome of a previous finding. The term does not necessarily imply a defined level of certainty regarding the prediction of a particular status or outcome.

As defined herein, “contacting” means that a compound used in the present invention is provided such that is capable of making physical contact with another element, such as a microorganism, a microbial culture or a substrate. In another embodiment, the term “contacting” means that the compound used in the present invention is introduced into a subject receiving treatment, and the compound is allowed to come in contact in vivo.

Alkyl groups include straight-chain, branched and cyclic alkyl groups. Alkyl groups include those having from 1 to 30 carbon atoms. Alkyl groups include small alkyl groups having 1 to 3 carbon atoms. Alkyl groups include medium length alkyl groups having from 4-10 carbon atoms. Alkyl groups include long alkyl groups having more than 10 carbon atoms, particularly those having 10-30 carbon atoms. Cyclic alkyl groups include those having one or more rings. Cyclic alkyl groups include those having a 3-, 4-, 5-, 6-, 7-, 8-, 9- or 10-member carbon ring and particularly those having a 3-, 4-, 5-, 6-, or 7-member ring. The carbon rings in cyclic alkyl groups can also carry alkyl groups. Cyclic alkyl groups can include bicyclic and tricyclic alkyl groups. Alkyl groups are optionally substituted. Substituted alkyl groups include among others those which are substituted with aryl groups, which in turn can be optionally substituted. Specific alkyl groups include methyl, ethyl, n-propyl, iso-propyl, cyclopropyl, n-butyl, s-butyl, t-butyl, cyclobutyl, n-pentyl, branched-pentyl, cyclopentyl, n-hexyl, branched hexyl, and cyclohexyl groups, all of which are optionally substituted. Substituted alkyl groups include fully halogenated or semihalogenated alkyl groups, such as alkyl groups having one or more hydrogens replaced with one or more fluorine atoms, chlorine atoms, bromine atoms and/or iodine atoms. Substituted alkyl groups include fully fluorinated or semifluorinated alkyl groups, such as alkyl groups having one or more hydrogens replaced with one or more fluorine atoms. An alkoxyl group is an alkyl group linked to oxygen and can be represented by the formula R—O.

Alkenyl groups include straight-chain, branched and cyclic alkenyl groups. Alkenyl groups include those having 1, 2 or more double bonds and those in which two or more of the double bonds are conjugated double bonds. Alkenyl groups include those having from 2 to 20 carbon atoms. Alkenyl groups include small alkenyl groups having 2 to 3 carbon atoms. Alkenyl groups include medium length alkenyl groups having from 4-10 carbon atoms. Alkenyl groups include long alkenyl groups having more than 10 carbon atoms, particularly those having 10-20 carbon atoms. Cyclic alkenyl groups include those having one or more rings. Cyclic alkenyl groups include those in which a double bond is in the ring or in an alkenyl group attached to a ring. Cyclic alkenyl groups include those having a 3-, 4-, 5-, 6-, 7-, 8-, 9- or 10-member carbon ring and particularly those having a 3-, 4-, 5-, 6- or 7-member ring. The carbon rings in cyclic alkenyl groups can also carry alkyl groups. Cyclic alkenyl groups can include bicyclic and tricyclic alkyl groups. Alkenyl groups are optionally substituted. Substituted alkenyl groups include among others those which are substituted with alkyl or aryl groups, which groups in turn can be optionally substituted. Specific alkenyl groups include ethenyl, prop-1-enyl, prop-2-enyl, cycloprop-1-enyl, but-1-enyl, but-2-enyl, cyclobut-1-enyl, cyclobut-2-enyl, pent-1-enyl, pent-2-enyl, branched pentenyl, cyclopent-1-enyl, hex-1-enyl, branched hexenyl, cyclohexenyl, all of which are optionally substituted. Substituted alkenyl groups include fully halogenated or semihalogenated alkenyl groups, such as alkenyl groups having one or more hydrogens replaced with one or more fluorine atoms, chlorine atoms, bromine atoms and/or iodine atoms. Substituted alkenyl groups include fully fluorinated or semifluorinated alkenyl groups, such as alkenyl groups having one or more hydrogens replaced with one or more fluorine atoms.

Aryl groups include groups having one or more 5- or 6-member aromatic or heteroaromatic rings. Aryl groups can contain one or more fused aromatic rings. Heteroaromatic rings can include one or more N, O, or S atoms in the ring. Heteroaromatic rings can include those with one, two or three N, those with one or two 0, and those with one or two S, or combinations of one or two or three N, O or S. Aryl groups are optionally substituted. Substituted aryl groups include among others those which are substituted with alkyl or alkenyl groups, which groups in turn can be optionally substituted. Specific aryl groups include phenyl groups, biphenyl groups, pyridinyl groups, and naphthyl groups, all of which are optionally substituted. Substituted aryl groups include fully halogenated or semihalogenated aryl groups, such as aryl groups having one or more hydrogens replaced with one or more fluorine atoms, chlorine atoms, bromine atoms and/or iodine atoms. Substituted aryl groups include fully fluorinated or semifluorinated aryl groups, such as aryl groups having one or more hydrogens replaced with one or more fluorine atoms.

Arylalkyl groups are alkyl groups substituted with one or more aryl groups wherein the alkyl groups optionally carry additional substituents and the aryl groups are optionally substituted. Specific alkylaryl groups are phenyl-substituted alkyl groups, e.g., phenylmethyl groups. Alkylaryl groups are alternatively described as aryl groups substituted with one or more alkyl groups wherein the alkyl groups optionally carry additional substituents and the aryl groups are optionally substituted. Specific alkylaryl groups are alkyl-substituted phenyl groups such as methylphenyl. Substituted arylalkyl groups include fully halogenated or semihalogenated arylalkyl groups, such as arylalkyl groups having one or more alkyl and/or aryl having one or more hydrogens replaced with one or more fluorine atoms, chlorine atoms, bromine atoms and/or iodine atoms.

Optional substitution of any alkyl, alkenyl and aryl groups includes substitution with one or more of the following substituents: halogens, —CN, —COOR, —OR, —COR, —OCOOR, —CON(R)₂, —OCON(R)₂, —N(R)₂, —NO₂, —SR, —SO₂R, —SO₂N(R)₂ or —SOR groups. Optional substitution of alkyl groups includes substitution with one or more alkenyl groups, aryl groups or both, wherein the alkenyl groups or aryl groups are optionally substituted. Optional substitution of alkenyl groups includes substitution with one or more alkyl groups, aryl groups, or both, wherein the alkyl groups or aryl groups are optionally substituted. Optional substitution of aryl groups includes substitution of the aryl ring with one or more alkyl groups, alkenyl groups, or both, wherein the alkyl groups or alkenyl groups are optionally substituted.

Optional substituents for alkyl, alkenyl and aryl groups include among others:
—COOR where R is a hydrogen or an alkyl group or an aryl group and more specifically where R is methyl, ethyl, propyl, butyl, or phenyl groups all of which are optionally substituted;
—COR where R is a hydrogen, or an alkyl group or an aryl groups and more specifically where R is methyl, ethyl, propyl, butyl, or phenyl groups all of which groups are optionally substituted;
—CON(R)₂ where each R, independently of each other R, is a hydrogen or an alkyl group or an aryl group and more specifically where R is methyl, ethyl, propyl, butyl, or phenyl groups all of which groups are optionally substituted; R and R can form a ring which may contain one or more double bonds;
—OCON(R)₂ where each R, independently of each other R, is a hydrogen or an alkyl group or an aryl group and more specifically where R is methyl, ethyl, propyl, butyl, or phenyl groups all of which groups are optionally substituted; R and R can form a ring which may contain one or more double bonds;
—N(R)₂ where each R, independently of each other R, is a hydrogen, or an alkyl group, acyl group or an aryl group and more specifically where R is methyl, ethyl, propyl, butyl, or phenyl or acetyl groups all of which are optionally substituted; or R and R can form a ring which may contain one or more double bonds.
—SR, —SO₂R, or —SOR where R is an alkyl group or an aryl groups and more specifically where R is methyl, ethyl, propyl, butyl, phenyl groups all of which are optionally substituted; for —SR, R can be hydrogen;
—OCOOR where R is an alkyl group or an aryl groups;
—SO₂N(R)₂ where R is a hydrogen, an alkyl group, or an aryl group and R and R can form a ring;
—OR where R═H, alkyl, aryl, or acyl; for example, R can be an acyl yielding —OCOR* where R* is a hydrogen or an alkyl group or an aryl group and more specifically where R* is methyl, ethyl, propyl, butyl, or phenyl groups all of which groups are optionally substituted;

Specific substituted alkyl groups include haloalkyl groups, particularly trihalomethyl groups and specifically trifluoromethyl groups. Specific substituted aryl groups include mono-, di-, tri, tetra- and pentahalo-substituted phenyl groups; mono-, di-, tri-, tetra-, penta-, hexa-, and hepta-halo-substituted naphthalene groups; 3- or 4-halo-substituted phenyl groups, 3- or 4-alkyl-substituted phenyl groups, 3- or 4-alkoxy-substituted phenyl groups, 3- or 4-RCO-substituted phenyl, 5- or 6-halo-substituted naphthalene groups. More specifically, substituted aryl groups include acetylphenyl groups, particularly 4-acetylphenyl groups; fluorophenyl groups, particularly 3-fluorophenyl and 4-fluorophenyl groups; chlorophenyl groups, particularly 3-chlorophenyl and 4-chlorophenyl groups; methylphenyl groups, particularly 4-methylphenyl groups, and methoxyphenyl groups, particularly 4-methoxyphenyl groups.

As used herein, the term “alkylene” refers to a divalent radical derived from an alkyl group as defined herein. Alkylene groups in some embodiments function as bridging and/or spacer groups in the present compositions.

As used herein, the term “cycloalkylene” refers to a divalent radical derived from a cycloalkyl group as defined herein. Cycloalkylene groups in some embodiments function as bridging and/or spacer groups in the present compositions.

As used herein, the term “alkenylene” refers to a divalent radical derived from an alkenyl group as defined herein. Alkenylene groups in some embodiments function as bridging and/or spacer groups in the present compositions.

As used herein, the term “cylcoalkenylene” refers to a divalent radical derived from a cylcoalkenyl group as defined herein. Cycloalkenylene groups in some embodiments function as bridging and/or spacer groups in the present compositions.

As used herein, the term “alkynylene” refers to a divalent radical derived from an alkynyl group as defined herein. Alkynylene groups in some embodiments function as bridging and/or spacer groups in the present compositions.

As to any of the above groups which contain one or more substituents, it is understood, that such groups do not contain any substitution or substitution patterns which are sterically impractical and/or synthetically non-feasible. In addition, the compounds of this invention include all stereochemical isomers arising from the substitution of these compounds.

Pharmaceutically acceptable salts comprise pharmaceutically-acceptable anions and/or cations. Pharmaceutically-acceptable cations include among others, alkali metal cations (e.g., Li⁺, Na⁺, K⁺), alkaline earth metal cations (e.g., Ca²⁺, Mg²⁺), non-toxic heavy metal cations and ammonium (NH₄⁺) and substituted ammonium (N(R′)₄⁺, where R′ is hydrogen, alkyl, or substituted alkyl, i.e., including, methyl, ethyl, or hydroxyethyl, specifically, trimethyl ammonium, triethyl ammonium, and triethanol ammonium cations). Pharmaceutically-acceptable anions include among other halides (e.g., Cl⁻, Br⁻), sulfate, acetates (e.g., acetate, trifluoroacetate), ascorbates, aspartates, benzoates, citrates, and lactate.

The compounds of this invention may contain one or more chiral centers. Accordingly, this invention is intended to include racemic mixtures, diasteromers, enantiomers and mixture enriched in one or more steroisomer. The scope of the invention as described and claimed encompasses the racemic forms of the compounds as well as the individual enantiomers and non-racemic mixtures thereof.

Many of the compositions described herein are at least partially present as an ion when provided in solution and as will be understood by those having skill in the art the present compositions include these partially or fully ionic forms. A specific example relates to acidic and basic groups, for example on the polymer back bone of block copolymers and in linking groups, that will be in an equilibrium in solution with respect to ionic and non-ionic forms. The compositions and formula provided herein include all fully and partially ionic forms that would be present in solution conditions of pH ranging from 1-14, and optionally pH ranging from 3-12 and optionally pH ranging from 6-8. The compositions and formula provided herein include all fully and partially ionic forms that would be present under physiological conditions.

Before the present methods are described, it is understood that this invention is not limited to the particular methodology, protocols, cell lines, and reagents described, as these may vary. It is also to be understood that the terminology used herein is for the purpose of describing particular embodiments only, and is not intended to limit the scope of the present invention which will be limited only by the appended claims.

It must be noted that as used herein and in the appended claims, the singular forms “a”, “an”, and “the” include plural reference unless the context clearly dictates otherwise. Thus, for example, reference to “a cell” includes a plurality of such cells and equivalents thereof known to those skilled in the art, and so forth. As well, the terms “a” (or “an”), “one or more” and “at least one” can be used interchangeably herein. It is also to be noted that the terms “comprising”, “including”, and “having” can be used interchangeably.

As used herein, the term “treating” includes preventative as well as disorder remittent treatment. As used herein, the terms “reducing”, “suppressing” and “inhibiting” have their commonly understood meaning of lessening or decreasing.

In certain embodiments, the present invention encompasses administering optical agents useful in the present invention to a patient or subject. A “patient” or “subject”, used equivalently herein, refers to an animal. In particular, an animal refers to a mammal, preferably a human. The subject either: (1) has a condition remediable or treatable by administration of an optical agent of the invention; or (2) is susceptible to a condition that is preventable by administering an optical agent of this invention.

Unless defined otherwise, all technical and scientific terms used herein have the same meanings as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated herein by reference for the purpose of describing and disclosing the chemicals, cell lines, vectors, animals, instruments, statistical analysis and methodologies which are reported in the publications which might be used in connection with the invention. Nothing herein is to be construed as an admission that the invention is not entitled to antedate such disclosure by virtue of prior invention.

This invention disclosure relates to the generally to the concept of integrating photoactive molecules (e.g., fluorophores, chromophores, photosensitizers and photoreactive functionalities) into polymer micelles through physical association and covalent cross linking chemistry. The resulting nanosystems are useful for in vivo imaging, visualization, monitoring and phototherapy applications.

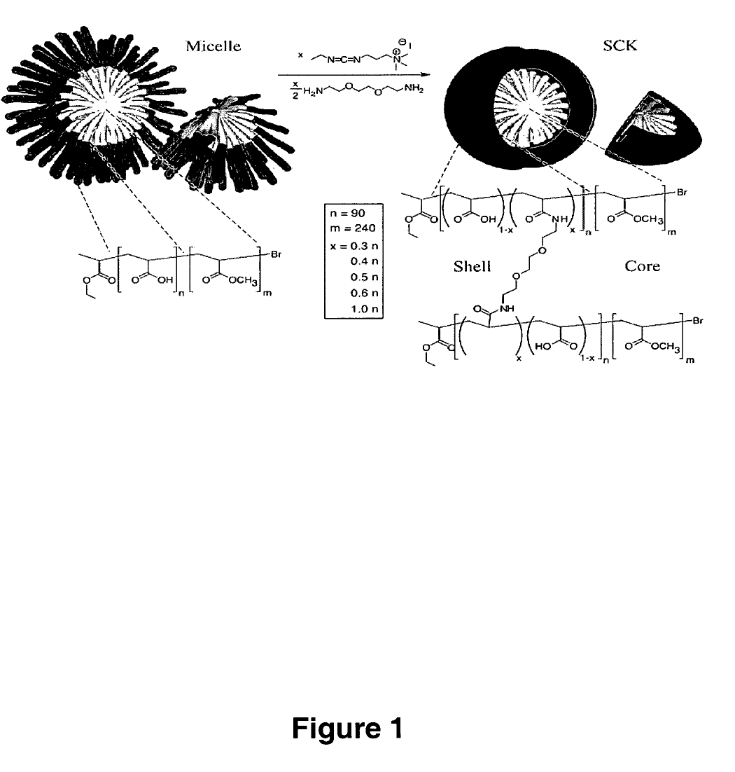

A body of research now exists regarding the supramolecular assembly of amphiphilic block copolymers into micelles which can be covalently shell-cross linked (SCK) to form core-shell type nanoparticles. FIG. 1 provides a schematic representation showing an example of the formation of a shell-cross linked micelle structure. Aspects of the present invention include the chemical nature of the block copolymers used to form the precursor micelles and the corresponding contributions to the overall morphology and environmental responsiveness of the resulting SCK. Further synthetic elaboration of these systems can be accomplished in a pre- or post-SCK fashion with incorporation of tissue targeting and/or imaging appendages on the exterior of the nanostructure. In addition, chemistry has been developed to attach functionality within the excavated core of SCK nanoparticles.

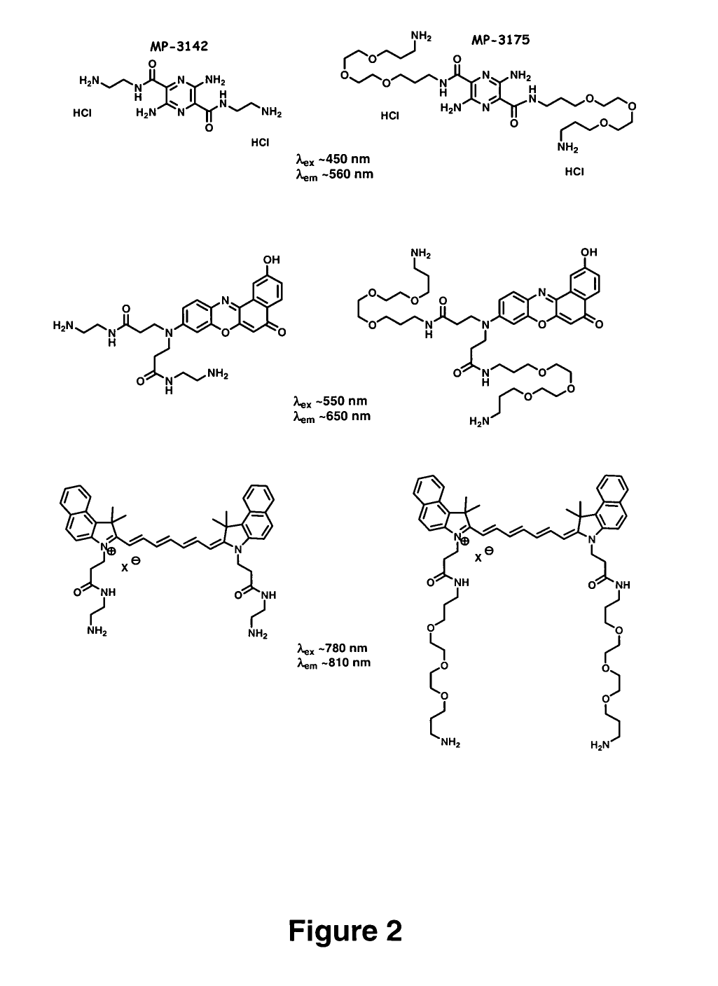

The methods and compositions of the present invention uses bi-functional optical probe molecules as photonic linkage systems for the micelle cross linking step in SCK formation. The resultant SCK nanostructures have a covalently stabilized shell that contains a specified number of copies of the optical probe. The optical probe molecule can be varied extensively, for example, from bifunctional pyrazines, to Nile Red derivatives, to indocyanine derivatives to cover yellow-green to red to NIR excitation and emission, respectively. FIG. 2 provides examples of bifunctional optical probes moieties for photonic shell cross linking in the present methods and compositions.

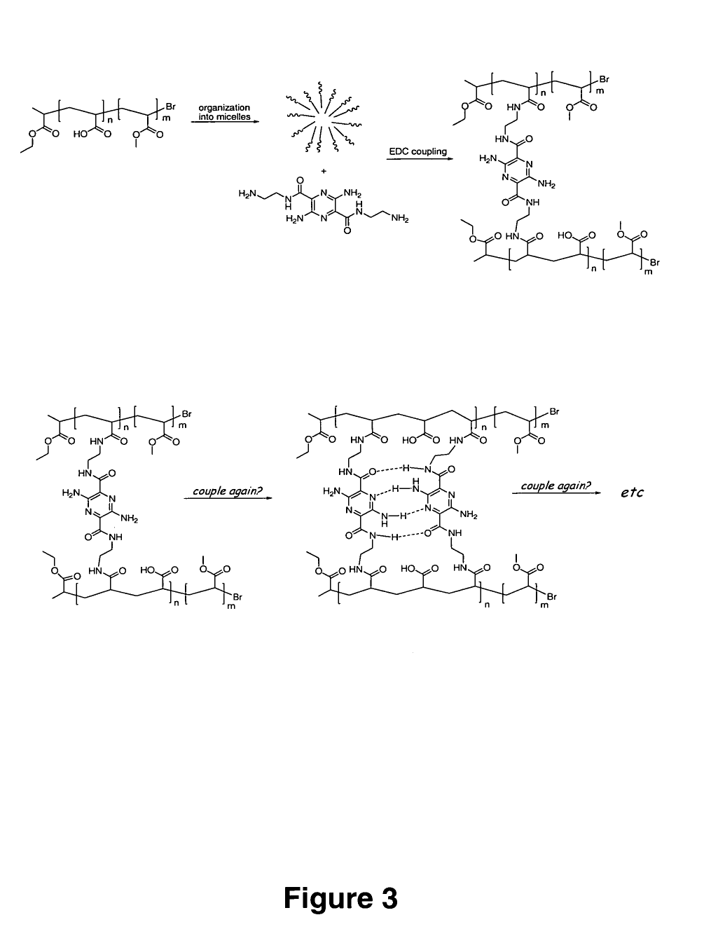

FIG. 3 provides a schematic diagram illustrating a synthetic pathway for the formation of photonic shell containing SCKs via cross linking chemistry with a linking group of the present invention.

The present photonic nanosystems and compositions thereof enable a number of potential biomedical uses.

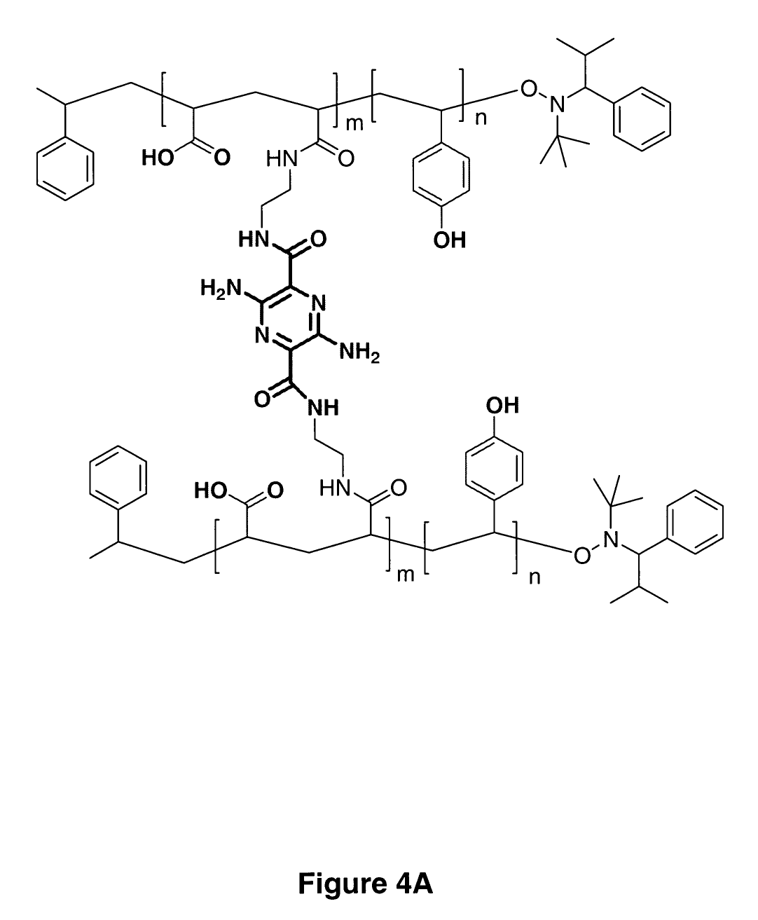

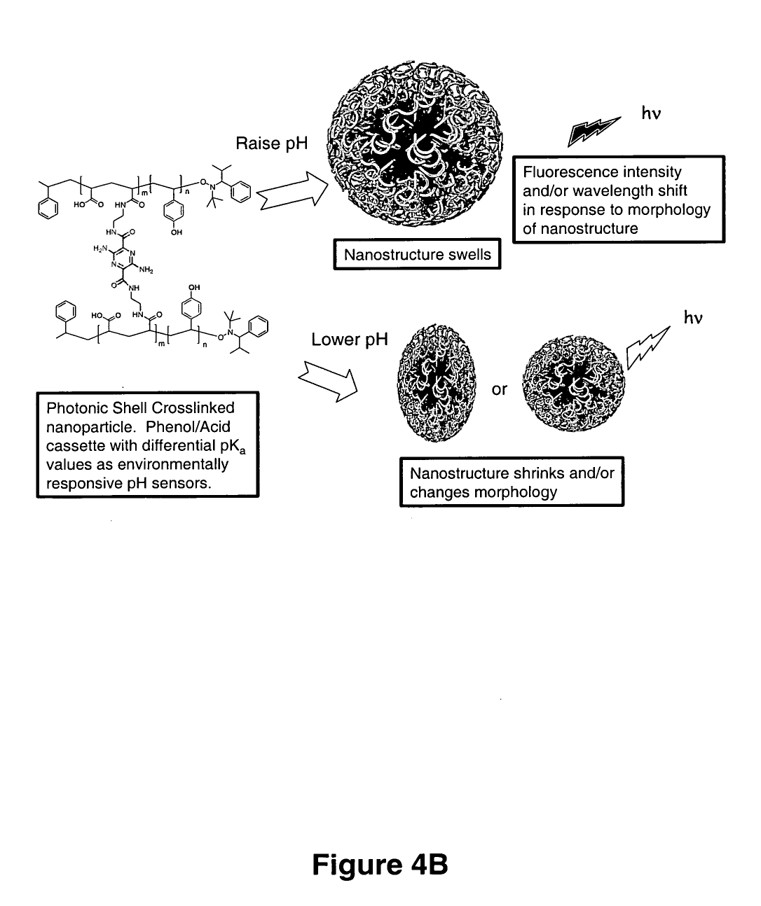

In an embodiment, photonic nanosystems and compositions thereof enable chemical and/or physiological sensors and sensing methods. In some embodiments, block copolymer micelle systems are used that respond morphologically to pH (e.g., swell at high pH and shrink at low pH) through the incorporation of functionality of differential pKa (e.g., phenol/carboxylate cassette). Photophysical consequences of these changes in morphology are manifested as “fluorescence on” at higher pH's and “fluorescence off” at lower due to proximity quenching. In an alternatively embodiment, photophysical consequences of these changes in morphology are manifested as the shifting of emission maxima as a function of nanostructure morphology enabling ratiometric pH measurement. The pyrazines are quadrupoles and display photophysical characteristics that are fairly insensitive to pH changes, thus the resulting photophysical changes will be a function of nanostructure morphology alone. The Nile Red analogues are dipoles and highly sensitive to solvent and potentially pH, thus the resulting photophysical changes are a function of both the morphology of the nanostructure and the local internal environment of the covalently linked probe. FIG. 4A illustrates an exemplary photonic shell cross linked nanoparticle structure for this application. FIG. 4B schematically illustrates the effects of raising and/or lowering the pH on a photonic shell cross linked nanoparticle.

In an embodiment, photonic nanosystems and compositions thereof provide optical imaging agents, including optical probes with organized photonic shell architecture. Aspects of the present invention useful for this application of the present compositions include (i) the potential for providing an increase the in vivo sensitivity of the nanostructure over that of small molecule probes; (ii) the potential ability to organize the shell-dye arrangement to increase fluorescence and/or induce useful shifts in wavelength; (iii) the potential capability to simulate a quantum dot semiconductor system with this organic nanostructure; and (iv) the potential quadrupolar nature of the pyrazines to induce two photon fluorescence for deeper tissue penetration and better spatial resolution with properties enhanced by the nanoarchitecture.

In an embodiment, photonic nanosystems and compositions thereof provide carriers and antennae for Type I Phototherapeutic Agents. In an embodiment of this aspect, the photonic shell of the present photonic nanosystems and compositions is used as an “Antenna/Transducer” for absorbing the appropriate laser irradiation and transferring it internally (via FRET) to type I phototherapeutic warheads that are either physically associated with the shell and/or core of the structures or covalently attached either through stable or photolabile bonds. The type I phototherapeutic warheads may be conjugatable derivatives of agents that decompose to cytotoxic reactive intermediates upon laser irradiation. The nanoparticle strategy allows the delivery of large doses in vivo. In addition, these nanophototherapeutics can be targeted with the appropriate exteriorly displayed ligand to the desired location (e.g. AᵥBₓ, A₅B₁, Bombesin, EGF, VEGF, etc).

In an embodiment, photonic nanosystems and compositions thereof provide photoacoustic imaging and therapy agents. In an embodiment of this aspect, the photonic shell SCKs provide organic optical probes for photoacoustic imaging and therapy. The photonic shells containing many copies of longer wavelength probes (cypate analogues) may be tuned to provide the enhanced cross-sections for absorption based photoacoustic methods.

The present invention provides optical agents comprising optically functional cross linked supramolecular structures and assemblies useful for a range of imaging, diagnostic, and therapeutic applications. Supramolecular structures and assemblies of the present invention include optically functional shell-cross linked micelles wherein optical functionality is achieved via incorporation of one or more linking groups comprising photoactive moieties. The present invention further includes imaging, sensing and therapeutic methods using one or more optical agents of the present invention including optically functional shell cross-linked micelles. The present invention includes in situ monitoring methods, for example, wherein physical and/or structural changes in an optically functional shell-cross linked micelle generated in response to changes in chemical environment or physiological conditions causes a measurable change in the wavelengths or intensities of emission from the micelle.

In an aspect, the present invention provides an optical agent comprising an optically functional shell-cross linked micelle, comprising: (i) a plurality of cross linked block copolymers, wherein each of the block copolymers comprises a hydrophilic block and a hydrophobic block; and (ii) a plurality of linking groups covalently cross linking at least a portion the hydrophilic blocks of the block copolymers, wherein at least a portion of the linking groups comprise one or more photoactive moieties, such as such as chromophores, fluorophores and/or photothereapeutic agents. The optically functional shell-cross linked micelle has an interior hydrophobic core comprising the hydrophobic blocks of the block copolymers and a covalently cross linked hydrophilic shell comprising the hydrophilic blocks of the block copolymers. Optionally, the extent of cross linking in the cross linked micelle is selected over the range of 1% to 75% of the monomers of the hydrophilic blocks of the block copolymers, and optionally 10 to 75% of the monomers of the hydrophilic blocks of the block copolymers.

An optically functional shell-cross linked micelle composition useful for biomedical applications, for example, comprise block copolymers having poly(acrylic acid) polymer hydrophilic block, optionally having between 20-250 monomer units. In an embodiment, for example, linking groups comprising one or more photoactive moieties are bound to at least a portion of the monomers of the poly(acrylic acid) polymer block by carboxamide bonds.

In an embodiment, at least a portion of the hydrophilic blocks of the block copolymers comprise monomers bound to linking groups having the formula:

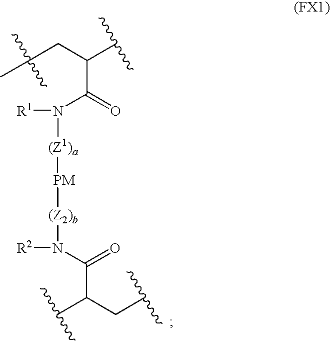

wherein PM is the linking group; wherein each of R¹ and R² is independently selected from the group consisting of —R, —COOR, —COR, —CON(R)₂, —OCON(R)₂, —N(R)₂, —SR, —SO₂R, —SOR, —OCOOR, —SO₂N(R)₂, and —OR; R is selected from the group consisting of a hydrogen, C₁-C₂₀ alkyl, C₅-C₂₀ aryl, C₁-C₂₀ carbonyl, C₂-C₂₀ alkenyl, C₂-C₂₀ alkynyl, C₅-C₂₀ alkylaryl, C₁-C₂₀ alkoxy, halo, amine, amide, hydroxyl, carboxyl, cyano, a nitrile group, an azide group, a nitro group, an acyl group, a thiol group or a natural or non-natural amino acid or fragment (e.g., side chain) thereof;

each of Z¹ and Z² is independently

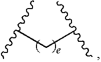

wherein one or more CH₂ groups may be replaced by NH, O, S, a carbonyl (C═O), or a sulfonyl (S═O or O=S═O); two adjacent CH₂ groups may be replaced by —CH═CH— or —C≡C—; and wherein each e is independently selected from the range of 0 to 10; and each of a and b is independently 0 or 1. As used herein, reference to a or b equal to 0 represents a formula wherein there is no Z¹ or Z² group present, respectively.

As applied to formula (FX1), reference to a or b equal to 0, for example, refers to a formula wherein PM is directly bound to the adjacent nitrogen(s). As used herein, reference to e equal to 0 also represents a formula wherein there is no Z¹ and/or Z² group present. In an embodiment, each e is independently is selected from the range of 1 to 5. The present invention includes compositions comprising enantiomers, diastereomers and/or ionic forms (e.g., protonated and deprotonated forms) of formula (FX1).

In an optical agent of the invention, at least a portion of the monomers of the hydrophilic blocks of the block copolymers are bound to the linking groups by formula (FX1) and the linking group PM comprises at least one chromophore or fluorophore group capable of excitation by absorption of electromagnetic radiation having wavelengths in the visible (e.g. 400 nm to 750 nm) and/or the near infrared region (e.g., 750-1300 nm) regions of the electromagnetic spectrum. In an embodiment, for example, the linking group PM comprises a chromophore or fluorophore group selected from the group consisting of a phenylxanthene, a phenothiazine, a phenoselenazine, a cyanine, an indocyanine, a squaraine, a dipyrrolo pyrimidone, an anthraquinone, a tetracene, a quinoline, a pyrazine, an acridine, an acridone, a phenanthridine, an azo dye, a rhodamine, a phenoxazine, an azulene, an azaazulene, a triphenyl methane dye, an indole, a benzoindole, an indocarbocyanine, a Nile Red dye, a benzoindocarbocyanine, and conjugates, complexes, fragments and derivatives thereof. In an optical agent of the invention, at least a portion of the monomers of the hydrophilic blocks of the block copolymers are bound to the linking groups by formula (FX1) and PM comprises one or more pyrazine groups.

In an embodiment wherein PM is connected to the hydrophilic blocks of the copolymer via spacers, each of Z¹ and Z² is independently amide, C₁-C₁₀ alkylene, C₃-C₁₀ cycloalkylene, poly(alkylene glycol), C₂-C₁₀ alkenylene, C₃-C₁₀ cycloalkenylene, carbonyl, or C₂-C₁₀ alkynylene. In an embodiment, at least one of Z¹ and Z² is a substituent comprising —(CH₂CH₂O)_{b}— (PEG, polyethylene glycol)) wherein b is selected from the range of 1 to 10. In an optical agent of the invention, at least a portion of the monomers of the hydrophilic blocks of the block copolymers are bound to the linking groups by formula (FX1) and at least one of, and optionally each of, R¹ and R² is independently hydrogen, C₁-C₂₀ alkyl, C₅-C₂₀ aryl, C₁-C₂₀ acyl, C₂-C₂₀ alkenyl, C₂-C₂₀ alkynyl, C₅-C₂₀ alkylaryl, halo, amine, hydroxyl, carboxyl, C₁-C₂₀ alkoxycarbonyl or a natural or non-natural amino acid or fragment (e.g., side chain) thereof. In an optical agent of the invention, at least a portion of the monomers of the hydrophilic blocks of the block copolymers are bound to the linking groups by formula (FX1) and each of R¹ and R² is independently hydrogen, C₁-C₁₀ alkyl, C₅-C₁₀ aryl, or C₁-C₁₀ acyl.

In an embodiment, at least a portion of the monomers of the hydrophilic blocks are bound to pyrazine-based linking groups such as a pyrazine-based amino linking group. In an embodiment, for example, at least a portion of the hydrophilic blocks of the block copolymers comprise monomers bound to linking groups having the formula:

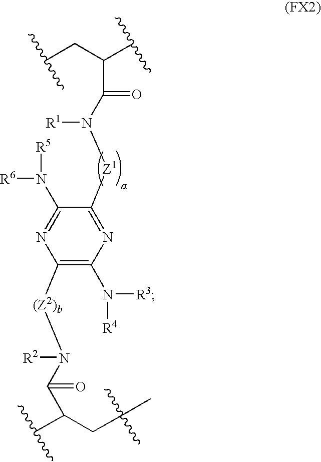

wherein each of R¹-R⁶ is independently selected from the group consisting of —R, —COOR, —COR, —CON(R)₂, —OCON(R)₂, —N(R)₂, —SR, —SO₂R, —SOR, —OCOOR, —SO₂N(R)₂, and —OR; R is selected from the group consisting of a hydrogen, C₁-C₂₀ alkyl, C₅-C₂₀ aryl, C₁-C₂₀ carbonyl, C₂-C₂₀ alkenyl, C₂-C₂₀ alkynyl, C₅-C₂₀ alkylaryl, C₁-C₂₀ alkoxy, halo, amine, amide, hydroxyl, carboxyl, cyano, a nitrile group, an azide group, a nitro group, an acyl group, a thiol group or a natural or non-natural amino acid or fragment (e.g., side chain) thereof;

each of Z¹ and Z² is independently

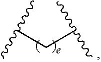

wherein one or more CH₂ groups may be replaced by NH, O, S, a carbonyl (C═O), or a sulfonyl (S═O or O═S═O); two adjacent CH₂ groups may be replaced by —CH═CH— or —C═C—; and wherein each e is independently is selected from the range of 0 to 10; and each of a and b is independently 0 or 1. The present invention includes compositions comprising enantiomers, diastereomers, and/or ionic forms (e.g., protonated and deprotonated forms) of formula (FX2).

In an optical agent of the invention, at least a portion of the monomers of the hydrophilic blocks of the block copolymers are bound to the linking groups by formula (FX2) and each R¹-R⁶ is independently hydrogen, C₁-C₂₀ alkyl, C₅-C₂₀ aryl, C₁-C₂₀ acyl, C₂-C₂₀ alkenyl, C₂-C₂₀ alkynyl, C₅-C₂₀ alkylaryl, halo, amine, hydroxyl, carboxyl, C₁-C₂₀ alkoxycarbonyl, or a natural or non-natural amino acid or fragment (e.g., side chain) thereof. In an optical agent of the invention, at least a portion of the monomers of the hydrophilic blocks of the block copolymers are bound to the linking groups by formula (FX2) and at least one of, and optionally each of, R¹-R⁶ is independently hydrogen, C₁-C₁₀ alkyl, C₅-C₁₀ aryl, or C₁-C₁₀ acyl. In an embodiment, each e is independently is selected from the range of 1 to 5. In an optical agent of the invention, at least a portion of the monomers of the hydrophilic blocks of the block copolymers are bound to the linking groups by formula (FX2) and each of Z¹ and Z² is independently amide, C₁-C₁₀ alkylene, C₃-C₁₀ cycloalkylene, poly(alkylene glycol), C₂-C₁₀ alkenylene, C₃-C₁₀ cycloalkenylene, carbonyl, or C₂-C₁₀ alkynylene. In an embodiment, at least one of Z¹ and Z² is a substituent comprising —(CH₂CH₂O)_{b}— (PEG, poly(ethylene glycol)) wherein b is selected from the range of 1 to 10.

In an embodiment, at least a portion of the monomers of the hydrophilic blocks are bound to pyrazine-based linking groups via a carboxamide bonding scheme (e.g., via amino carbonyl groups). In an embodiment, for example, at least a portion of the hydrophilic blocks of the block copolymers comprise monomers bound to linking groups having the formula:

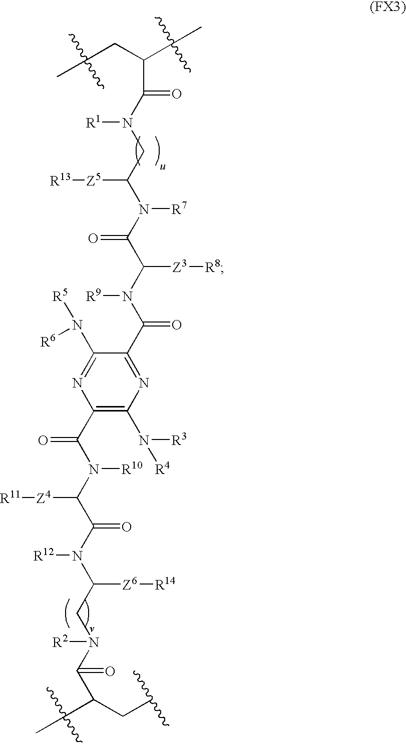

wherein each of R¹-R¹⁴ is independently selected from the group consisting of —R, —COOR, —COR, —CON(R)₂, —OCON(R)₂, —N(R)₂, —SR, —SO₂R, —SOR, —OCOOR, —SO₂N(R)₂, and —OR; R is selected from the group consisting of a hydrogen, C₁-C₂₀ alkyl, C₅-C₂₀ aryl, C₁-C₂₀ carbonyl, C₂-C₂₀ alkenyl, C₂-C₂₀ alkynyl, C₅-C₂₀ alkylaryl, C₁-C₂₀ alkoxy, halo, amine, amide, hydroxyl, carboxyl, cyano, a nitrile group, an azide group, a nitro group, an acyl group, a thiol group or a natural or non-natural amino acid or fragment (e.g., side chain) thereof; each of u and v is independently selected from the range of 0 to 10; each of Z³-Z⁶ is

independently

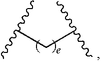

wherein one or more CH₂ groups may be replaced by NH, O, S, a carbonyl (C═O), or a sulfonyl (S═O or O═S═O); two adjacent CH₂ groups may be replaced by —CH═CH— or —C═C—; and wherein each e is independently is selected from the range of 0 to 10. In an embodiment, e is selected from the range of 1 to 5. The present invention includes compositions comprising enantiomers, diastereomers, and/or ionic forms (e.g., protonated and deprotonated forms) of formula (FX3).

In an optical agent of the present invention having the cross linking between hydropillic blocks of block copolymers as shown in formula (FX3) at least one of R⁸, R¹¹, R¹³, and R¹⁴ is the side chain of a basic natural or non-natural amino acid, such as at least one of R⁸, R¹¹, R¹³, and R¹⁴ is a side chain of an amino acid selected from the group consisting of arginine, lysine, histidine, ornithine, and homoarginine. In an embodiment, at least one of R⁸, R¹¹, R¹³, and R¹⁴ is selected from the group consisting of:

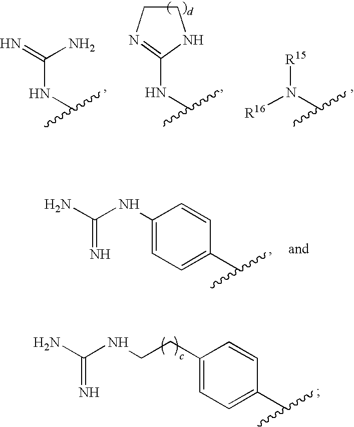

wherein d is selected from the range of 1 to 4 and wherein c is selected from the range of 1 to 7, and wherein each of wherein each of R¹⁵ and R¹⁶ is independently selected from the group consisting of —R, —COOR, —COR, —CON(R)₂, —OCON(R)₂, —N(R)₂, —SR, —SO₂R, —SOR, —OCOOR, —SO₂N(R)₂, and —OR; R is selected from the group consisting of a hydrogen, C₁-C₂₀ alkyl, C₅-C₂₀ aryl, C₁-C₂₀ carbonyl, C₂-C₂₀ alkenyl, C₂-C₂₀ alkynyl, C₅-C₂₀ alkylaryl, C₁-C₂₀ alkoxy, halo, amine, amide, hydroxyl, carboxyl, cyano, a nitrile group, an azide group, a nitro group, an acyl group, a thiol group or a natural or non-natural amino acid or fragment (e.g., side chain) thereof, and optionally, R¹⁵ and R¹⁶ can together form a aliphatic or aromatic ring of 4-8 carbons, optionally substituted with one or more S, C or O heteroatoms provided in the aliphatic or aromatic ring. In an embodiment, each of R¹⁵ and R¹⁶ is independently a hydrogen or C₁-C₅ alkyl.

In an optical agent of the invention, at least a portion of the monomers of the hydrophilic blocks of the block copolymers are bound to the linking groups by formula (FX3) and each R¹-R¹⁶ is independently hydrogen, C₁-C₂₀ alkyl, C₅-C₂₀ aryl, C₁-C₂₀ acyl, C₂-C₂₀ alkenyl, C₂-C₂₀ alkynyl, C₅-C₂₀ alkylaryl, halo, amine, hydroxyl, carboxyl, C₁-C₂₀ alkoxycarbonyl, or a natural or non-natural amino acid or fragment (e.g., side chain) thereof. In an optical agent of the invention, at least a portion of the monomers of the hydrophilic blocks of the block copolymers are bound to the linking groups by formula (FX3) and at least one of R¹-R¹⁶, and optionally each of R¹-R¹⁶, is independently hydrogen, C₁-C₁₀ alkyl, C₅-C₁₀ aryl, or C₁-C₁₀ acyl. In an embodiment, each e is independently is selected from the range of 1 to 5. In an optical agent of the invention, at least a portion of the monomers of the hydrophilic blocks of the block copolymers are bound to the linking groups by formula (FX3) and each of Z³-Z⁶ is independently amide, C₁-C₁₀ alkylene, C₃-C₁₀ cycloalkylene, poly(alkylene glycol), C₂-C₁₀ alkenylene, C₃-C₁₀ cycloalkenylene, carbonyl, or C₂-C₁₀ alkynylene. In an embodiment, at least one of Z³-Z⁶ is a substituent comprising —(CH₂CH₂O)_{b}— (PEG, poly(ethylene glycol)) wherein b is selected from the range of 1 to 10.

In an embodiment, at least a portion of the monomers of the hydrophilic blocks are bound to pyrazine-based linking groups having one or more guanidine or guanidine derivative moities (e.g., the side chain of the amino acid arginine). In an embodiment, for example, at least a portion of the hydrophilic blocks of the block copolymers comprise monomers bound to linking groups having the formula:

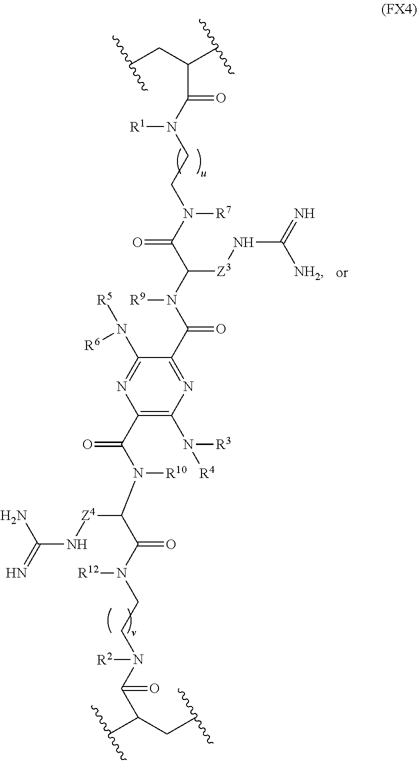

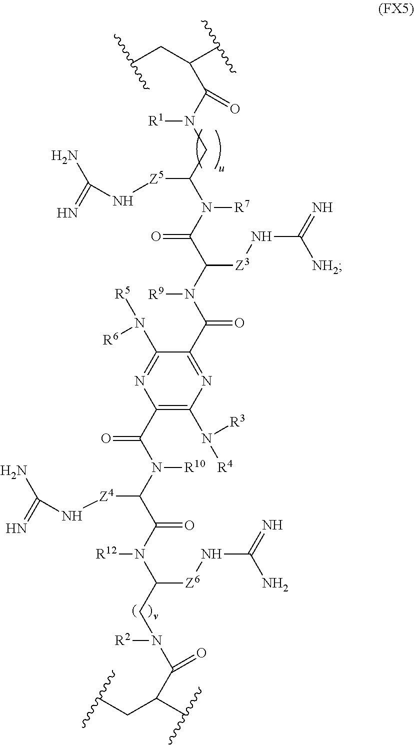

wherein R¹-R⁷, R⁹-R¹⁰, R¹², Z³, Z⁴, Z⁵, Z⁶, e, u and v are defined as described above in the context of formula (FX3). In an optical agent of the invention, at least a portion of the monomers of the hydrophilic blocks of the block copolymers are bound to the linking groups by formula (FX4) or (FX5) and each R¹-R⁷, R⁹-R¹⁰, and R¹² is independently hydrogen, C₁-C₂₀ alkyl, C₅-C₂₀ aryl, C₁-C₂₀ acyl, C₂-C₂₀ alkenyl, C₂-C₂₀ alkynyl, C₅-C₂₀ alkylaryl, halo, amine, hydroxyl, carboxyl, C₁-C₂₀ alkoxycarbonyl, or a natural or non-natural amino acid or fragment (e.g., side chain) thereof. The present invention includes compositions comprising enantiomers, diastereomers, and/or ionic forms (e.g., protonated and deprotonated forms) of formula (FX4) and (FX5).

In an optical agent of the invention, at least a portion of the monomers of the hydrophilic blocks of the block copolymers are bound to the linking groups by formula (FX4) or (FX5) and at least one of R¹-R⁷, R⁹-R¹⁰, and R¹² is hydrogen, C₁-C₁₀ alkyl, C₅-C₁₀ aryl, or C₁-C₁₀ acyl. In an embodiment, each e is independently is selected from the range of 1 to 5. In an optical agent of the invention, at least a portion of the monomers of the hydrophilic blocks of the block copolymers are bound to the linking groups by formula (FX4) or (FX5) and each of Z³-Z⁶ is independently amide, C₁-C₁₀ alkylene, C₃-C₁₀ cycloalkylene, poly(alkylene glycol), C₂-C₁₀ alkenylene, C₃-C₁₀ cycloalkenylene, carbonyl, or C₂-C₁₀ alkynylene. In an embodiment, at least one of Z³-Z⁶ is a substituent comprising —(CH₂CH₂O)_{b}— (PEG, poly(ethylene glycol)) wherein b is selected from the range of 1 to 10.

In an embodiment of this aspect, at least a portion of the hydrophilic blocks of the block copolymers comprise monomers bound to linking groups having the formula:

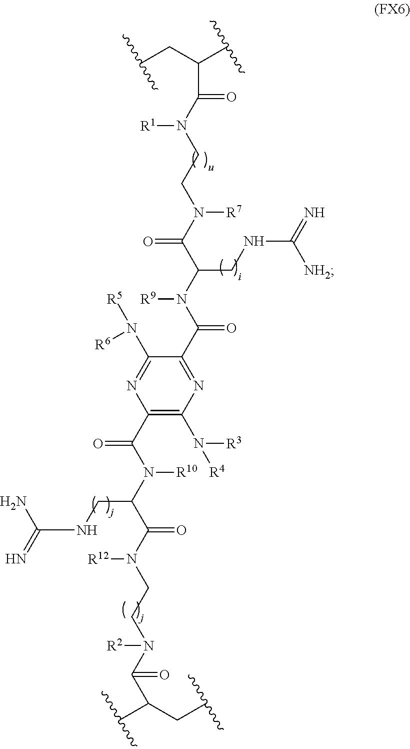

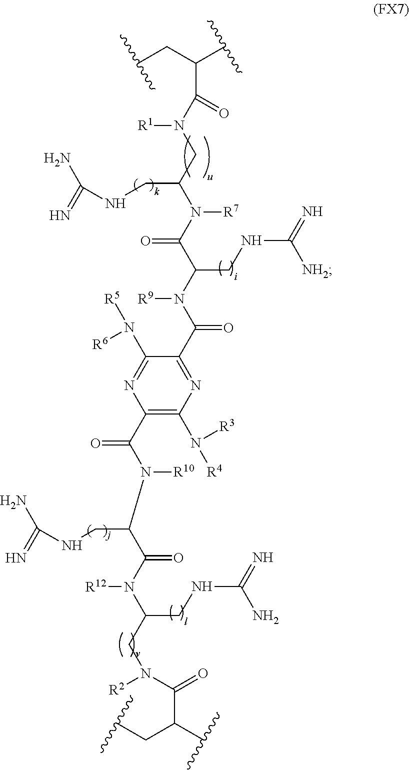

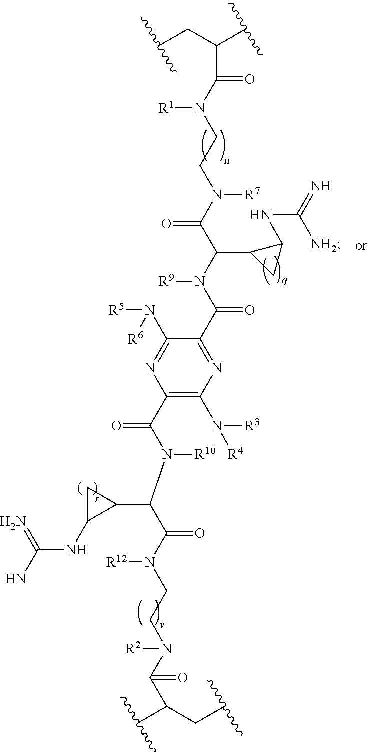

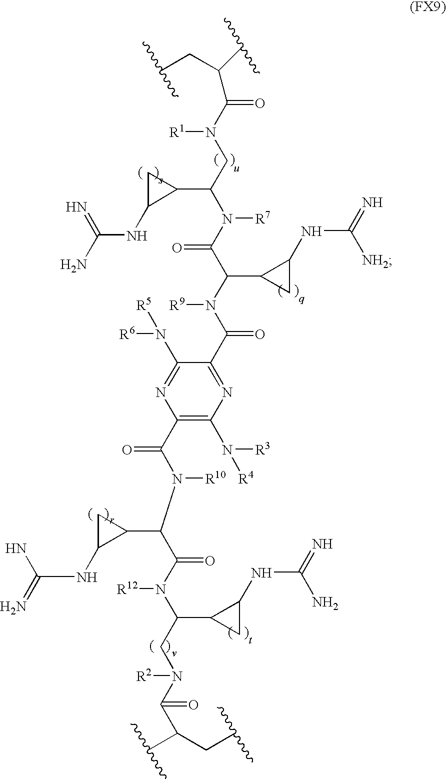

wherein R¹-R¹⁰, R¹², e, u and v are defined as described above in the context of formula (FX3), each of i, j, k and l is independently selected from the range of 0 to 9, and each of q, r, s and t is independently selected from the range of 1 to 3. The present invention includes compositions comprising enantiomers, diastereomers, and/or ionic forms (e.g., protonated and deprotonated forms) of formula (FX5)-(FX9).

In an optical agent of the invention, at least a portion of the monomers of the hydrophilic blocks of the block copolymers are bound to the linking groups by formula ((FX6), (FX7), (FX8) or (FX9) and each of R¹-R¹⁰, and R¹² is independently hydrogen, C₁-C₂₀ alkyl, C₅-C₂₀ aryl, C₁-C₂₀ acyl, C₂-C₂₀ alkenyl, C₂-C₂₀ alkynyl, C₅-C₂₀ alkylaryl, halo, amine, hydroxyl, carboxyl, C₁-C₂₀ alkoxycarbonyl, or a natural or non-natural amino acid or fragment (e.g., side chain) thereof. In an optical agent of the invention, at least a portion of the monomers of the hydrophilic blocks of the block copolymers are bound to the linking groups by formula (FX6), (FX7), (FX8) or (FX9) and at least one of R¹-R¹⁰, and R¹² is hydrogen, C₁-C₁₀ alkyl, C₅-C₁₀ aryl, or C₁-C₁₀ acyl. In an embodiment, each e is independently is selected from the range of 1 to 5.

An optically functional shell-cross linked micelle composition of the present invention comprises block copolymers having poly(acrylic acid) polymer hydrophilic block cross linked by one or more pyrazine photoactive moieties or conjugates or derivatives thereof. In an embodiment, for example, at least a portion of the hydrophilic blocks of the block copolymers comprise monomers bound to linking groups having the formula:

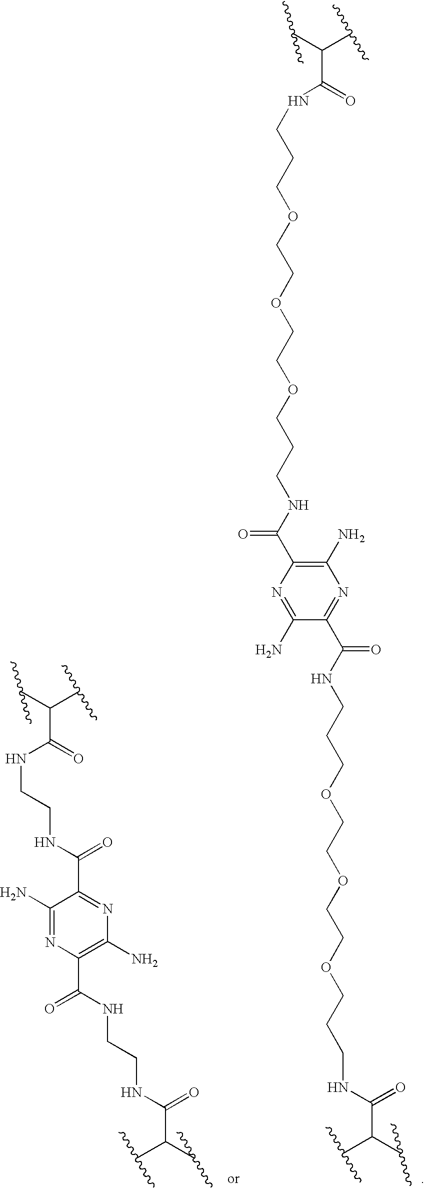

As will be understood by those having skill in the art, the present invention includes supramolecular structures and compositions cross linked via other types of covalent bonding known in the art of synthetic organic chemistry and polymer chemistry.

An optically functional shell cross linked micelle of the invention comprises block copolymer and linking group components having the structure:

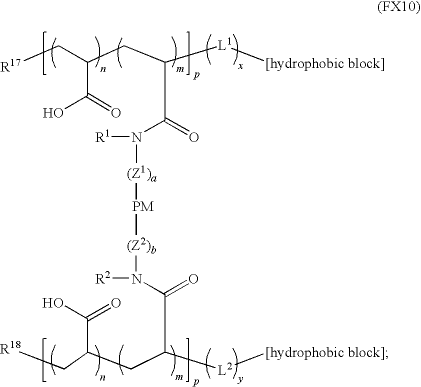

wherein PM, R¹, R², Z¹, Z², a and b are defined as described above in the context of formula (FX1); wherein p is selected from the range of 20 to 250, wherein independently for each value of p, n is independently equal to 1 or 0 and m is independently equal to 1 or 0; each of R¹⁷ and R¹⁸ is independently selected from the group consisting of —R, —COOR, —COR, —CON(R)₂, —OCON(R)₂, —N(R)₂, —SR, —SO₂R, —SOR, —OCOOR, —SO₂N(R)₂, and —OR; R is selected from the group consisting of a hydrogen, C₁-C₂₀ alkyl, C₅-C₂₀ aryl, C₁-C₂₀ carbonyl, C₂-C₂₀ alkenyl, C₂-C₂₀ alkynyl, C₅-C₂₀ alkylaryl, C₁-C₂₀ alkoxy, halo, amine, amide, hydroxyl, carboxyl, cyano, a nitrile group, an azide group, a nitro group, an acyl group, a thiol group, a natural or non-natural amino acid or fragment thereof or an additional hydrophilic block of the copolymers; each of L¹ and L² is independently

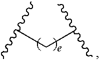

wherein one or more CH₂ groups may be replaced by NH, O, S, a carbonyl (C═O), or a sulfonyl (S═O or O═S═O); two adjacent CH₂ groups may be replaced by —CH═CH— or —C═C—; and wherein each e is independently selected from the range of 0 to 10; each of a and b is independently 0 or 1; wherein [hydrophobic block] is a hydrophobic block of the block copolymers; wherein each of x and y is independently 0 or 1. The present invention includes compositions comprising enantiomers, diastereomers, and/or ionic forms (e.g., protonated and deprotonated forms) of formula (FX10). As used herein, reference to x or y equal to 0 represents a formula wherein there is no L¹ or L² group present, respectively. In an embodiment, each e is independently selected from the range of 1 to 5. Optionally, p is selected from the range of 50 to 200. In an optical agent of the invention, at least a portion of the block copolymer and linking group components have the structure (FX10) and PM comprises one or more pyrazine groups.

In a specific embodiment, each of R¹⁷ and R¹⁸ is independently an additional hydrophilic block of the copolymers. In a specific embodiment, each of R¹⁷ and R¹⁸ is independently a hydrophilic block selected from the group consisting of a poly(acrylic acid) polymer block, a poly(N-(acryloyloxy)succinimide) polymer block; a poly(N-acryloylmorpholine) polymer block; a poly(ethylene glycol) polymer block, poly(p-vinyl benzaldehyde) block or a poly(phenyl vinyl ketone) block. In an embodiment, each of R¹⁷ and R¹⁸ is —(CH₂CH₂O)ₕ— wherein h is selected from the range of 10 to 500.

As shown in formula (FX10), a portion of the polymer backbones of the block copolymers is shown in block parenthesis (i.e., the parenthesis with the subscript “p”) indicating repeating units of the hydrophilic block. For each repeating unit in this portion of the polymer backbone n and m can independently have values of 0 and 1, indicating that the monomers of the repeating unit may vary in this embodiment along on the polymer backbone. This structure reflects that fact that the extent and structure of cross linking between cross linked block copolymers can vary along the polymer back bone. For example, n and m may both equal 1 for the first unit of the polymer backbone shown in formula (FX10), signifying that both cross linked and non-cross linked monomer groups are present in this unit, and m may equal 1 and n equal 0 in the second repeating unit of the polymer backbone signifying that only the cross linked monomer groups is present in the second unit. Accordingly, the optical agent of formula (FX10)-(FX18) represent a class of compositions having a variable extent of cross linking, for example, an extent of cross linking ranging from 1 to 75%, and optionally 20 to 75%. The hydrophilic block of the block copolymer may have any number of additional chemical domains. In an embodiment, for example, R¹⁷ and/or R¹⁸ are independently a substituent comprising —(CH₂CH₂O)_{b}— (i.e., (PEG, poly(ethylene glycol))), wherein b is selected from the range of 1 to 10.

In an embodiment, at least a portion of the monomers of the hydrophilic blocks are bound to pyrazine-based linking groups such as pyrazine-based amino linking groups. In an embodiment, for example, at least a portion of the block copolymers and linking groups of the optical agent have the formula:

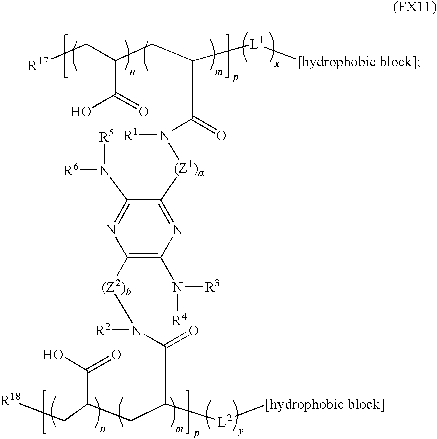

wherein R¹-R⁶, R¹⁷, R¹⁸, Z¹, Z², L¹, L², a, b, n, m, p, x and y are defined as described above in the context of formulae (FX1), (FX2), and (FX10). The present invention includes compositions comprising enantiomers, diastereomers, and/or ionic forms (e.g., protonated and deprotonated forms) of formula (FX11).

In an embodiment, for example, at least a portion of the block copolymers and linking groups of the optical agent have the formula:

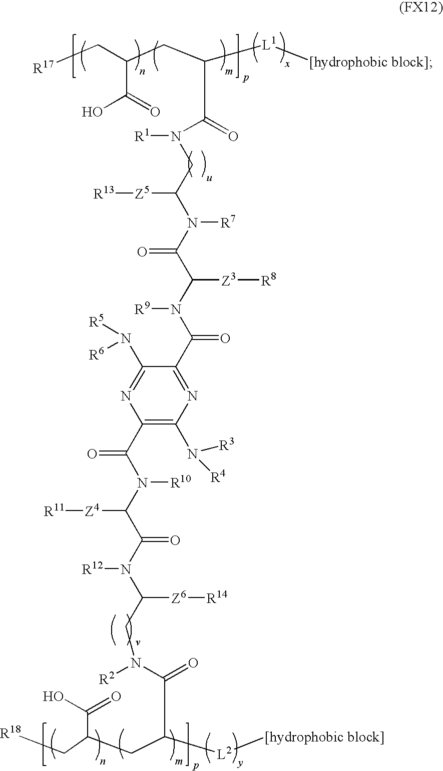

wherein R¹-R¹⁴, R¹⁷, R¹⁸, Z¹, Z², L¹, L², a, b, n, m, p, x, u, v and y are defined as described above in the context of formulae (FX1), (FX2), (FX3), (FX10) and (FX11). The present invention includes compositions comprising enantiomers, diastereomers, and/or ionic forms (e.g., protonated and deprotonated forms) of formula (FX12).

In an embodiment, at least a portion of the monomers of the hydrophilic blocks are bound to pyrazine-based linking groups having one or more guanidine or guanidine derivative moities (e.g., side chain of the amino acid arginine). In an embodiment, for example, at least a portion of the block copolymers and linking groups of the optical agent have the formula:

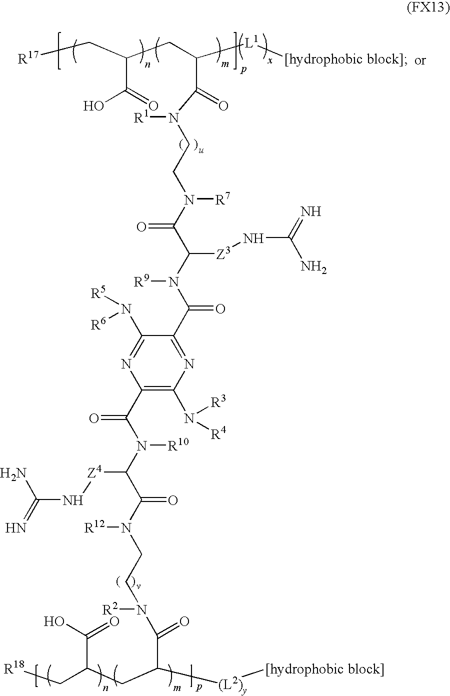

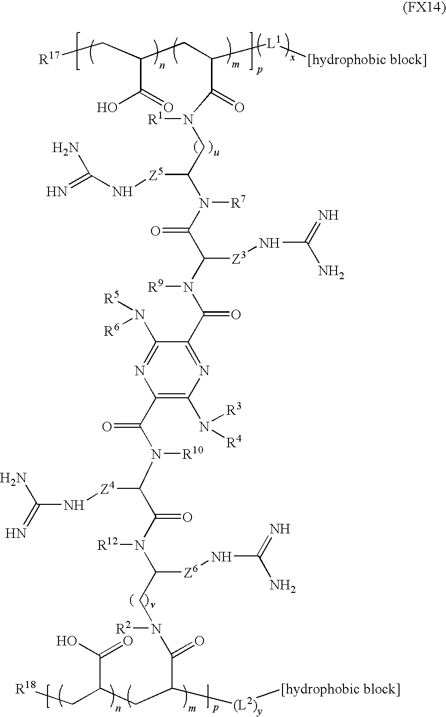

wherein R¹-R¹⁴, R¹⁷, R¹⁸, Z¹, Z², L¹, L², a, b, n, m, p, x, u, v and y are defined as described above in the context of formulae (FX1)-(FX5), (FX10), (FX11) and (FX12). The present invention includes compositions comprising enantiomers, diastereomers, and/or ionic forms (e.g., protonated and deprotonated forms) of formula (FX13) and (FX14).

In an embodiment, for example, at least a portion of the block copolymers and linking groups of the optical agent have the formula:

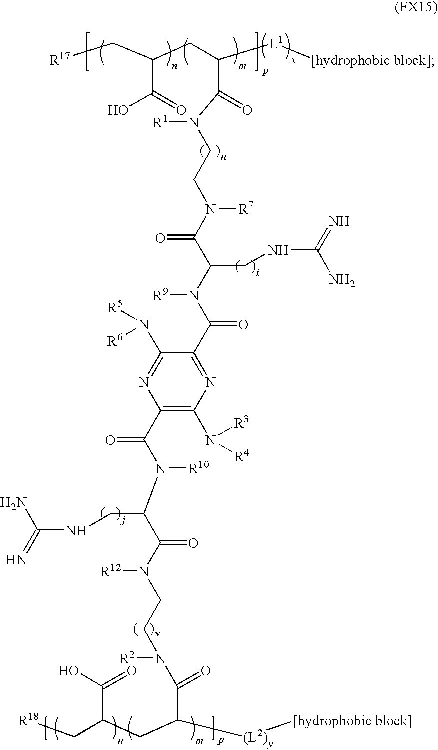

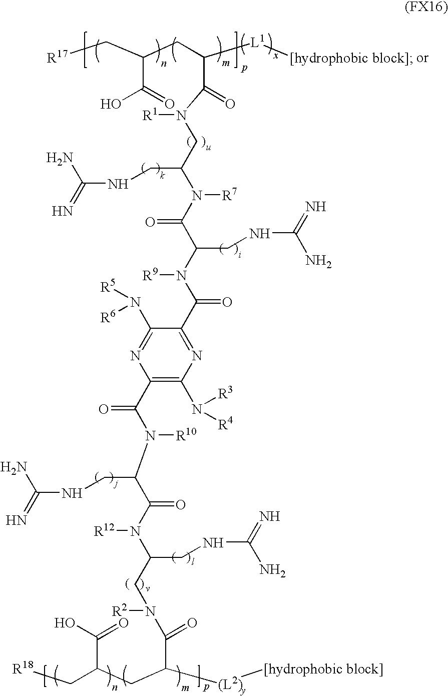

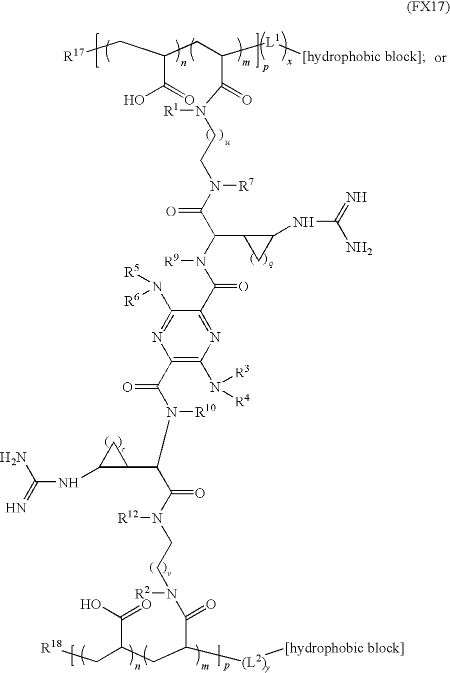

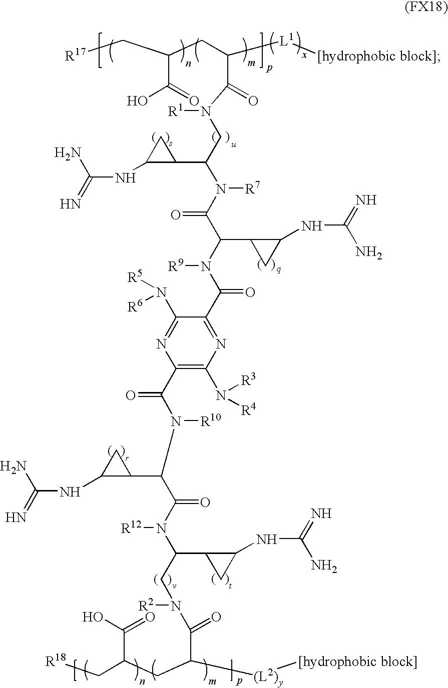

wherein R¹-R¹⁴, R¹⁷, R¹⁸, Z¹, Z², L¹, L², a, b, n, m, p, x, y, i, j, k, l, q, r, s, t, u, v, x and y are defined as described above in the context of formulae (FX1)-(FX14). The present invention includes compositions comprising enantiomers, diastereomers, and/or ionic forms (e.g., protonated and deprotonated forms) of formula (FX15)-(FX18).

In an embodiment, an optically functional shell cross linked micelle of present invention comprises block copolymer and pyrazine linking group components having the structure:

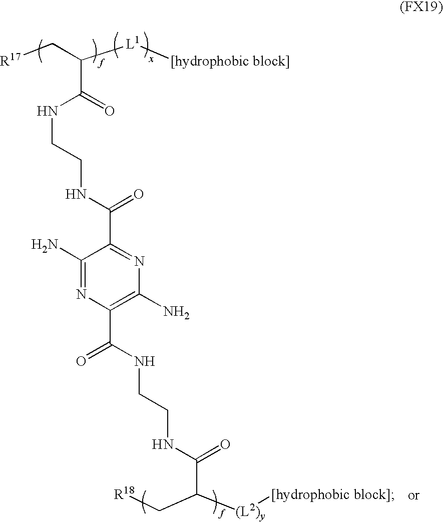

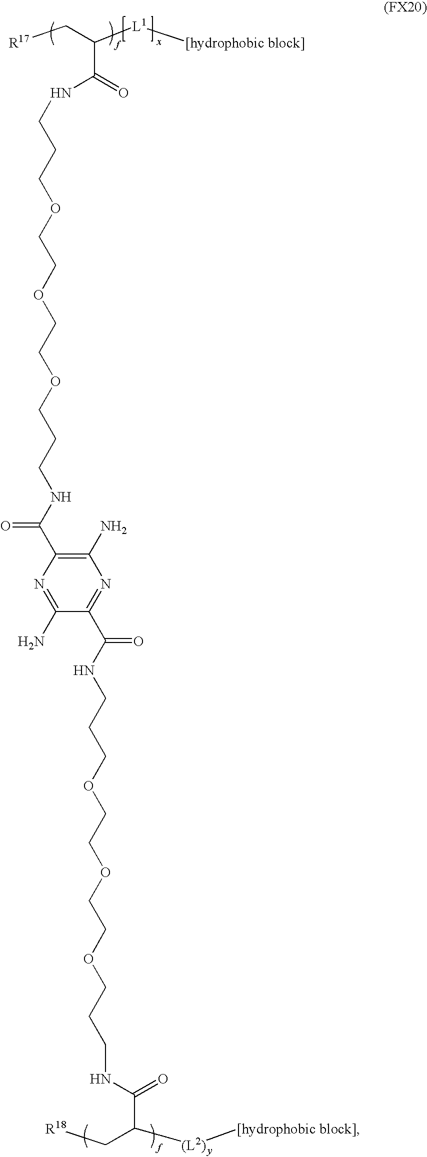

and enantiomers, diastereomers, and/or ionic forms (e.g., protonated and deprotonated forms) thereof; wherein f is selected from the range of 20 to 250; each of R¹⁷ and R¹⁸ is independently selected from the group consisting of —R, —COOR, —COR, —CON(R)₂, —OCON(R)₂, —N(R)₂, —SR, —SO₂R, —SOR, —OCOOR, —SO₂N(R)₂, and —OR; R is selected from the group consisting of a hydrogen, C₁-C₂₀ alkyl, C₅-C₂₀ aryl, C₁-C₂₀ carbonyl, C₂-C₂₀ alkenyl, C₂-C₂₀ alkynyl, C₅-C₂₀ alkylaryl, C₁-C₂₀ alkoxy, halo, amine, amide, hydroxyl, carboxyl, cyano, a nitrile group, an azide group, a nitro group, an acyl group, a thiol group, a natural or non-natural amino acid or fragment thereof or an additional

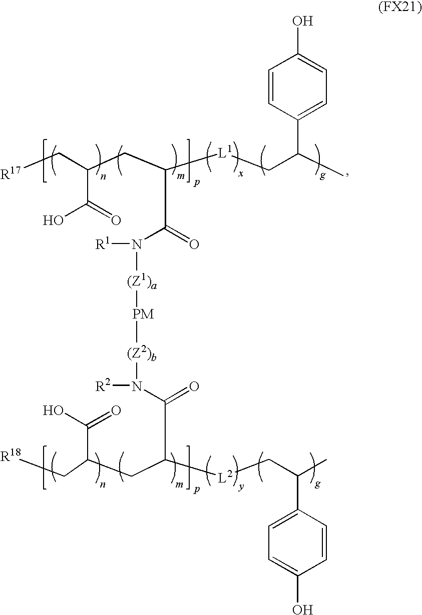

and enantiomers, diastereomers, and/or ionic forms (e.g., protonated and deprotonated forms) thereof; wherein PM, R¹, R², Z¹, Z², L¹, L², a, b, n, m, p, y, x, R¹⁷, R¹⁸, are defined as described above in the context of formula (FX1)-(FX19); wherein each g is independently selected from the range of 20 to 250.

In an embodiment, the hydrophilic groups of at least a portion of the block copolymers further comprise a poly(ethylene glycol) domain (PEG), for example a domain comprising —(CH₂CH₂O)ₕ— wherein h is selected from the range of 10 to 500, optionally 20 to 100. In an embodiment, for example, at least a portion of the block copolymers and linking groups of the optical agent have the formula:

hydrophilic block of the copolymers; each of L¹ and L² is independently

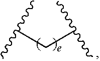

wherein one or more CH₂ groups may be replaced by NH, O, S, a carbonyl (C═O), or a sulfonyl (S═O or O═S═O); two adjacent CH₂ groups may be replaced by —CH═CH— or —C═C—; and wherein each e is independently selected from the range of 0 to 10; each of a and b is independently 0 or 1; wherein [hydrophobic block] is a hydrophobic block of the block copolymers; wherein each of x and y is independently 0 or 1. As used herein, reference to x or y equal to 0 represents a formula wherein there is no L¹ or L² grouppresent, respectively. In an embodiment, each e is independently selected from the range of 1 to 5. Optionally, p is selected from the range of 50 to 200.

The hydrophobic block in formula (FX10)-(FX20) (represented by [hydrophobic block]) can have a wide range of compositions depending on the desired application and use of the present optical agents. In an embodiment, the composition of [hydrophobic block] is selected from the group consisting of a poly(p-hydroxystyrene) polymer block; a polystyrene polymer block; a polyacrylate polymer block, a poly(propylene glycol) polymer block; a poly(amino acid) polymer block; a poly(ester) polymer block; a poly (ε-caprolactone) polymer block, and a phospholipid; or a copolymer thereof. In an embodiment, the [hydrophobic block] comprises monomers including one or more aryl groups, such as phenyl, phenol and/or derivative thereof. In an embodiment, the hydrophobic block has a number of monomers selected from the range of 210 to 250, optionally 40 to 100. In an embodiment, for example, at least a portion of the block copolymers and linking groups of the optical agent have the formula:

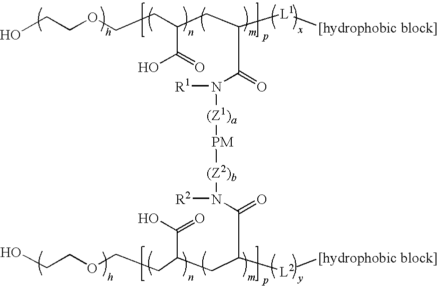

(FX22) and enantiomers, diastereomers, and/or ionic forms (e.g., protonated and deprotonated forms) thereof; wherein PM, R¹, R², Z¹, Z², L¹, L², a, a b, n, m, p, y, x, are defined as described above in the context of formula (FX1)-(FX19); wherein each h is independently selected from the range of 10 to 500.

### STATEMENTS REGARDING INCORPORATION BY REFERENCE AND VARIATIONS

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

All patents and publications mentioned in the specification are indicative of the levels of skill of those skilled in the art to which the invention pertains. References cited herein are incorporated by reference herein in their entirety to indicate the state of the art, in some cases as of their filing date, and it is intended that this information can be employed herein, if needed, to exclude (for example, to disclaim) specific embodiments that are in the prior art. For example, when a compound is claimed, it should be understood that compounds known in the prior art, including certain compounds disclosed in the references disclosed herein (particularly in referenced patent documents), are not intended to be included in the claim.

When a group of substituents is disclosed herein, it is understood that all individual members of those groups and all subgroups, including any isomers and enantiomers of the group members, and classes of compounds that can be formed using the substituents are disclosed separately. When a compound is claimed, it should be understood that compounds known in the art including the compounds disclosed in the references disclosed herein are not intended to be included. When a Markush group or other grouping is used herein, all individual members of the group and all combinations and subcombinations possible of the group are intended to be individually included in the disclosure.

Every formulation or combination of components described or exemplified can be used to practice the invention, unless otherwise stated. Specific names of compounds are intended to be exemplary, as it is known that one of ordinary skill in the art can name the same compounds differently. When a compound is described herein such that a particular isomer or enantiomer of the compound is not specified, for example, in a formula or in a chemical name, that description is intended to include each isomers and enantiomer of the compound described individual or in any combination. One of ordinary skill in the art will appreciate that methods, device elements, starting materials, and synthetic methods other than those specifically exemplified can be employed in the practice of the invention without resort to undue experimentation. All art-known functional equivalents, of any such methods, device elements, starting materials, and synthetic methods are intended to be included in this invention. Whenever a range is given in the specification, for example, a temperature range, a time range, or a composition range, all intermediate ranges and subranges, as well as all individual values included in the ranges given are intended to be included in the disclosure.

Whenever a range is given in the specification, for example, a temperature range, a time range, or a composition or concentration range, all intermediate ranges and subranges, as well as all individual values included in the ranges given are intended to be included in the disclosure. As used herein, ranges specifically include the values provided as endpoint values of the range. For example, a range of 1 to 100 specifically includes the end point values of 1 and 100. It will be understood that any subranges or individual values in a range or subrange that are included in the description herein can be excluded from the claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

Many of the molecules disclosed herein contain one or more ionizable groups [groups from which a proton can be removed (e.g., —COOH) or added (e.g., amines) or which can be quaternized (e.g., amines)]. All possible ionic forms of such molecules and salts thereof are intended to be included individually in the disclosure herein. With regard to salts of the compounds herein, one of ordinary skill in the art can select from among a wide variety of available counterions those that are appropriate for preparation of salts of this invention for a given application. In specific applications, the selection of a given anion or cation for preparation of a salt may result in increased or decreased solubility of that salt.

Every formulation or combination of components described or exemplified herein can be used to practice the invention, unless otherwise stated.

The present compositions, preparations and formulations can be used both as a diagnostic agent as well as a photodynamic therapeutic agent concomitantly. For example, an effective amount of the present compositions, preparations and formulations in a pharmaceutically acceptable formulation is administered to a patient. Administration is followed by a procedure that combines photodiagnosis and phototherapy. For example, a composition comprising compounds for combined photodiagnosis and phototherapy is administered to a patient and its concentration, localization, or other parameters is determined at the target site of interest. More than one measurement may be taken to determine the location of the target site. The time it takes for the compound to accumulate at the target site depends upon factors such as pharmcokinetics, and may range from about thirty minutes to two days. Once the site is identified, the phototherapeutic part of the procedure may be done either immediately after determining the site or before the agent is cleared from the site. Clearance depends upon factors such as pharmacokinetics.

The present compositions, preparations and formulations can be formulated into diagnostic or therapeutic compositions for enteral, parenteral, topical, aerosol, inhalation, or cutaneous administration. Topical or cutaneous delivery of the compositions, preparations and formulations may also include aerosol formulation, creams, gels, solutions, etc. The present compositions, preparations and formulations are administered in doses effective to achieve the desired diagnostic and/or therapeutic effect. Such doses may vary widely depending upon the particular compositions employed in the composition, the organs or tissues to be examined, the equipment employed in the clinical procedure, the efficacy of the treatment achieved, and the like. These compositions, preparations and formulations contain an effective amount of the composition(s), along with conventional pharmaceutical carriers and excipients appropriate for the type of administration contemplated. These compositions, preparations and formulations may also optionally include stabilizing agents and skin penetration enhancing agents.

Methods of this invention comprise the step of administering an “effective amount” of the present diagnostic and therapeutic compositions, formulations and preparations containing the present compounds, to diagnosis, image, monitor, evaluate treat, reduce or regulate a biological condition and/or disease state in a patient. The term “effective amount,” as used herein, refers to the amount of the diagnostic and therapeutic formulation, that, when administered to the individual is effective diagnosis, image, monitor, evaluate treat, reduce or regulate a biological condition and/or disease state. As is understood in the art, the effective amount of a given composition or formulation will depend at least in part upon, the mode of administration (e.g. intravenous, oral, topical administration), any carrier or vehicle employed, and the specific individual to whom the formulation is to be administered (age, weight, condition, sex, etc.). The dosage requirements need to achieve the “effective amount” vary with the particular formulations employed, the route of administration, and clinical objectives. Based on the results obtained in standard pharmacological test procedures, projected daily dosages of active compound can be determined as is understood in the art.

Any suitable form of administration can be employed in connection with the diagnostic and therapeutic formulations of the present invention. The diagnostic and therapeutic formulations of this invention can be administered intravenously, in oral dosage forms, intraperitoneally, subcutaneously, or intramuscularly, all using dosage forms well known to those of ordinary skill in the pharmaceutical arts.

The diagnostic and therapeutic formulations of this invention can be administered alone, but may be administered with a pharmaceutical carrier selected upon the basis of the chosen route of administration and standard pharmaceutical practice.

The diagnostic and therapeutic formulations of this invention and medicaments of this invention may further comprise one or more pharmaceutically acceptable carrier, excipient, or diluent. Such compositions and medicaments are prepared in accordance with acceptable pharmaceutical procedures, such as, for example, those described in Remingtons Pharmaceutical Sciences, 17th edition, ed. Alfonoso R. Gennaro, Mack Publishing Company, Easton, Pa. (1985), which is incorporated herein by reference in its entirety.

The invention may be further understood by the following non-limiting examples.

### Example 1

### Photonic Shell-Crosslinked Nanoparticle Probes for Optical Imaging and Monitoring

Shell-crosslinked micelles have been shown to be excellent nanostructural platforms for a variety of biomedical applications, ranging from the delivery of large payloads of chemotherapeutics and diagnostic agents to the in vivo targeting of such entities to tumors via the external multivalent presentation of tissue specific ligands. The outstanding versatility of these systems is derived from both the ease with which they are produced (by placing amphiphilic block copolymers into a solvent that is selective for solubilizing a portion of the polymer chain segments), and the final core-shell or other (multi) compartment-type morphologies. In general, for shell-crosslinked knedel-like (SCK) nanoparticles derived from amphiphilic block copolymers containing poly(acrylic acid) as the hydrophilic, crosslinkable component, non-functional diamines have been used to chemically crosslink the carboxylate-rich shells in order to generate stable discrete nanoparticles. Even in cases where the core domain is transformed from a hydrophobic block copolymer segment to a hydrophilic polymer chain or degraded into small molecule fragments through chemical excavation strategies, the covalently-crosslinked shell layer retains structural integrity, resulting in the formation of nanocage frameworks, which are able to undergo expansion and contraction under changing environmental conditions.

In this Example we demonstrate the use of the reversible hydrophobicity/hydrophilicity of the core domain to drive the block copolymer micelle assembly/disassembly in water without the aid of organic solvents, as a unique, green chemistry approach to the formation of SCKs. In this pursuit, we show that simple polymer nanoparticles can fashioned into sophisticated sensing devices, by bringing together the concepts of reversible hydrophobicity and nanoparticle expansion/contraction, with the use of functional crosslinkers. The functional crosslinkers provide structural integrity and optical signals to both mediate and probe the local changes within the SCKs, promoted by tuning the pH of the aqueous solution. A notable enhancement of photophysical properties for fluorophore-shell-crosslinked nanoparticles (fluorophore-SCKs), as a result of changing the pH across the physiological range. The current systems have been designed to produce high fluorescence when the shell is swollen at elevated pH and to allow for fluorescence quenching when the shell shrinks as the pH is lowered (See structures and schematic in FIG. 5). We demonstrate that the covalent attachment of fluorogenic crosslinkers within the SCK shell provides this behavior uniquely.

Photonic shell-crosslinked nanoparticles (SCKs) were prepared via crosslinking between fluorophores and micelles. These unique photonic SCKs are discussed in this Example, including their abilities to undergo pH-sensitive swelling/deswelling, which affects enhancement/quenching of the fluorescence.

The fluorophore-SCKs were assembled from the diblock copolymer precursor, poly(acrylic acid)₁₀₃-b-polyp-hydroxystyrene)₄₁, PAA-b-PpHS, which was synthesized via nitroxide-mediated radical polymerization. Micelles were formed by first dissolving the block copolymer in water at high pH and then slowly decreasing the solution pH to 7, at which protonated PpHS block formed a hydrophobic core while maintenance of the deprotonated PAA block shaped a hydrophilic shell. FIG. 5 illustrates the preparation of micelles from poly(acrylic acid)-b-poly(p-hydroxystyrene) in water, with adjustment of the solution pH.

The resulting micelle solution 2 was incubated with 6.25 mol % or 12.5 mol % of the diamino-terminated pyrazine, relative to the acrylic acid residues, with the addition of EDCI, to afford SCK 3 or 4 having different amounts of fluorophores incorporated into the shells and, therefore, different degrees of crosslinking. The reaction mixture solutions were dialyzed against nanopure water for 4 days to remove the urea by-products and any non-attached pyrazine fluorophores. The SCK dimensions were then measured by atomic force microscopy (AFM) and transmission electron microscopy (TEM). The AFM-measured heights were observed to be 6±2 nm and 8±2 nm, and their TEM-measured diameters were 9±2 nm and 9±2 nm for SCKs 3 and 4, respectively. Dialysis of the SCK solutions against nanopure water (ca. pH 7) for 3 days and then partitioning into six vials, each containing 5 mL of 5 mM PBS at pH 4.5, 6.1, 8.0, 9.5, or 11.0, placed the SCKs into different pH environments for analysis of the effects on the SCK hydrodynamic diameters and on the fluorophore photophysical properties.

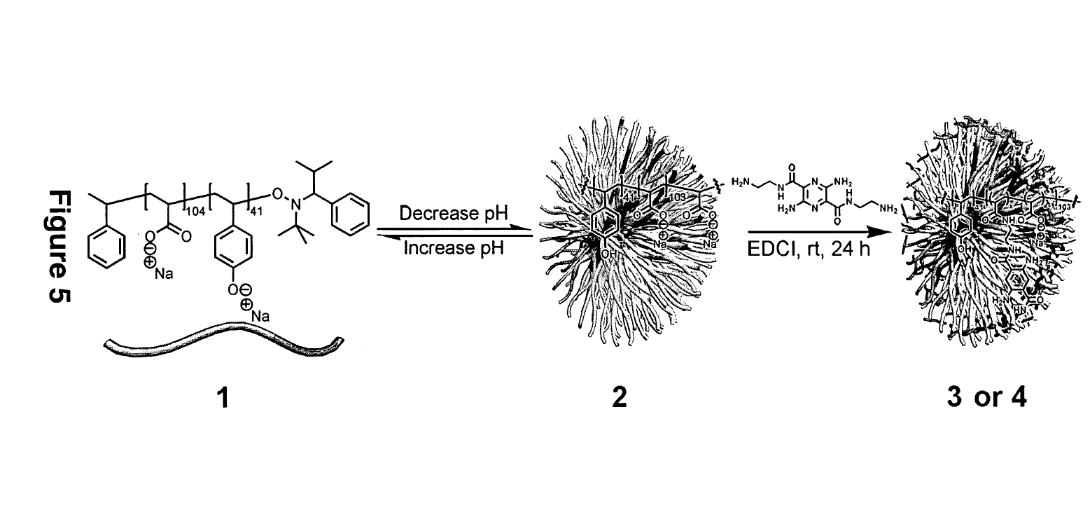

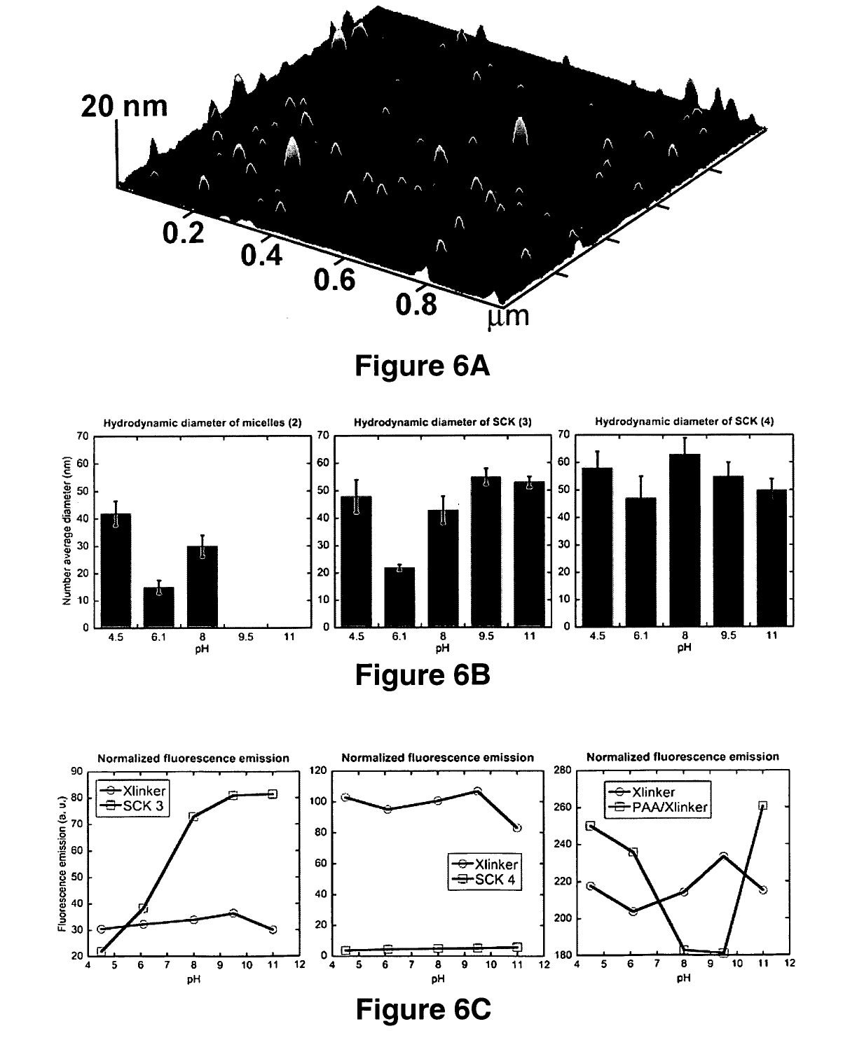

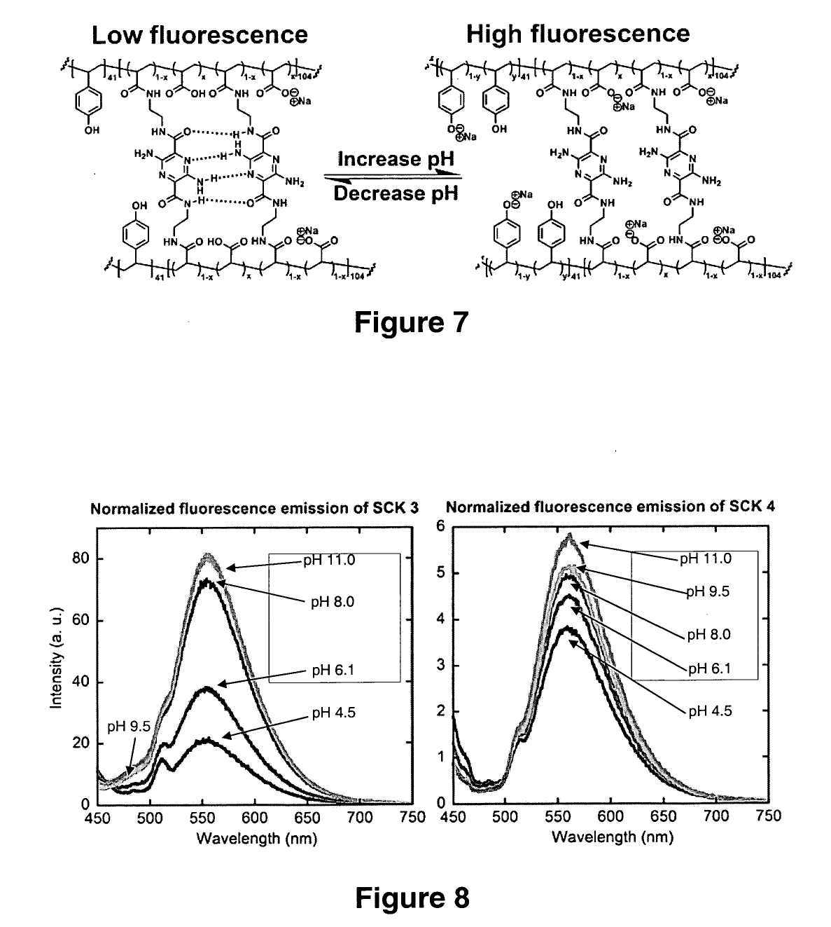

In some experiments, the resulting micelle solution was incubated with 6.25 mol % (a) or 12.5 mol % (b) of diamine-terminated pyrazine with (II) or without (I) three ethylene oxide units. The resulting solution of micelle and the crosslinker underwent covalent crosslinking by addition of EDCI, resulting in nanoparticles having hydrodynamic diameters of ca. 20 nm (as measured by DLS) and whose heights were ca. 8 nm (as measured by atomic force microscopy, AFM). FIG. 6 illustrates a representative AFM image of I-a, with an average height of 8 nm. The SCK solutions were dialyzed against 5 mM PBS at pH 7.4 for three days and then were partitioned into six vials each containing 5 mL of 5 mM PBS at pH 4.5, 6.1, 8.0, 9.5, 11.0, or 12.8.

As the SCK solution pH increases, two factors play major roles in expansion of the nanoparticles: 1) as more poly(acrylic acid) blocks become deprotonated, negatively-charged carboxylates repel PAA chains from one another within the confined SCK structure; 2) as the PpHS blocks become deprotonated at higher pH (i.e., >10), the hydrophilicity of the PpHS core increases, allowing water molecules to enter the shell-crosslinked nanoparticles. The acrylamide-pyrazine linkages are included so the composition would be able to respond to the SCKs' dual shell and core pH-driven expansion mechanisms by fluorescing upon loss of self-attractive interactions, such as hydrogen bonding, hydrophobic effects, and pi-stacking, but suffer fluorescence quenching as self-associations re-establish at lower pH values (See, FIG. 5). Due to their D₂ₕ symmetry, 2,6-diamino-2,5-diamide substituted pyrazines are quadrupolar dyes displaying photophysical characteristics that are fairly insensitive to pH changes.

Taking advantage of the SCKs' pH-responsive expansion are the diamine-terminated pyrazines, which fluoresce upon loss of intermolecular hydrogen bonding, but whose fluorescence quenches as the hydrogen bonding reestablishes. FIG. 5 illustrates the swelling/deswelling of photonic SCKs as a function of pH, where n=0 for I and n=3 for II. These pyrazine molecules are quadrupoles whose photophysical characteristics are fairly insensitive to pH changes. Thus, the resulting photophysical changes are a function of the nanostructure morphology.

Covalent crosslinking between the pyrazine units and the PAA shells, thereby, affords photonic SCKs for potential pH sensing. Covalent crosslinking between pyrazine and PAA shells constitutes photonic SCKs for potential biomedical applications. We expected to observe the photophysical consequences of the deprotonated PAA shell from pH 4.5 to 9.5 and those of the PpHS core from pH 9.5 to 11. In order to test our hypothesis, UV-vis and fluorescence measurements were collected on the resulting SCK solutions over the pH range of 4.5 to 11.0 to determine the pyrazine concentration, and then normalize the concentration relative to the fluorescence intensity values (See, FIG. 8). To demonstrate this aspect, UV-vis and fluorescence measurements were conducted on the resulting SCK solutions at different pH values, to verify the consistency in the amount of pyrazine loading in each set and to observe enhancement of photophysical properties of photonic SCKs, respectively. To observe the photophysical properties of the photonic SCKs, the data for the pyrazines within the SCK shell layers were compared between the two SCKs having different degrees of pyrazine loading and also against the pyrazine crosslinker associated physically with PAA and as a small molecule in buffered solutions.

The UV-vis and fluorescence data support the hypothesis that expansion of the fluorophore-SCKs as a function of pH provides a unique local environment to mediate the fluorescence outputs. The UV-vis measurements of 3 and 4 indicated no significant variation among data sets, confirming consistent amounts of pyrazine loading in each sample. There was an order of magnitude greater fluorescence emission intensity, however, for 3 vs. 4 (FIG. 8), suggesting that a limited amount of the fluorophore-based crosslinkers can be accommodated within the SCK shell domain while avoiding fluorescence quenching, over all of the pH values studied. Dynamic light scattering data (See, FIG. 6B) further supported this suggestion, as the variability in the SCK hydrodynamic diameter was reduced at the higher crosslinking density (12.5 mol % fluorophore for 4), whereas the lower degree of crosslinking (6.25 mol % fluorophore for 3) allowed for significant shell and core expansion with increasing pH (See, FIG. 6B). The most notable enhancement in fluorescence occurred from pH 6.1 to 8.0 (Table 1), the physiologically-relevant pH range. FIG. 6A shows a representative AFM image of a photonic SCK micelle of the present invention, having an average height of 8 nm.

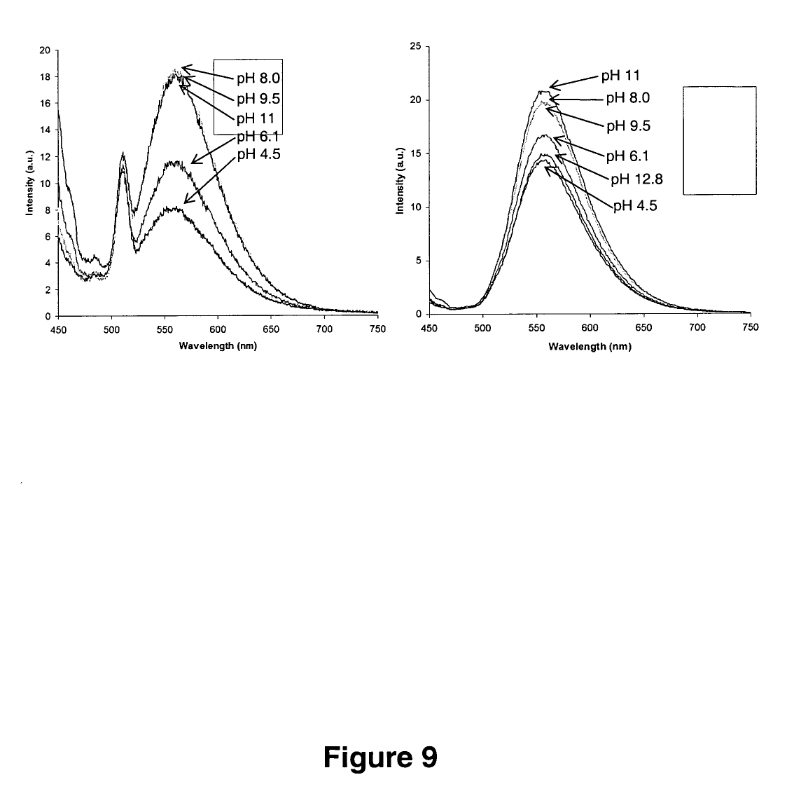

Fluorescence measurements, however, indicated significant enhancement as solution pH increased from 4.5 to 11.0, with the most notable enhancement being from 6.1 to 8.0. FIGS. 8 and 9 show fluorescence measurements of I-a, I-b, II-a, and II-b as a function of pH. All four SCK sample sets experienced the highest enhancement in fluorescence within that pH region (see, Table 1). The UV-vis and the fluorescence measurements demonstrate that the expansion of the fluorophore-SCKs at high pH disrupts the hydrogen bonding among pyrazine molecules, lowering fluorescence output. However, at pH 12.8, there was a significant drop in fluorescence (See, Table 1. I-b and II-b). In this pH region, deprotonated PpHS's quenching effect dominated, resulting in a net decrease in fluorescence.

TABLE 1
Percent increase in fluorescence as a function
of pH and fluorophore loading in SCKs I and II.

| | I | | II | |
|---|---|---|---|---|
| SCK solution | 12.5% xlink | 25.0% xlink | 12.5% xlink | 25.0% xlink |
| pH | (a) | (b) | (a) | (b) |
| pH 4.5 | 0% | 0% | 0% | 0% |
| pH 6.1 | 100% | 7% | 20% | 17% |
| pH 8.0 | 380% | 21% | 90% | 38% |
| pH 9.5 | 415% | 22% | 90% | 38% |
| PH 11.0 | 445% | 35% | 80% | 45% |
| pH 12.8 | N/A | 21% | N/A | 4% |

Only when covalently linked within the SCK shell did the pyrazine fluorophores experience an increase in fluorescence emission with increasing pH. As illustrated in FIG. 6C, the pyrazine crosslinker as a small molecule in solution or in the presence of PAA underwent no change in fluorescence intensity or gave a slight decrease in intensity on increasing from pH 4.5 to 6.1 and another decrease in intensity on increasing to pH 8.0, where it remained constant until pH 11.0 at which a slight fluorescence intensity increase was observed. In contrast, significant increases in fluorescence emission were observed for the pyrazines in 3 (Table 2), ca. 330% increase over the pH range where expansion of the shell is expected due to deprotonation of residual acrylic acid residues, and ca. 370% fluorescence increase with deprotonation of the phenolic groups and expansion of the core domain, each relative to the fluorescence intensity observed at pH 4.5. The higher degree of crosslinking and higher loading of pyrazine of 4 limited the nanostructure expansion and promoted pyrazine-pyrazine fluorescence quenching, which together reduced the observed effects on fluorescence intensity (FIG. 6C and Table 2).

TABLE 2
Normalized percent increase in fluorescence as a
function of pH and fluorophore loading in SCK.

| | Normalized percent increase | | | |
|---|---|---|---|---|
| solution pH | SCK 3^{[a]} | SCK 4^{[b]} | PAA/Xlinker^{[c]} | Xlinker^{[d]} |
| pH 4.5 | 100% | 100% | 100% | 100% |
| pH 6.1 | 180% | 120% | 90% | 100% |
| pH 8.0 | 330% | 130% | 70% | 100% |
| pH 9.5 | 370% | 140% | 70% | 110% |
| pH 11.0 | 370% | 150% | 100% | 100% |

^{[a]}6.25 mol % fluorophore loading
^{[b]}12.5 mol % fluorophore loading
^{[c]}PAA and fluorophore complex at 6.25 mol % fluorophore loading, relative to acrylic acid residues
^{[d]}fluorophore stock solution.

According, these results, demonstrated successful preparation and characterization of fluorophore-SCKs using a bifunctional optical probe molecule as a photonic linkage system for the shell-crosslinking step in SCK formation. We utilize a pH-insensitive fluorophore to generate a pH-sensing assembly through its covalent incorporation within a nanostructure derived from pH-responsive polymers. The bifunctional fluorophore could then be described as a photonic linkage system for the shell-crosslinking step in SCK formation.

Dynamic light scattering data and UV-vis/fluorescence measurements together have shown that the fluorophore-SCKs respond morphologically to pH (swell at high pH and shrink at low pH) through the incorporation of functionality of differential pKₐ (i.e. phenols/carboxylate). Photophysical consequences of these changes in morphology were manifested as “fluorescence on” at higher pH values and “fluorescence off” at lower pH values due to proximity quenching. Biomedical uses for these new photonic nanosystems include chemical/physiological sensors, among other applications.

### Experimental Section

Synthesis of poly(tert-butyl acrylate)₁₀₄ (5): To a flame-dried 50-mL Schlenk flask equipped with a magnetic stir bar and under N₂ atmosphere, at room temperature (rt), was added 2,2,5-trimethyl-3-(1′-phenylethoxy)-4-phenyl-3-azahexane (600 mg, 1.84 mmol), 2,2,5-trimethyl-4-phenyl-3-azahexane-3-nitroxide (20.0 mg, 0.092 mmol), and tent-butyl acrylate (31.5 g, 245 mmol). The reaction flask was sealed and stirred 10 min at rt (i.e. room temperature). The reaction mixture was degassed through three cycles of freeze-pump-thaw. After the last cycle, the reaction mixture was recovered back to rt and stirred for 10 min before being immersed into a pre-heated oil bath at 125° C. to start the polymerization. After 72 h, ¹H NMR analysis showed 72% monomer conversion had been reached. The polymerization was quenched by quick immersion of the reaction flask into liquid N₂. The reaction mixture was dissolved in THF and precipitated into H₂O/MeOH (v:v, 1:4) three times to afford white powder, (19.3 g, 85% yield based upon monomer conversion); M_{n,GPC}=13,700 Da, PDI=1.1, DP=104.

Synthesis of poly(tert-butylacrylate)₁₀₄-b-poly(acetoxystyrene)₄₁ (6): To a flame-dried 50-mL Schlenk flask equipped with a magnetic stir bar and under N₂ atmosphere at rt, 5 (3.0 g, 0.22 mmol) and 4-acetoxystyrene (4.44 g, 27.4 mmol) were added. The reaction mixture was allowed to stir for 1 h at it to obtain a homogenous solution. The reaction mixture was degassed through three cycles of freeze-pump-thaw. After the last cycle, the reaction mixture was recovered back to it and stirred for 10 min before being immersed into a pre-heated oil bath at 125° C. to start the polymerization. After 6 h, 32% monomer conversion was reached, as analyzed by ¹H NMR spectroscopy. After quenching by immersion of the reaction flask into a bath of liquid N₂, THF was added to the reaction mixture and the polymer was purified by precipitating into H₂O/MeOH (v:v, 1:4) three times to afford 6 as a white powder, (3.73 g, 83% yield); M_{n,GPC}=17,400 Da, PDI=1.3, DP=41.

Preparation of poly(tert-butyl acrylate)₁₀₄-b-poly(p-hydroxystyrene)₄₁ (7): To a 25-mL round bottom (RB) flask, (6) (3.0 g, 0.15 mmol) and MeOH (10 mL) were added and stirred 10 min at rt. The cloudy mixture was heated slowly to reflux. Immediately after the solution turned clear, a sodium methoxide solution in MeOH (25 wt %) (26 mg, 0.12 mmol) was added through syringe. The reaction mixture was further allowed to heat at reflux for 4 h. After cooling down to rt, the reaction mixture was precipitated in water with 4% acetic acid to afford 7 as white solid (2.6 g, 95% yield). M_{n,NMR}=18,600 Da.

Synthesis of poly(acrylic acid)₁₀₄-b-poly(p-hydroxystyrene)₄₁ (1): To a 50 mL RB flask equipped with a stir bar, was added 7 (2.5 g, 0.13 mmol) and trifluoroacetic acid (20.2 g, 177 mmol). The reaction mixture was allowed to stir for 24 h at rt. Excess acid was removed under vacuum. The residue was dissolved into 10 mL of THF and purified by dialysis against nanopure water (18.0 MΩ-cm) for three days and freeze-dried to afford 1 as a white powder (1.6 g, 95% yield). M_{nNMR}=12,000 Da

Preparation of micelle 2 from 1: To a 50 mL of RB flask equipped with a magnetic stir bar was added 1 (2.0 mg, 0.16 μmol) and 15 mL of nanopure water. The pH value was adjusted to 12 by adding 1.0 M NaOH solution to afford a clear solution. The micellization was initiated after decreasing the pH value to 7 by adding dropwise 1.0 M HCl. After further stirring 12 h at rt, the micelle solution was used directly for construction of SCK 3 and 4.

Preparation of shell-crosslinked nanoparticles (SCK 3 or 4) from micelle 2: To a 50 mL RB flask equipped with a magnetic stir bar was added a solution of micelles in nanopure H₂O (15.0 mL, 0.016 mmol of carboxylic acid residues). To this solution, was added a solution of 3,6-diamino-N²,N⁵-bis(2-aminoethyl)pyrazine-2,5-dicarboxamide (0.397 mg, 1.12 μmol (6.25 mol % relative to the acrylic acid residues) for 12.5% crosslinking extent; or 0.794 mg, 2.24 μmol (12.5 mol % relative to the acrylic acid residues) for 25% crosslinking extent) in 1 mL nanopure H₂O. The reaction mixture was allowed to stir for 2 h at rt. To this solution was added, dropwise via a syringe pump over 1 h, a solution of 1-[3′-(dimethylamino)propyl]-3-ethylcarbodiimide methiodide (EDCI, 0.849 mg, 2.86 μmol for 12.5% crosslinking extent; or 1.70 mg, 5.72 μmol for 25% crosslinking extent) in nanopure H₂O (1.0 mL) and the reaction mixture was further stirred for 16 h at rt. Finally, the reaction mixture was transferred to pre-soaked dialysis tubing (MWCO ca. 3,500 Da) and dialyzed against nanopure water for 3 d to remove the small molecule starting materials and by-products, and afford aqueous solutions of SCK 3 and 4. SCK solutions for DLS, UV-vis, and fluorescence studies were further partitioned into six vials each containing 5 mM PBS (with 5 mM NaCl) at pH values of 4.5, 6.1, 8.0, 9.5, and 11.

Synthesis of 3,6-diamino-N²,N⁵-bis(2-aminoethyl)pyrazine-2,5-dicarboxamide: A mixture of sodium 3,6-diaminopyrazine-2,5-dicarboxylate (500 mg, 2.07 mmol), tert-butyl 2-aminoethylcarbamate (673 mg, 4.20 mmol), HOBt (836 mg, 5.46 mmol) and EDCI (1.05 g, 5.48 mmol) in DMF (25 mL) was allowed to stir for 16 h and was then concentrated. The residue was partitioned with 1 N NaHSO₄ (200 mL) and EtOAc (200 mL). The organic layer was separated and washed with water (200 mL×3), sat. NaHCO₃ (200 mL×3) and brine. Dried with MgSO₄, filtered and concentrated to afford the bisamide as an orange foam. 770 mg, 76% yield. ¹H NMR (300 MHz, DMSO-d₆)major conformer, δ8.44 (t, J=5.7 Hz, 2H), 6.90 (t, J=5.7 Hz, 2H), 6.48 (br, 4H), 2.93-3.16 (m, 8H), 1.37 (s, 9H), 1.36 (s, 9H) ppm. ¹³C NMR (75 MHz, DMSO-d₆), δ 165.1, 155.5, 155.4, 146.0, 126.2, 77.7, 77.5, 45.2, 44.5, 28.2 ppm. LC-MS (15-95% gradient acetonitrile in 0.1% TFA over 10 min), single peak retention time=7.18 min on 30 mm column, (M+H)⁺=483 amu. To the product (770 mg, 1.60 mmol) in methylene chloride (100 mL), was added TFA (25 mL) and the reaction was stirred at room temperature for 2 h. The mixture was concentrated and the residue was dissolved into methanol (15 mL). Diethyl ether (200 mL) was added and the orange solid precipitate was isolated by filtration and dried at high vacuum to afford an orange powder. 627 mg, 77% yield. ¹H NMR (300 MHz, DMSO-d₆) δ 8.70 (t, J=6 Hz, 2H), 7.86 (br, 6H), 6.50 (br, 4H), 3.46-3.58 (m, 4H), 3.26-3.40 (m, 4H) ppm. ¹³C NMR (75 MHz, DMSO-d₆) δ 166.4, 146.8, 127.0, 39.4, 37.4 ppm. LC-MS (15-95% gradient acetonitrile in 0.1% TFA over 10 min), single peak retention time=2.60 min on 30 mm column, (M+H)⁺=283 amu. UV-vis (100 μM in PBS) λ_{abs}=435 nm. Fluorescence (100 nM) λₑₓ=449 nm, λₑₘ=562 nm. The product was converted to the HCl salt by coevaporation (3×100 mL) with 1 N aqueous HCl.

### Example 2

### General Methods for Photonic Cross-Linker Synthesis

Analytical thin layer chromatography (TLC) was performed on Analtech 0.15 mm silica gel 60-GF₂₅₄ plates. Visualization was accomplished with exposure to UV light, exposure to Iodine or by dipping in an ethanolic PMA solution followed by heating. Solvents for extraction were HPLC or ACS grade. Chromatography was performed by the method of Still with Merck silica gel 60 (230-400 mesh) with the indicated solvent system. NMR spectra were collected on a Bruker ARX-500, or Varian Mercury-300 spectrometer. ¹H NMR spectra were reported in ppm from tetramethylsilane on the δ scale. Data are reported as follows: Chemical shift, multiplicity (s=singlet, d=doublet, t=triplet, q=quartet, m=multiplet, b=broadened, obs=obscured), coupling constants (Hz), and assignments or relative integration. ¹³C NMR spectra were reported in ppm from the central deuterated solvent peak. Grouped shifts are provided where an ambiguity has not been resolved. Preparative reversed phased liquid chromatrography runs were conducted on a low pressure system employing an AllTech Model 7125 Rheodyne Injector Valve with a 5 mL sample loop, an AllTech Model 426 pump, an ISCO UA-6 absorbance detector with built-in recorder, peak separator and type 11 optical unit, an ISCO Foxy 200 fraction collector and using Lobar LiChroprep RP-18 (40-63 μm) prepacked columns and on a Waters Autopurification System using a Waters XBrigdge Preparative C18 OBD 30×150 mm column. LCMS were run on a Shimadzu LCMS-2010A using Agilent Eclipse (XDB-C18, 4.6×30 mm, 3.5-Micron) Rapid Resolution Cartridges and Agilent Eclipse (XDB-C18 4.6×250 mm, 3.5-Micron) Columns. GCMS were run on a Varian Saturn 2000 using a DB5 capillary column (30 m×0.25 mm I.D., 1.0 p film thickness). MALDI mass spectra were run on a PE Biosystems Voyager System 2052. Electronic absorption spectra were measured in phosphate buffered saline using a Shimadzu UV-3101PC UV-VIS-NIR scanning spectrophotometer. Emission spectra were recorded in phosphate buffered saline using a Jobin Yvon Fluorolog-3 fluorescence spectrometer.

### Abbreviations

AFM Atomic Force Microscopy

Arg Arginine

DMF Dimethyl formamide

DLS Dynamic Light Scattering

DP Degree of Polymerization

Dz Intensity averaged hydrodynamic diameter

Dn Number averaged hydrodynamic diameter

EDC-HCl 1-(3-Dimethylaminopropyl)-3-ethylcarbodiimide hydrochloride

ESI Electrospray Ionization

EtOAc Ethyl Acetate

GPC Gel Permeation Chromatography

HOBt-H2O 1-Hydroxybenzotriazole hydrate

HRMS High Resolution Mass Spectrometry

IR Infrared Spectroscopy

LCMS Liquid Chromatography-Mass Spectrometry

MeOH Methanol

Mn Number Average Molecular Weight

MS Mass Spectrometry

MWCO Molecular Weight Cut-Off

NMR Nuclear Magnetic Resonance Spectroscopy

PBS Phosphate Buffered Saline

PDI Polydispersity Index

PMA Phosphomolybdic acid stain

PTA Phosphotungstic acid stain

SCK Shell Cross-Linked Nanoparticle

TEA Triethylamine

TEM Transmission Electron Microscopy

TFA Trifluoroacetic acid

THF Tetrahydrofuran

TLC Thin Layer Chromatography

Photonic Cross-Linker Chemistry

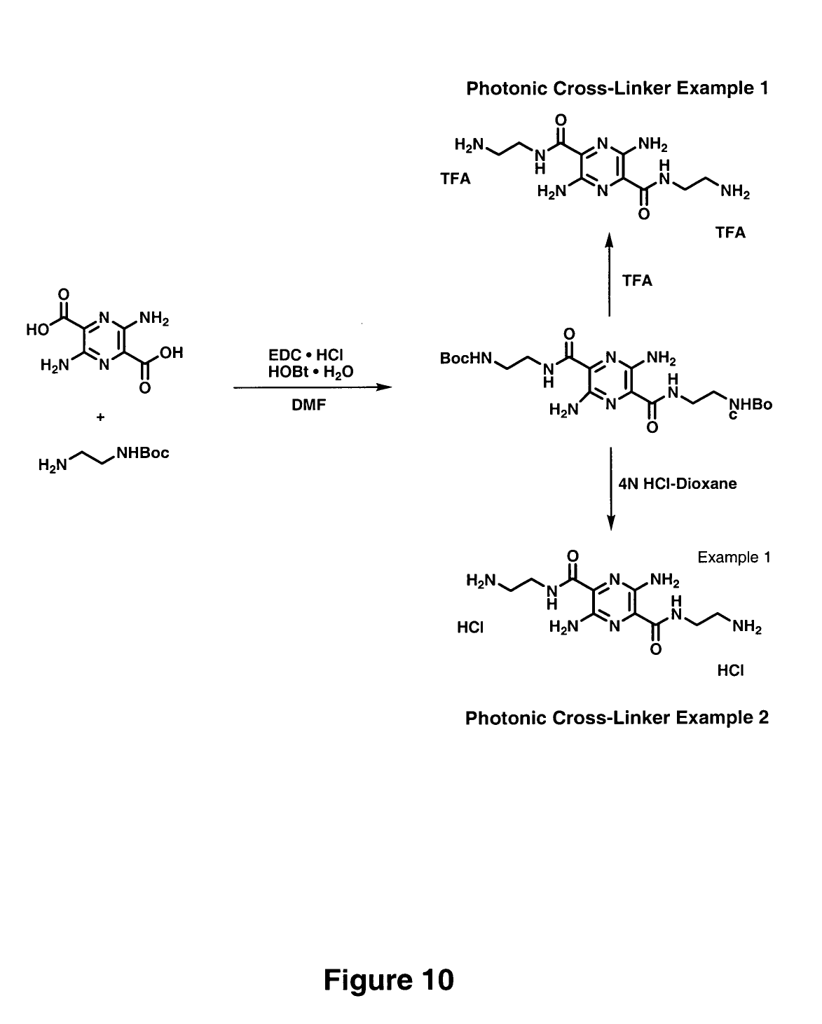

Photonic Cross-Linker Example 1: 3,6-diamino-N²,N⁵-bis(2-aminoethyl)pyrazine-2,5-dicarboxamide bis-TFA salt. FIG. 10 illustrates a synthetic pathway for production of Photonic Cross-linker Example 1.

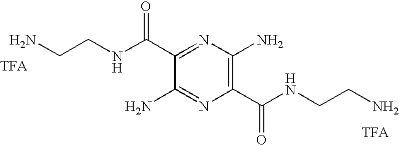

### Step 1. Synthesis of 3,6-diamino-N²,N⁵-bis[2-(tert-butoxycarbonyl)aminoethyl]pyrazine-2,5-dicarboxamide

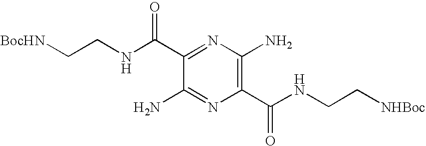

A mixture of sodium 3,6-diaminopyrazine-2,5-dicarboxylate (500 mg, 2.07 mmol), tert-butyl 2-aminoethylcarbamate (673 mg, 4.20 mmol), HOBt-H₂O (836 mg, 5.46 mmol) and EDC-HCl (1.05 g, 5.48 mmol) in DMF (25 mL) was stirred for 16 h and concentrated. The residue was partitioned with EtOAc (100 mL) and 1N NaHSO₄ (100 mL). The layers were separated and the EtOAc solution was washed with water (100 mL), saturated sodium bicarbonate (100 mL) and brine (100 mL). The EtOAc layer was dried (MgSO₄), filtered and concentrated to afford 770 mg (76% yield) of the bisamide as an orange foam: ¹H NMR (300 MHz, DMSO-d₆), major comformer, δ 8.44 (t, J=5.7 Hz, 2H), 6.90 (t, J=5.7 Hz, 2H), 6.48 (bs, 4H), 2.93-3.16 (complex m, 8H), 1.37 (s, 9H), 1.36 (s, 9H). ¹³C NMR (75 MHz, DMSO-d₆), conformational isomers δ 165.1 (s), 155.5 (bs), 155.4 (bs), 146.0 (s), 126.2 (s), 77.7 (bs), 77.5 (bs), 45.2 (bt), 44.5 (bt), 28.2 (q).

Step 2. To the product from step 1 (770 mg, 1.60 mmol) in methylene chloride (100 mL) was added TFA (25 mL) and the reaction was stirred at room temperature for 2 h. The mixture was concentrated and the residue taken up into methanol (15 mL). Ether (200 mL) was added and the orange solid precipitate was isolated by filtration and dried at high vacuum to afford 627 mg (77% yield) of Photonic Cross-Linker Example 1 as an orange powder: ¹H NMR (300 MHz, DMSO-d₆), δ 8.70 (t, J=6 Hz, 2H), 7.86 (bs, 6H), 6.50 (bs, 4H), 3.46-3.58 (m, 4H), 3.26-3.40 (m, 4H). ¹³C NMR (75 MHz, DMSO-d₆) δ 166.4 (s), 146.8 (s), 127.0 (s), 39.4 (t), 37.4 (t). LCMS (5-95% gradient acetonitrile in 0.1% TFA over 10 min), single peak retention time=3.62 min on 30 mm column, (M+H)⁺=283. UV/vis (100 μM in PBS) λ_{abs}=435 nm. Fluorescence (100 nM) λₑₓ=449 nm, λₑₘ=562 nm.

Photonic Cross-Linker Example 2: 3,6-diamino-N²,N⁵-bis(2-aminoethyl)pyrazine-2,5-dicarboxamide dihydrochloride. FIG. 10 illustrates a synthetic pathway for production of Photonic Cross-linker Example 2.

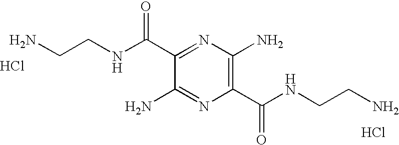

The product from Example 1, step 1 (351 mg, 0.73 mmol) was dissolved in 4N HCl-dioxane (35 mL) and the reaction mixture was stirred for 30 min at room temperature. The reaction was concentrated and triturated with ether (100 mL) to afford 226 mg (87% yield) of Photonic Cross-Linker Example 2 as an orange solid: MS (ESI) m/z=283 [M+H]⁺. UV/vis (100 μM in PBS) λ_{abs}=435 nm. Fluorescence (100 nM) λₑₓ=449 nm, λₑₘ=562 nm.

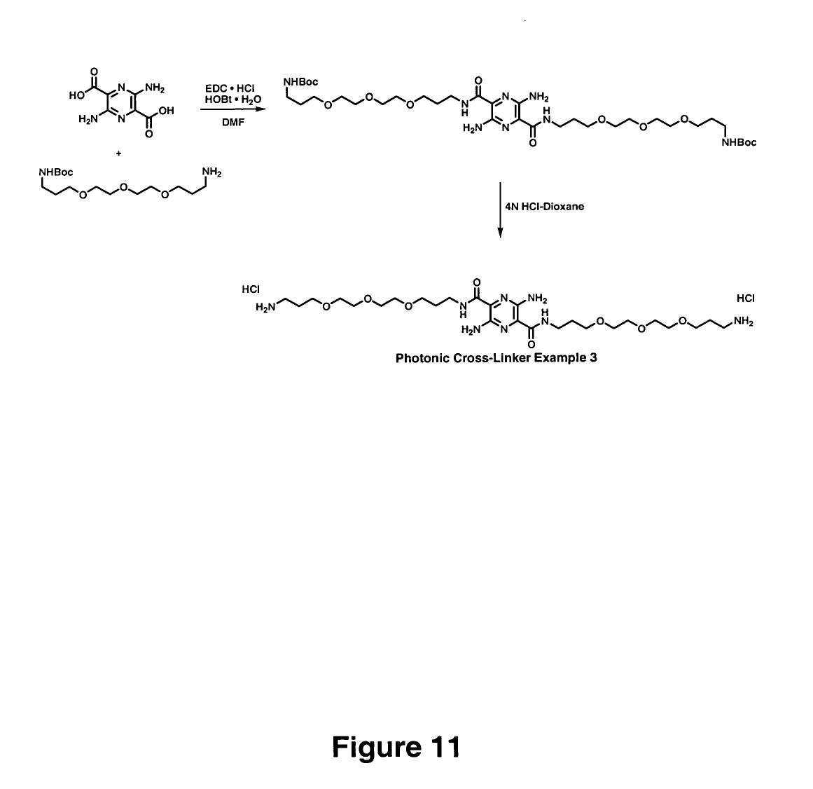

Photonic Cross-Linker Example 3: 3,6-diamino-N²,N⁵-bis(3-(2-(2-(3-aminopropoxy)ethoxy)ethoxy)propyl)pyrazine-2,5-dicarboxamide dihydrochloride. FIG. 11 illustrates a synthetic pathway for production of Photonic Cross-linker Example 3.

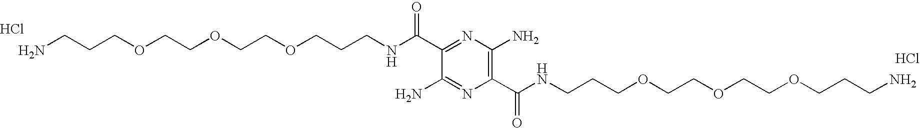

### Step 1. Synthesis of Tert-butyl 1,1′-(3,6-diaminopyrazine-2,5-diyl)bis(1-oxo-6,9,12-trioxa-2-azapentadecane-15,1-diyl)dicarbamate

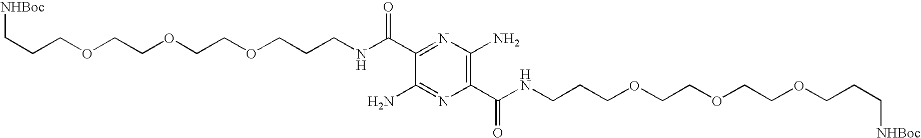

A mixture of 3,6-diaminopyrazine-2,5-dicarboxylic acid (0.31 g, 1.56 mmol), tert-butyl 3-(2-(2-(3-aminopropoxy)ethoxy)ethoxy)propylcarbamate (1.00 g, 3.12 mmol), EDC.HCl (0.72 g, 3.74 mmol) and HOBt (0.50, 3.74 mmol) was stirred in DMF (35 mL) for 16 hr at room temperature. Concentration and workup as in Photonic Cross-Linker Example 1 afforded the crude bis-amide which was taken on to the next step with no further purification: HRMS calcd for C₃₆H₆₆N₈O₁₂Na, 825.4692 [M+Na]⁺; found, 825.4674.

Step 2. The crude product mixture from step 1 (˜1.20 g, 1.50 mmol) was added 4N HCl-Dioxane (10 mL) and the resulting mixture was stirred for 1 hr at room temperature. Concentration, trituration of the residue with 1:1 hexanes-ether (100 mL) and pumping at high vacuum afforded Photonic Cross-Linker Example 3 as a viscous orange oil: LCMS (5-95% gradient acetonitrile in 0.1% TFA over 10 min), single peak retention time=5.70 min on 30 mm column, [M+H]⁺=603. UV/vis (100 μM in PBS) λ_{abs}=435 nm. Fluorescence (100 nM) λₑₓ=449 nm, λₑₘ=562 nm.

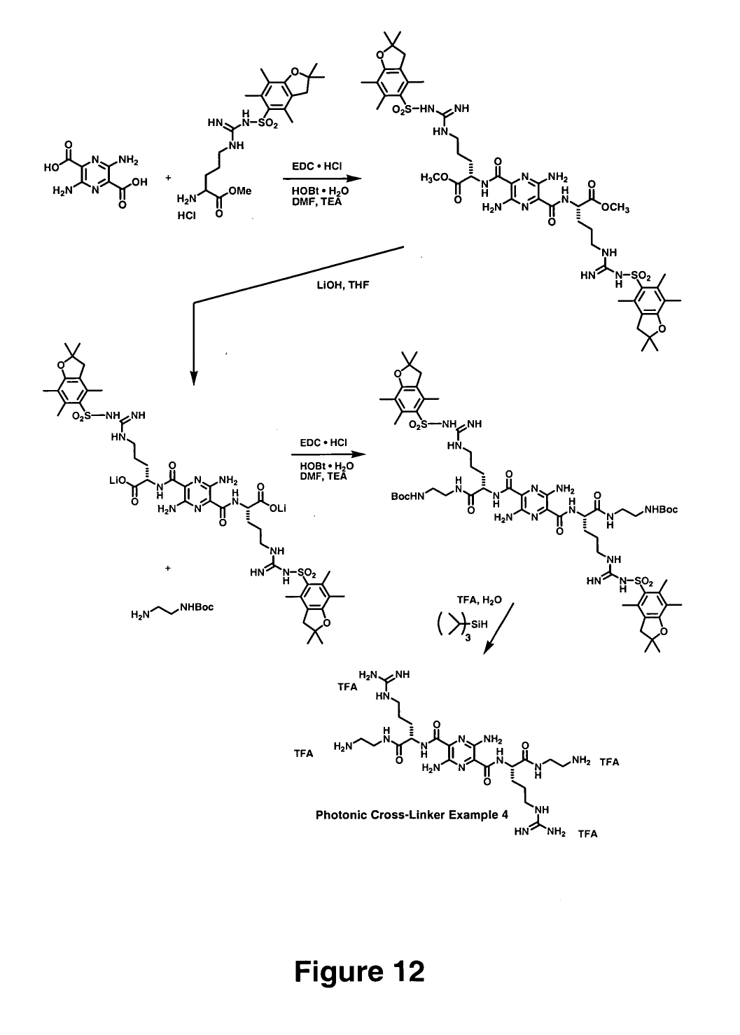

Photonic Cross-Linker Example 4: 3,6-Diamino-N2,N5-bis[N-(2-aminoethyl)-Arginine amide]-pyrazine-2,5-dicarboxamide tetra TFA salt. FIG. 12 illustrates a synthetic pathway for production of Photonic Cross-linker Example 4.

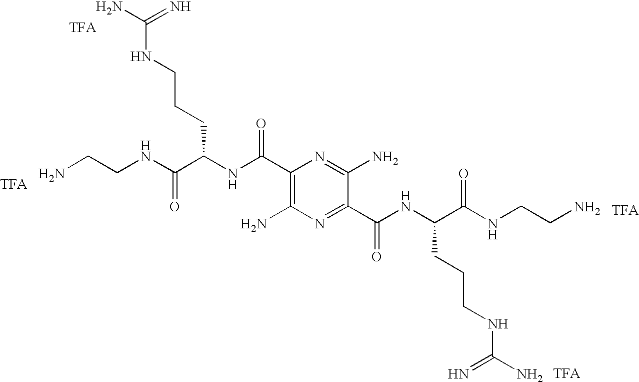

Step 1. Synthesis of 3,6-Diamino-N2,N5-bis(N-pbf-Arginine methyl ester)-pyrazine-2,5-dicarboxamide.

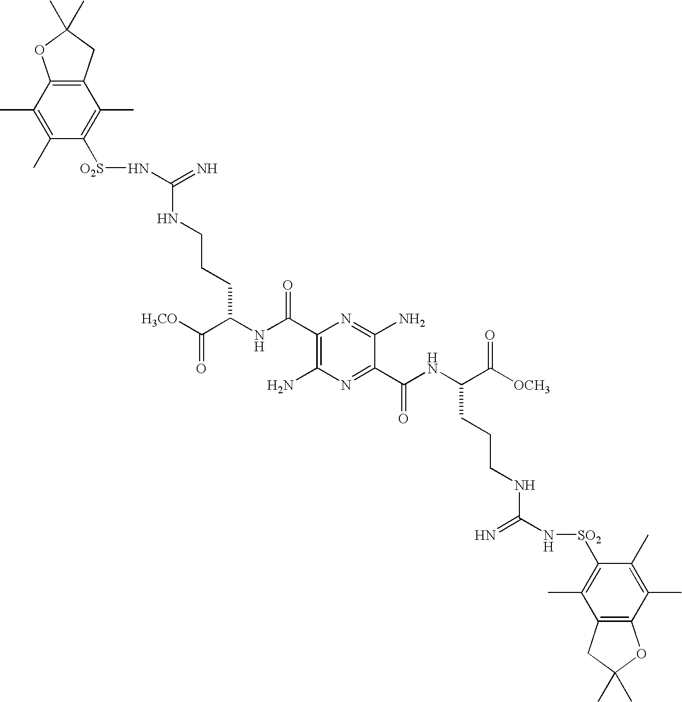

A mixture of 3,6-diaminopyrazine-2,5-dicarboxylic acid (0.90 g, 4.54 mmol), H-Arg(pbf)-OMe.HCl (4.77 g, 9.99 mmol), EDC (1.53 g, 9.99 mmol), HOBt (1.34 g, 9.99 mmol) and TEA (726 μL, 9.99 mmol) was stirred in DMF (35 mL) for 16 hr at room temperature. Concentration and workup as in Photonic Cross-Linker Example 1 followed by filtration through a plug of silica gel afforded the crude bis-amide which was taken on to the next step with no further purification.

Step 2. Synthesis of 3,6-Diamino-N2,N5-bis(N-pbf-Arginine)-pyrazine-2,5-dicarboxamide di-lithium salt.

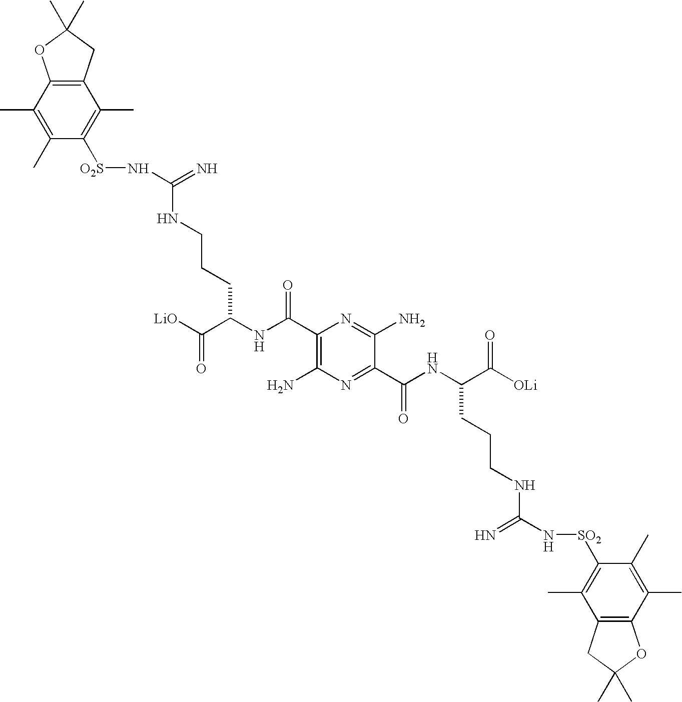

A solution of the product from Step 1 (2.40 g, 2.30 mmol) in THF (35 mL) was treated with a solution of lithium hydroxide (276 mg 11.5 mmol) in water (5.0 mL). After stirring for 1 hr at room temperature, HPLC analysis indicated reaction was complete. The reaction was quenched by the addition of dry ice and concentrated. This material was used in the next step without further purification.

### Step 3. Synthesis of 3,6-Diamino-N²,N⁵-bis[N-(2-Bocaminoethyl)-Arginine amide]-pyrazine-2,5-di-carboxamide

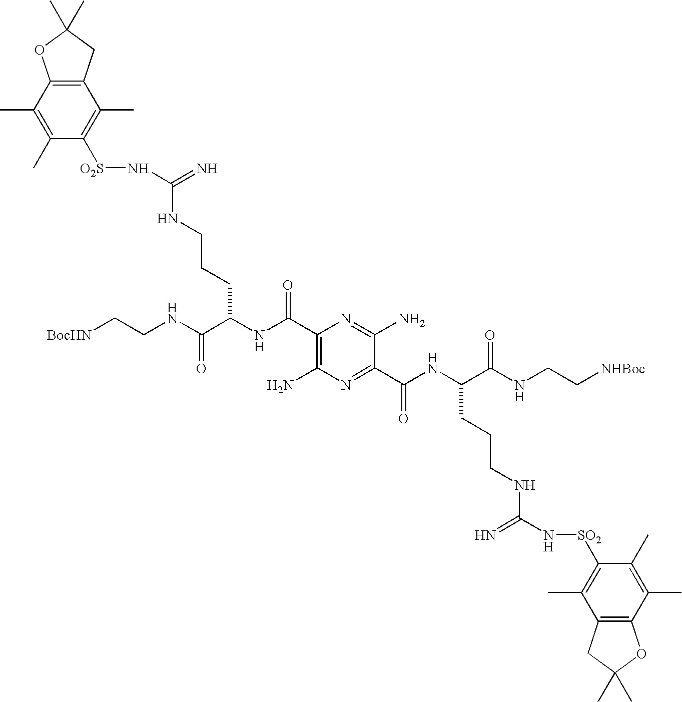

A mixture of the product from Step 2 (1.00 g, 0.97 mmol), tert-butyl 2-aminoethyl-carbamate (350 mg, 2.19 mmol), EDC.HCl (420 mg, 2.19 mmol) HOBt (290 mg, 2.15 mmol) and TEA (˜0.5 mL) in DMF (50 mL) was stirred at room temperature for 16 h. The reaction was concentrated and the residue was processed as in Photonic Cross-Linker Example 1 to afford 1.05 g of product as a red semi-solid: MS (ESI) [M+H]⁺=1300; [M+Na]⁺=1323. This material was used in the next step without further purification.

Step 4. Synthesis of Photonic Cross-Linker Example 4. To the product from Step 3 (900 mg, 0.69 mmol) was added TFA (9.25 mL), water (25 μL), and triisopropyl silane (25, μL). The resulting mixture was stirred at room temperature for 72 h (convenience—over weekend). The reaction mixture was concentrated. The residue was purified by preparative HPLC(C18, 30×150 mm column, 5% ACN in H₂O to 95% over 12 min, 0.1% TFA) to afford 178 mg (26% yield) of Photonic Cross-Linker Example 4 as a red foam: HRMS calcd for C₂₂H₄₃N₁₆O₄, 595.3648 [M+H]⁺; found, 595.3654.

Poly(acrylic Acid)-b-poly(p-hydroxystyrene) Chemistry: Synthesis of Block Copolymers Via Nitroxide-Mediated Radical Polymerization

Synthesis of poly(tert-butylacrylate)₁₀₄ (I): In a 50-mL Schlenk flask with a magnetic stir bar, 2,2,5-trimethyl-3-(1-phenylethoxy)-4-phenyl-3-azahexane (500 mg, 1.34 mmol), 2,2,5-trimethyl-4-phenyl-3-azahexane-3-nitroxide (17.0 mg, 0.077 mmol), and tert-butyl acrylate (16.4 g, 128 mmol) were mixed together. The reaction mixture underwent three cycles of freeze-pump-thaw. The reaction was heated to 125° C. rapidly in a pre-heated oil bath. After 23 hrs, the reaction was quenched in liquid nitrogen. The reaction mixture was dissolved in THF and precipitated in 20% H₂O in MeOH three times to afford white powder, (7.17 g, 86% yield); Mₙ=13,700 Da, PDI=1.1, DP=40, conv=61%.

Synthesis of poly(tert-butylacrylate)₁₀₄-b-poly(acetoxystyrene)₄₁ (II): In a 50-mL Schlenk flask, I (2.0 g, 0.37 mmol), 4-acetoxystyrene (5.95 g, 37 mmol), and DMF (0.5 mL) was added to obtain a homogenous mixture. The reaction mixture was heated to 125° C. in a pre-heated oil bath and heated under stirring for 23 h. The reaction was dissolved in THF and precipitated in 20% H₂O in MeOH three times to afford white powder, (5.81 g, 91% yield); Mₙ=17,402 Da, PDI=1.3, DP=70, conv=80%.

Synthesis of poly(tert-butylacrylate)₁₁₀ (III): In a 50-mL Schlenk flask with a magnetic stir bar, 2,2,5-trimethyl-3-(1-phenylethoxy)-4-phenyl-3-azahexane (600 mg, 1.84 mmol), 2,2,5-trimethyl-4-phenyl-3-azahexane-3-nitroxide (20.0 mg, 0.092 mmol), and tert-butyl acrylate (31.5 g, 245 mmol) were mixed together. The reaction mixture underwent three cycles of freeze-pump-thaw. The reaction was heated to 125° C. rapidly in a pre-heated oil bath. After 72 hrs, the reaction was quenched in liquid nitrogen. The reaction mixture was dissolved in THF and precipitated in 20% H₂O in MeOH three times to afford white powder, (19.33 g, 73% yield); Mₙ=14,400 Da, PDI=1.1, DP=40, conv=61%.

Synthesis of poly(tert-butylacrylate)₁₁₀-b-poly(acetoxystyrene)₂₀₇ (IV): In a 50-mL Schlenk flask, III (1.70 g, 0.108 mmol), 4-acetoxystyrene (11.87 g, 64.6 mmol), 2,2,5-trimethyl-4-phenyl-3-azahexane-3-nitroxide (1.19 mg, 5.39 μmol), and DMF (4.0 mL) was added to obtain a homogenous mixture. The reaction mixture was heated to 125° C. in a pre-heated oil bath and let stir for 8 h. The reaction was dissolved in THF and precipitated in 20% H₂O in MeOH three times to afford white powder, (3.84 g, 74% yield); Mₙ=48,300 Da, PDI=1.3, DP=200, conv=35%.

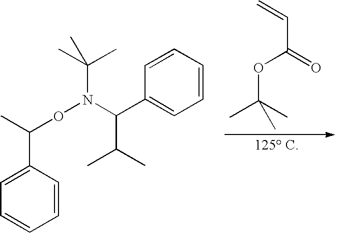

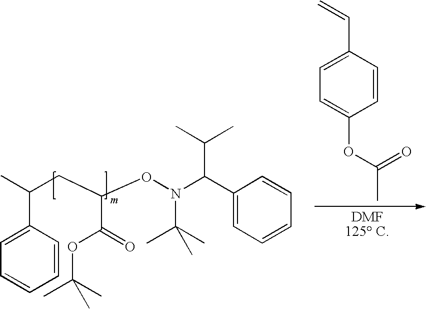

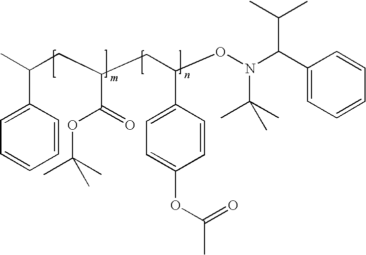

| Conditions | Characterizations | Condition | Characterizations |
|---|---|---|---|
| 23 h, 61% conv. | Mₙ^{GPC} = 13,700 Da | 23 h, 80% conv. | Mₙ^{GPC} = 17,400 Da |
| 86% yield | PDI = 1.1 | 90% yield | PDI = 1.3 |
| 72 h, 61% conv. | Mₙ^{GPC} = 14,400 Da | 8 h, 35% conv. | Mₙ^{GPC} = 48,300 Da |
| 73% yield | PDI = 1.1 | 74% yield | PDI = 1.3 |

m = 104
n = 41
m = 110
n = 207

Hydrolysis of II or IV to afford poly(tert-butylacrylate)₁₀₄-b-poly(p-hydroxystyrene)₄₁ (V) or poly(tert-butylacrylate)₁₁₀-b-poly(p-hydroxystyrene)₂₀₇ (VI): In a 25-mL rb flask, II (3.0 g, 0.148 mmol) or IV (3.84 g, 0.08 mmol) and MeOH (10 mL) were added and let stirred at rt for 10 min. A cloudy mixture was heated slowly to reflux. Immediately after the solution cleared, sodium methoxide (25% in MeOH) (26 mg, 0.12 mmol or 76 mg, 0.35 mmol) was syringed into the reaction pot. The reaction mixture was allowed to heat at reflux for 4 h. The reaction mixture was precipitated in acetic acid (4% in water) to afford 2.6 g (95% yield), Mₙ^{NMR}=18,600 Da (V) or 3.0 g (97% yield), Mₙ^{NMR}=38,700 Da (VI).

Acidolysis of V or VI to afford poly(acrylic acid)₁₀₄-b-poly(p-hydroxystyrene)₄₁ (VII) or poly(acrylic acid)₁₁₀-b-poly(p-hydroxystyrene)₂₀₇ (VIII): In a Schlenk flask, V (2.5 g, 0.134 mmol) or VI (2.9 g, 0.075 mmol) was added with a stir bar. Excess amount of trifluoroacetic acid (20.2 g, 177 mmol) was syringed into the reaction pot to solubilize the block copolymer and let stirred for 24 h. The reaction mixture was dissolved in 10 mL of methylene chloride. Residual acid and solvent were removed in vacuum. The purification process was repeated three times. Slightly pink solution was dialyzed against nanopure water for three days and freeze-dried to afford 1.6 g or 2.4 g of the white polymer (95% or 94% yield). IR (v): 3438 (OH inter-, intramolecular H-bond), 2928 (COOH dimer), 1654 (COOH intramolecular H-bond), 1560-1384 (COOH anion), 1249 (Aryl-OH), 1172-1123 (C—OH) cm⁻¹.

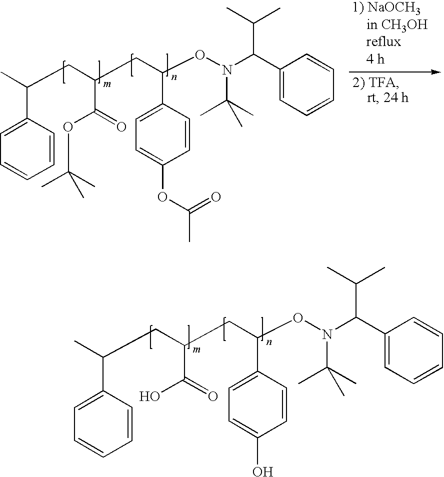

Photonic Shell Cross-Linked Nanoparticle Probe Chemistry

Preparation of micelles from VII or VIII: Micelles were prepared by first dissolving 2 mg of the block copolymer VII or VIII in 15 mL of nanopure water and stirring for 12 hrs.

Preparation of Shell Cross-Linked Nanoparticles (Sck) from Micelles: Micelle Solution pH was adjusted between 5 and 6. An electronic pipette was used to add 6.25 mol % or 12.5 mol % of diamine-terminated crosslinker (from stock solution with concentration 2.392 mg/mL or 6.2957 mg/mL) to the micelle solution and let stir for 3 hrs. To this reaction mixture was added dropwise, via a metering pump, a solution of 1-[3-(dimethylamino)propyl]-3-ethylcarbodiimide methiodide dissolved in nanopure water (12.5 mol % or 25.0 mol %). The reaction mixture was allowed to stir for 24 hrs at rt and was then transferred to presoaked dialysis membrane tube (MWCO ca. 3.5 kDa), and dialyzed against 5 mM PBS solution for three days to remove small molecules. SCK solutions for TEM and AFM studies were further dialyzed against nanopure water for three days and its pH adjusted to the desired value by addition of NaOH/HCl. SCK solutions for DLS, UV-vis, and fluorescence studies were further partitioned into six vials each containing 5 mM PBS at pH values 4.5, 6.1, 8.0, 9.5, 11.0, and 12.8.

Characterization Methods: Characterization of the polymers by gel permeation chromatography (GPC): Molecular weight and the molecular weight distribution (PDI) of the polymers I, II, III, and IV were determined by GPC. GPC was conducted on a Waters 1515 HPLC (Waters Chromatography, Inc.) equipped with a Waters 2414 differential refractometer, a PD2020 dual angle (15° and 90° light scattering detector (Precision Detectors, Inc.), and a three column series PL gel 5 μm Mixed C, 500 Å, and 10⁴ Å, 300×7.5 mm columns (Polymer Laboratories Inc.). The system was equilibrated at 35° C. in anhydrous THF, which served as the polymer solvent and eluent with a flow rate of 1.0 mL/min. Polymer solutions were prepared at a known concentration (ca. 3 mg/mL) and an injection volume of 200 μL was used. Data collection and analysis were performed, respectively, with Precision Acquire software and Discovery 32 software (Precision Detectors, Inc.). Interdetector delay volume and the light scattering detector calibration constant were determined by calibration using a nearly monodispersed polystyrene standard (Pressure Chemical Co., Mₚ=90 kDa, M_{w}/Mₙ<1.04). The differential refractometer was calibrated with standard polystyrene reference material (SRM 706 NIST), of known specific refractive index increment dn/dc (0.184 mL/g). The dn/dc values of the analyzed polymers were then determined from the differential refractometer response.

Analysis of the SCKs or micelles by dynamic light scattering (DLS): Hydrodynamic diameters (Dz, Dn) and size distributions for the SCKs in aqueous solutions were determined by dynamic light scattering (DLS). The DLS instrumentation consisted of a Brookhaven Instruments Limited (Holtsville, N.Y.) system, including a model BI-200SM goniometer, a model BI-9000AT digital correlator, a model EMI-9865 photomultiplier, and a model 95-2 Ar ion laser (Lexel, Corp.; Farmindale, N.Y.) operated at 514.5 nm. Measurements were made at 20 (1° C. Prior to analysis, solutions were centrifuged in a model 5414 microfuge (Brinkman Instruments, Inc.; Westbury, N.Y.) for 4 min to remove dust particles. Scattered light was collected at a fixed angle of 90°. The digital correlator was operated with 522 ratio spaced channels, an initial delay of 0.1 μs, a final delay of 5.0 μs, and a duration of 15 min. A photomultiplier aperture of 200 μm was used, and the incident laser intensity was adjusted to obtain a photon counting of 200 kcps. Only measurements in which the measured and calculated baselines of the intensity autocorrelation function agreed to within 0.1% were used to calculate particle size. The calculations of the particle size distributions and distribution averages were performed with the ISDA software package (Brookhaven Instruments Company), which employed single-exponential fitting, cumulants analysis, and nonnegatively constrained least-squares particle size distribution analysis routines. A stock solution of PBS was made by dissolving 7.564 g of NaH₂PO₄, 19.681 g of Na₂HPO₄, and 11.688 g of NaCl in 4 liters of nanopure water. After complete dissolution, NaOH or HCl was added to achieve the desired pH value. The samples were filtered using 0.45 μm pore size nylon membrane filters in order to remove dust and any large, nonmicellar aggregates.

Analysis of the SCKs or micelles by atomic force microscopy (AFM): The height measurements and distributions for the SCCs were determined by tapping-mode AFM under ambient conditions in air. The AFM instrumentation consisted of a Nanoscope III BioScope system (Digital Instruments, Veeco Metrology Group; Santa Barbara, Calif.) and standard silicon tips (type, OTESPA-70; L, 160 μm; normal spring constant, 50 N/m; resonance frequency, 224-272 kHz). The sample solutions were drop (2 μL) deposited onto freshly cleaved mica and allowed to dry freely in air.

Analysis of the SCKs or micelles by transmission electron microscopy (TEM): TEM samples were diluted in water (9:1) and further diluted with a 1% phosphotungstic acid (PTA) stain (1:1). Carbon grids were prepared by a plasma treatment to increase the surface hydrophilicity. Micrographs were collected at 100,000× magnification and calibrated using a 41 nm polyacrylamide bead standard from NIST. Histograms of particle diameters were generated from the analysis of a minimum of 150 particles from at least three different micrographs.

Analysis of the SCKs by UV-vis/Fluorescence: UV-vis spectroscopy data were acquired on a Varian Cary 1E UV-vis spectrophotometer. Fluorescence spectroscopy data were acquired on a Varian Cary Eclipse Fluorescence spectrophotometer. Each sample was prepared independently from a nanoparticle stock solution at ca. 0.13 mg/mL. Sample solutions at various pH values from 4.5, 6.1, 8.0, 9.5, 11.0, and 12.8 were excited at μₑₘ=435 nm, and the fluorescence emission spectra in the range 445-800 nm were recorded.

### Example 3

### Optical Results for Photon Shell Cross-Linked Nanoparticles

The optical properties of compositions of the present invention were evaluated. The optical absorption and optical fluorescence were measured as a function of pH for Photonic Cross-Linker Example 2, Photonic Cross-Linker Example 3, Shell Cross-Linked Nanoparticle Example 5, Shell Cross-Linked Nanoparticle Example 6, Shell Cross-Linked Nanoparticle Example 7, and Shell Cross-Linked Nanoparticle Example 8.

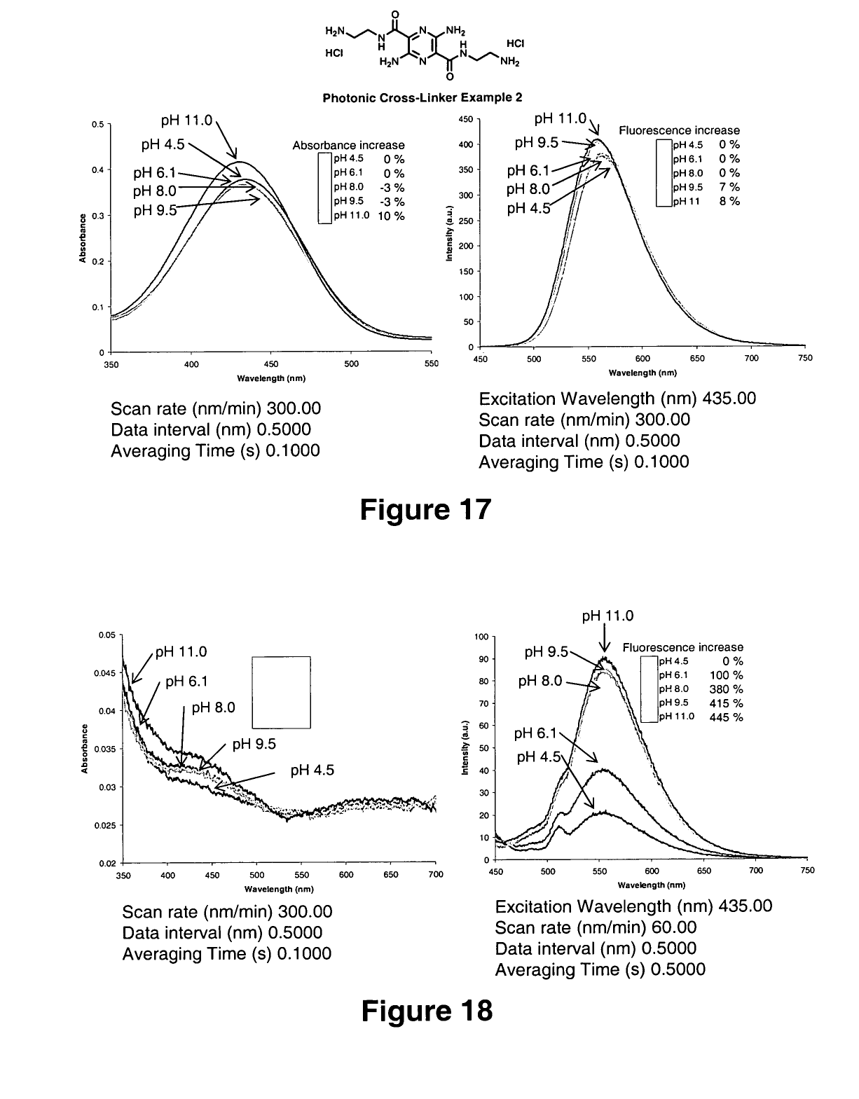

Control Experiment: Change in fluorescence output for Photonic Cross-Linker Example 2 alone (prior to cross-linking into nanoshells). As seen in FIG. 17, this molecule is relatively insensitive to pH change itself due to its quadrupolar nature; less than 10% change in fluorescence is observed in Photonic Cross-Linker Example 2 as a function of increasing pH.

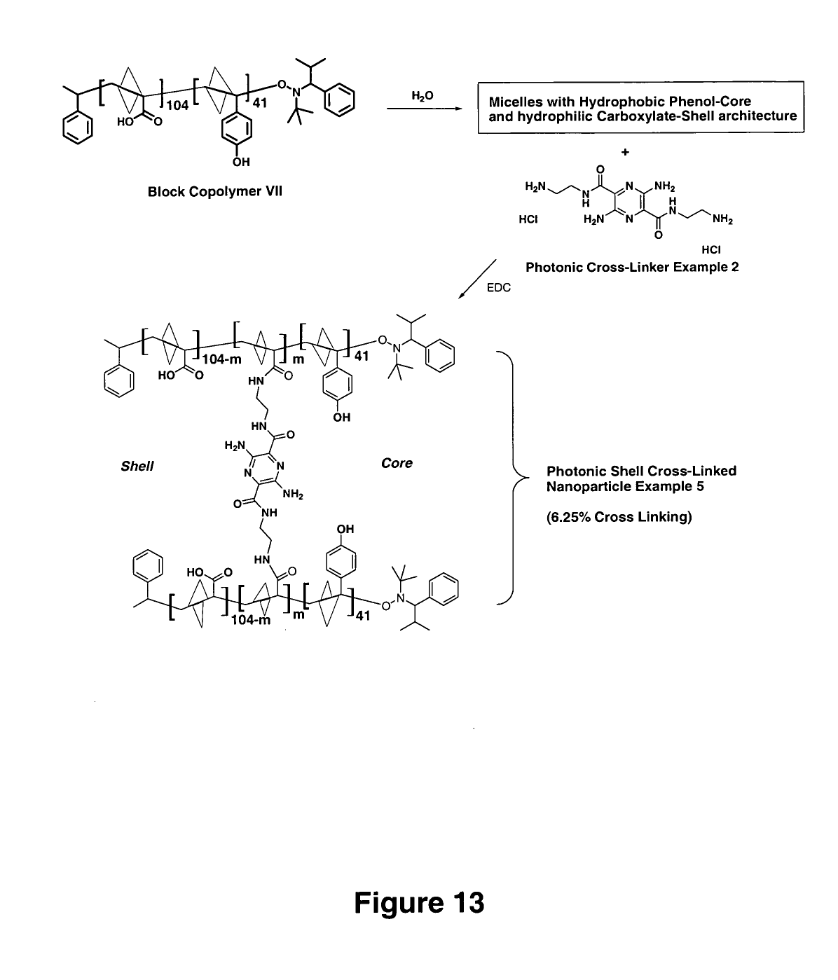

Shell Cross-Linked Nanoparticle Example 5: Optical Fluorescence Output of as a Function of pH. Block Copolymer VII was Cross-Linked with 6.25% Photonic Cross-Linker Example 2 to provide Shell Cross-Linked Nanoparticle Example 5, as illustrated in FIG. 13. As shown in FIG. 18, more than quadruple increase in fluorescence is observed in micelles crosslinked with 6.25 mol % Photonic Cross-Linker Example B as a function of increasing pH.

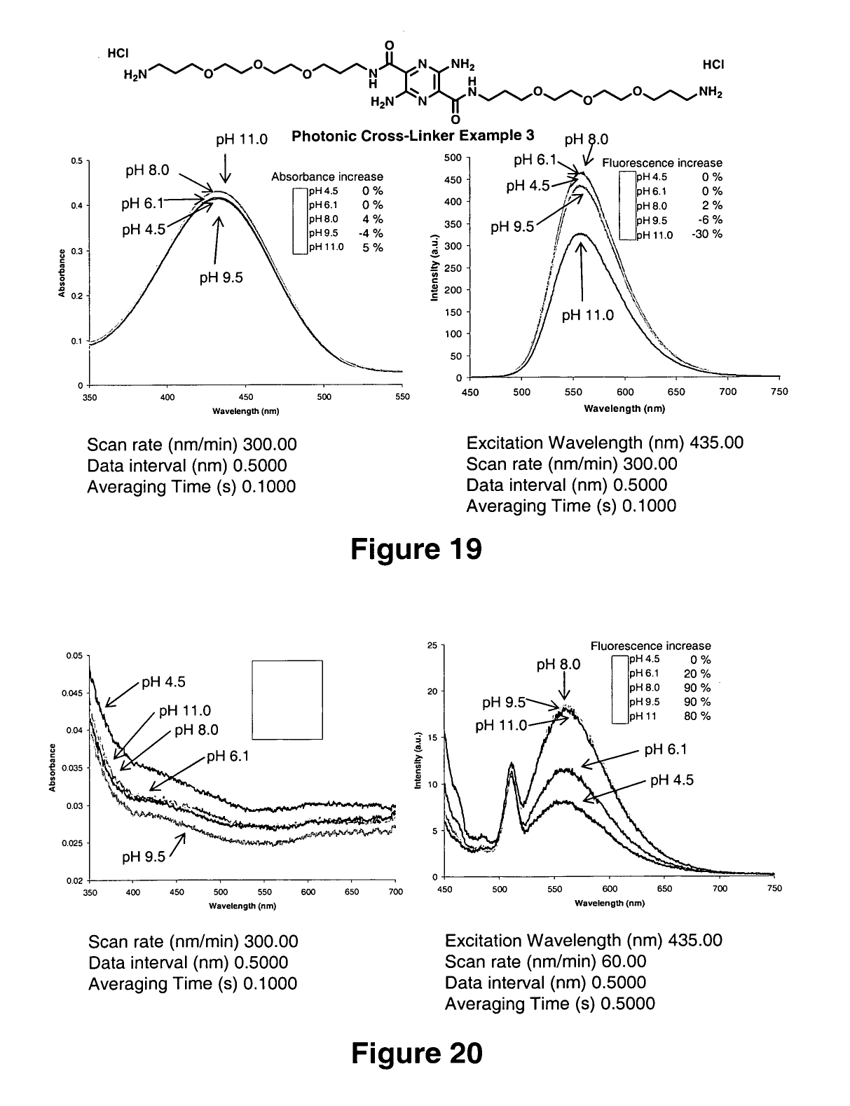

Control Experiment: Change in fluorescence output for Photonic Cross-Linker Example 3 alone (prior to cross-linking into nanoshells), was determined as a function of pH and is shown in FIG. 19. Photonic Cross-Linker Example 3, however, experienced ca. 30% decrease in fluorescence as a function of increasing pH.

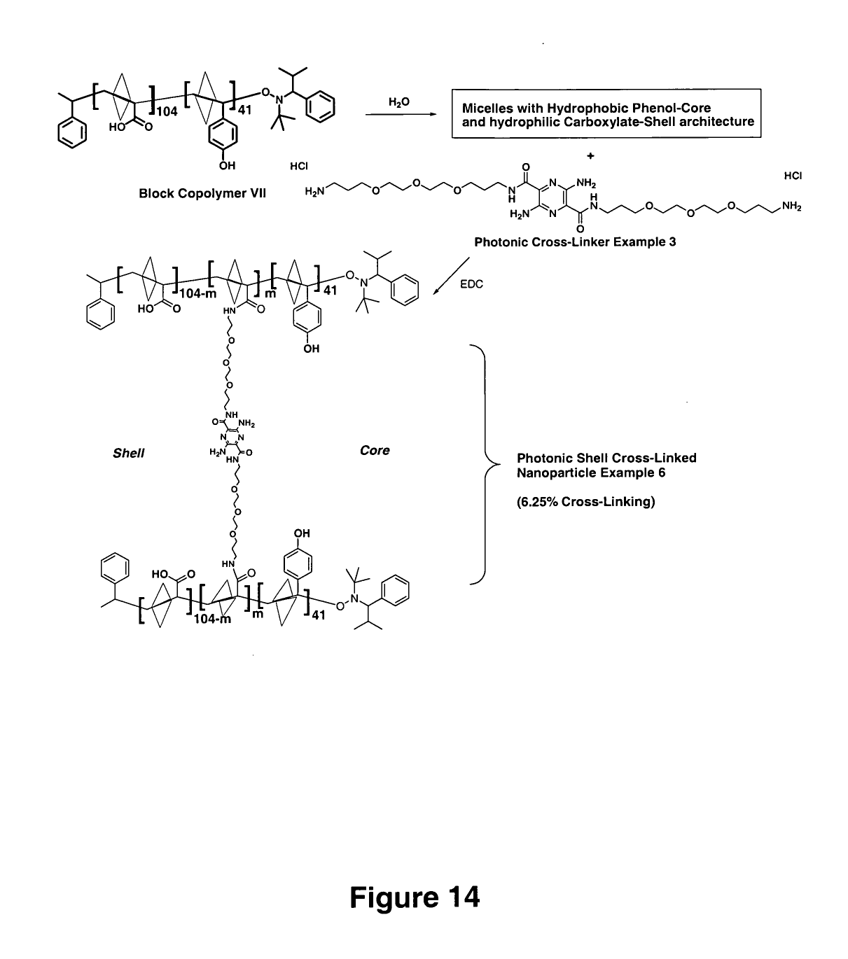

Shell Cross-Linked Nanoparticle Example 6: Optical Fluorescence Output of as a function of pH. Block Copolymer VII was Cross-Linked with 6.25% Photonic Cross-Linker Example 3 to provide Shell Cross-Linked Nanoparticle Example 6, as illustrated in FIG. 14. FIG. 20 shows up to 90% increase in fluorescence is observed in micelles crosslinked with 6.25 mol % Photonic Cross-Linker Example 3 as a function of increasing pH.

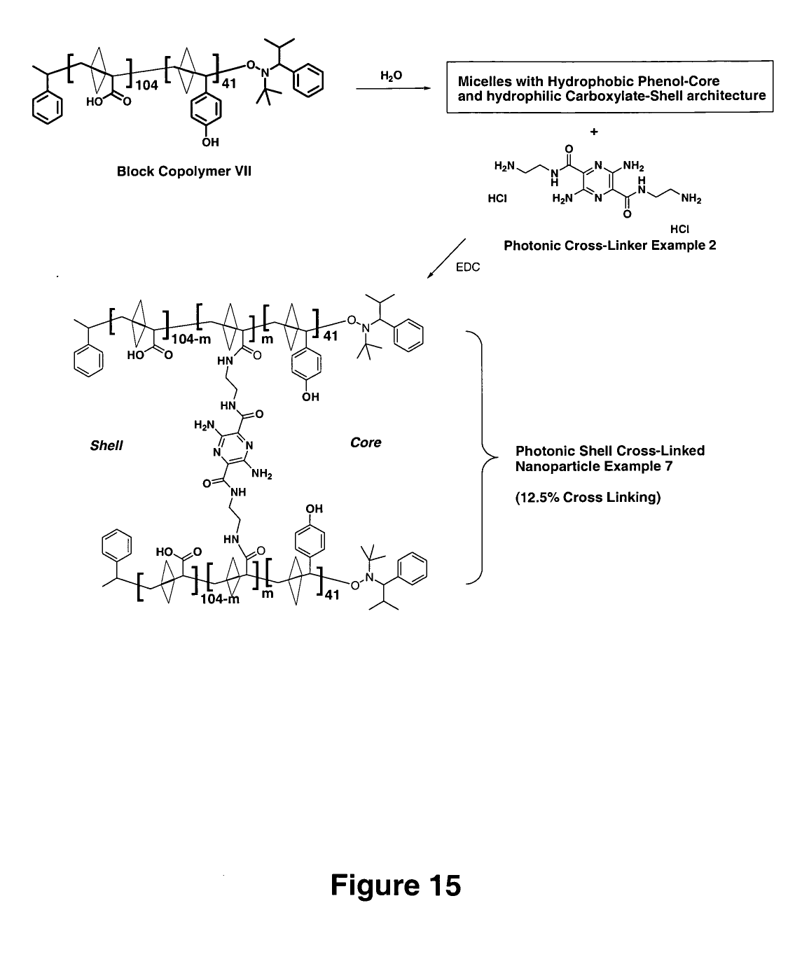

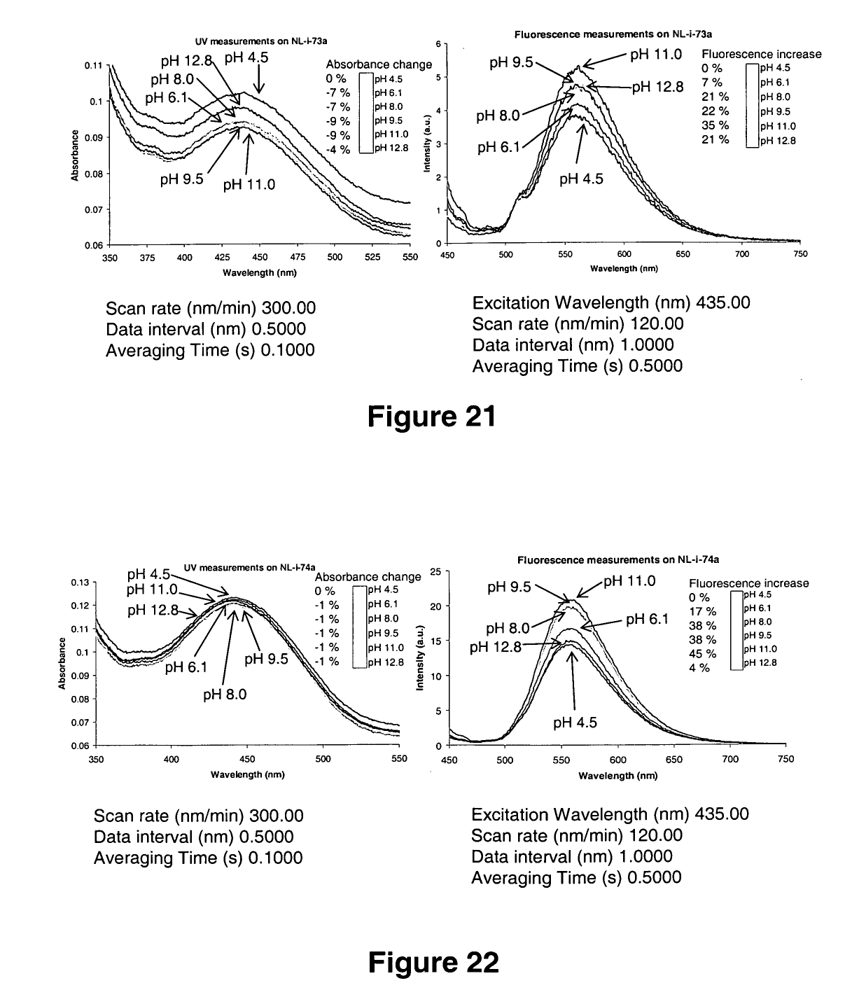

Shell Cross-Linked Nanoparticle Example 7: Optical Fluorescence Output of as a Function of pH. Block Copolymer VII was Cross-Linked with 12.5% Photonic Cross-Linker Example 2 to provide Shell Cross-Linked Nanoparticle Example 7, as illustrated in FIG. 15. FIG. 21 shows a substantial increase in fluorescence output of Shell Cross-Linked Nanoparticle Example 7 throughout physiological pH range. The increase tracks with swelling induced by deprotonation of shell carboxylic acids as pH increases from 4.5-8.0 and again as further swelling is induced by phenolate formation as pH traverses phenol pKa range from 9.5 to 11.0. Decrease of fluorescence upon further increased pH (to 12.8) may result from deprotonation of the pyrazine cross-link NH₂ groups.

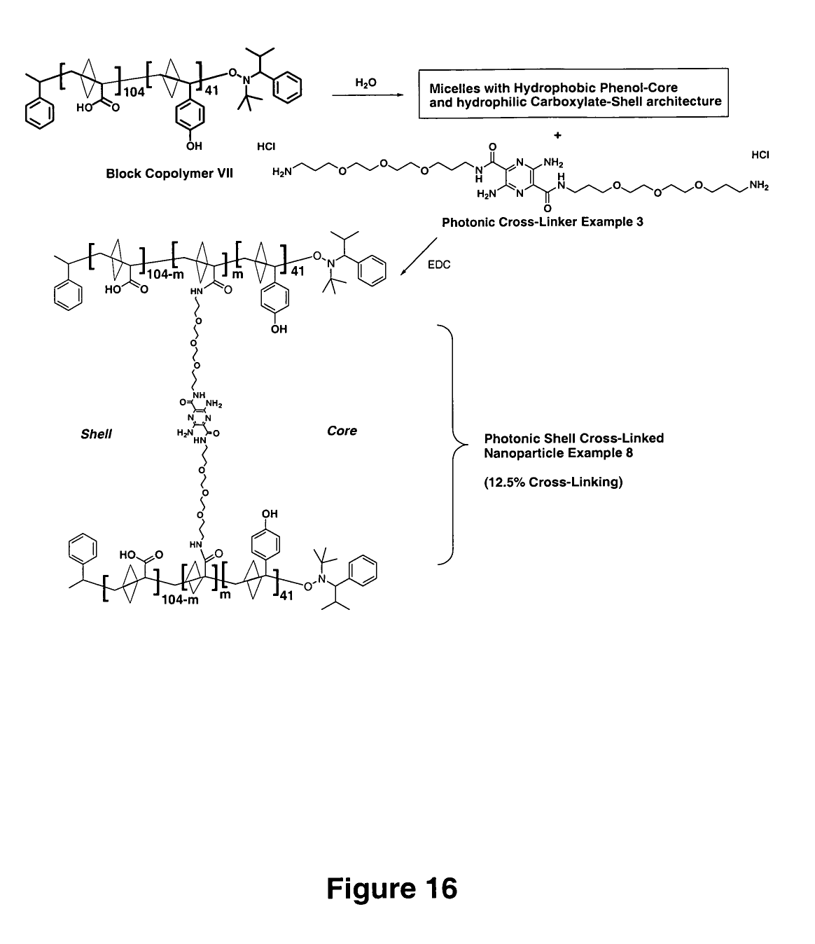

Shell Cross-Linked Nanoparticle Example 8: Optical Fluorescence Output of as a Function of pH. Block Copolymer VII was Cross-Linked with 12.5% Photonic Cross-Linker Example 3 to provide Shell Cross-Linked Nanoparticle Example 8, as illustrated in FIG. 16. As seen in FIG. 22, fluorescence output again increases through physiological pH range as in the previous example.

### Example 4

### Additional Linkage Systems

Additional chemistries were explored to identify further photonic cross-linking systems.

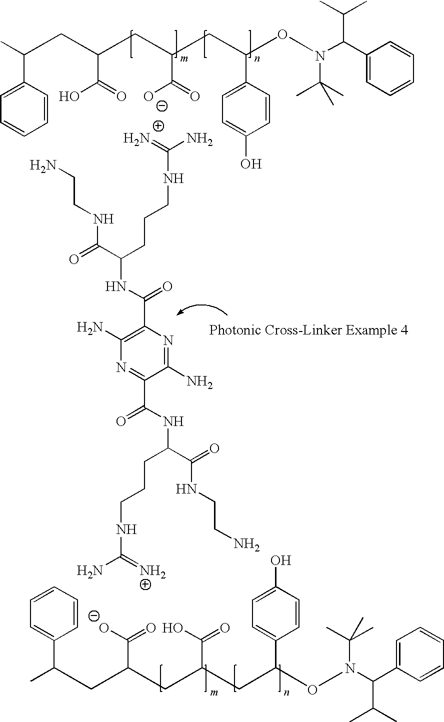

Preassociation of Photonic Cross-Linker Example 4 with Block Copolymer VII. The guanidine groups can form salt bridge coordination with the carboxylate shell region over a large pH range (˜3-12) and facilitate cross-linking. In addition the positive guanidinium charge can modulate surrounding pH and swelling characteristics of the nanoparticle.

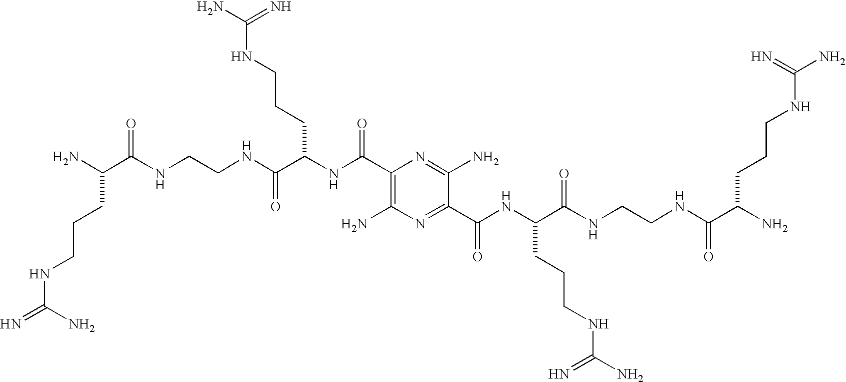

### Photonic Cross-Linker Example 9

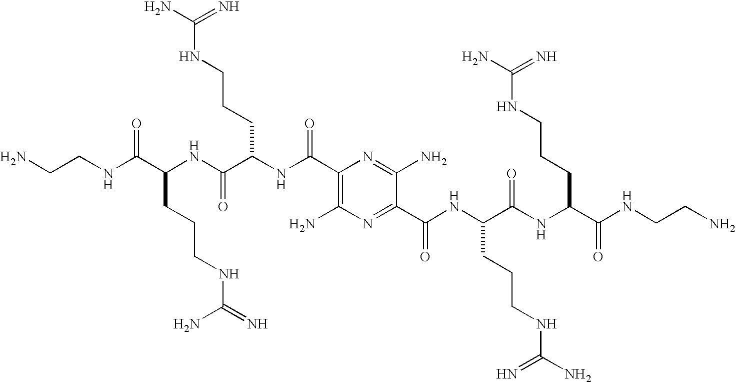

### Photonic Cross-Linker Example 10

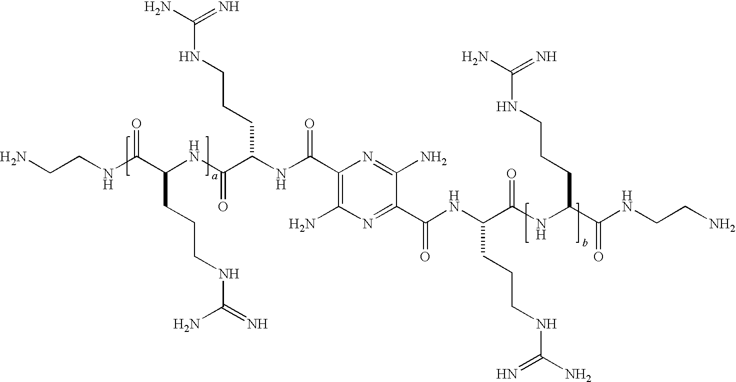

### Photonic Cross-Linker Example 11

### a and b Can be Any Whole Number, Most Preferably 1-7 to generate poly-Arg Containing Cross-Linkers

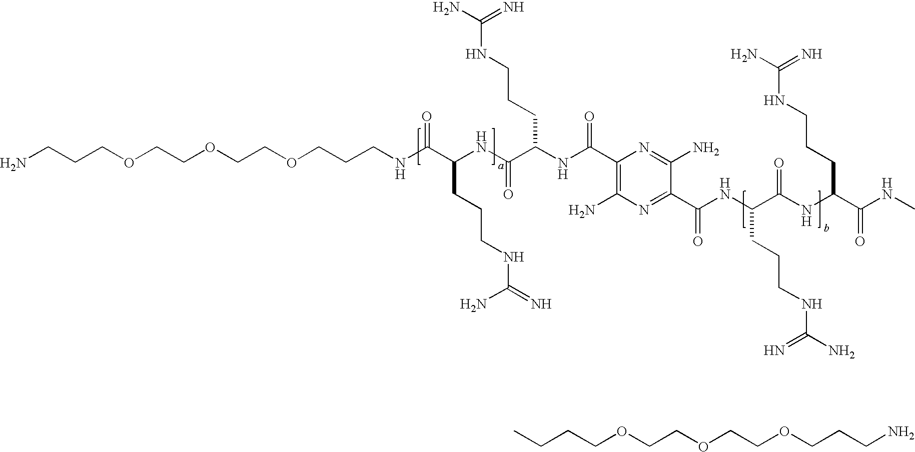

### Photonic Cross-Linker Example 12

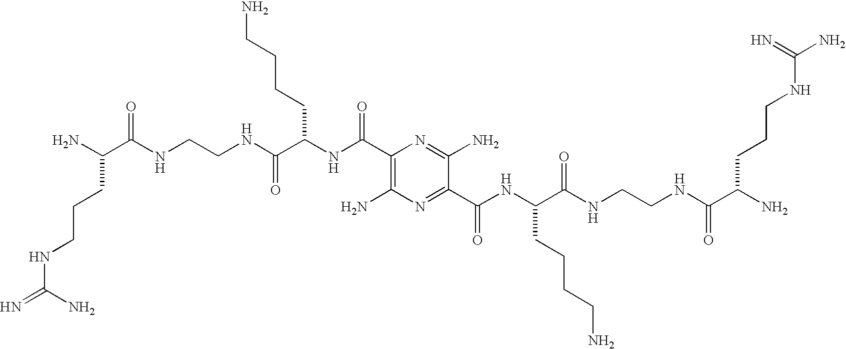

### Photonic Cross-Linker Example 13

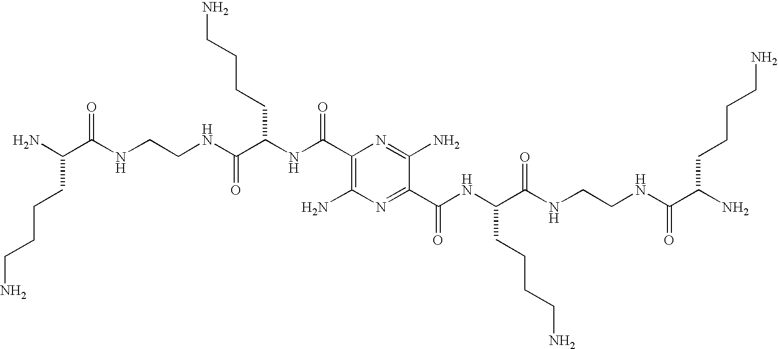

### Photonic Cross-Linker Example 14

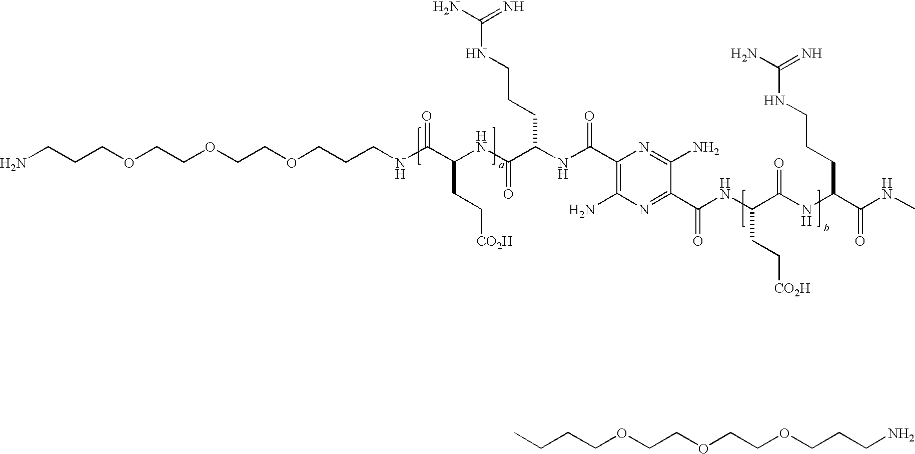

### Photonic Cross-Linker Example 15

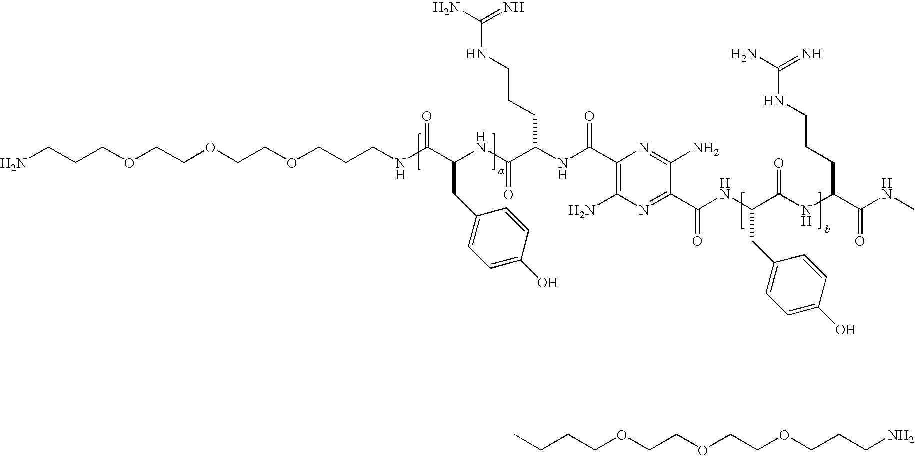

### Photonic Cross-Linker Example 16

### Polyphenols to Modulate pKa's

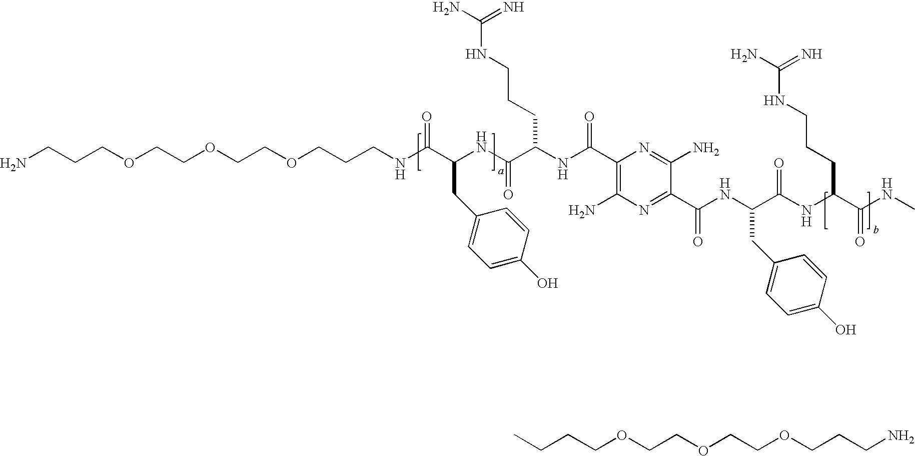

### Photonic Cross-Linker Example 17

### Polyphenol and PolyArg to modulate pKa's

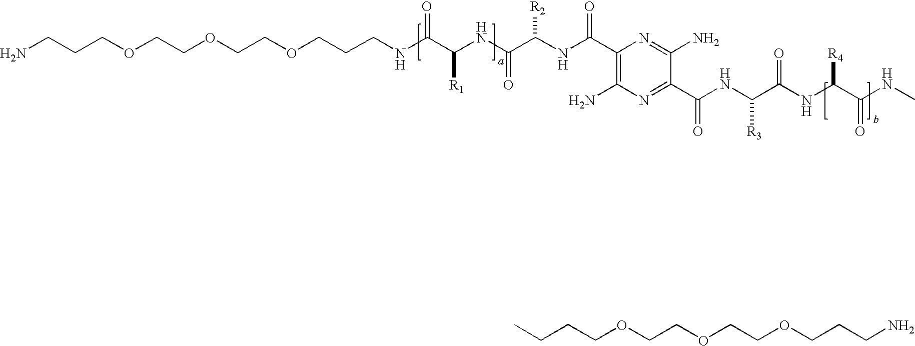

Photonic Cross-Linker General Example 18: R₁, R₂, R₃, R₄ can be ANY natural or unnatural amino acid, in repeating units defined by a and b.

### Example 5

### Construction of Functionalizable, Crosslinked Nanostructures

### Introduction

During the past decade, nanoscale micelles and vesicles assembled from amphiphilic block copolymer precursors have attracted much attention due to their promise for applications in the field of nanomedicine, ranging from controlled delivery of drugs and other diagnostic and therapeutic agents, to targeting of specific diseases and reporting of biological mechanisms via introduction of various functionalities. The thermodynamic stability of such nanoscale systems is only achieved above the critical micelle/vesicle concentration and their stability in vivo is therefore of concern. To overcome this restriction, covalent crosslinking throughout the shell/core domain of micelles or membrane domain of vesicles has been developed and demonstrated as an effective methodology for providing robust nanostructures.

In this Example, functional block copolymer systems were established based on N-acryloxysuccinimide (NAS) monomer building blocks, containing pre-installed active esters as amidation sites. A series of pyrazine-based diamino crosslinkers (Scheme 1 of this Example 5, Cross linkers 1-3) were designed for exploring the potential factors during the reaction with pyrazine acting as a monitoring probe. Furthermore, the photophysical properties of these crosslinked nanostructures were also investigated to explore their potential application for optical imaging and monitoring.

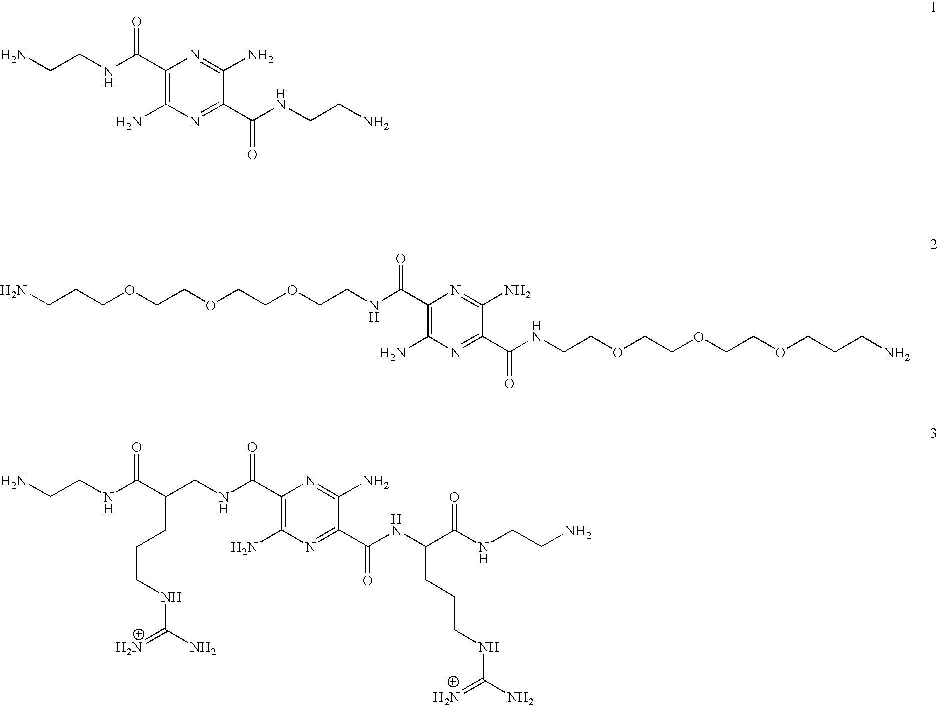

### Scheme 1 of Example 5

### Chemical Structures of Pyrazine-Based Diamino Crosslinkers

### Results and Discussion

As depicted in Scheme 1 of Example 5, well-defined diblock copolymers PEO₄₅-b-PNAS₉₅ and PEO₄₅-b-PNAS₁₀₅ were obtained via reversible addition-fragmentation chain transfer (RAFT) polymerization,³ starting from a PEO₄₅ based macro chain transfer agent (macro-CTA). GPC analyses of these two polymers (Scheme 1 of Example 5, insertions) clearly demonstrated their monomodal molecular weight distributions, even at higher NAS monomer conversions (90% and 95% respectively). Further chain extension with styrene yielded triblock copolymers PEO₄₅-b-PNAS₉₅-b-PS₆₀ (compound 4) and PEO₄₅-b-PNAS₁₀₅-b-PS₅₀ (compound 5).

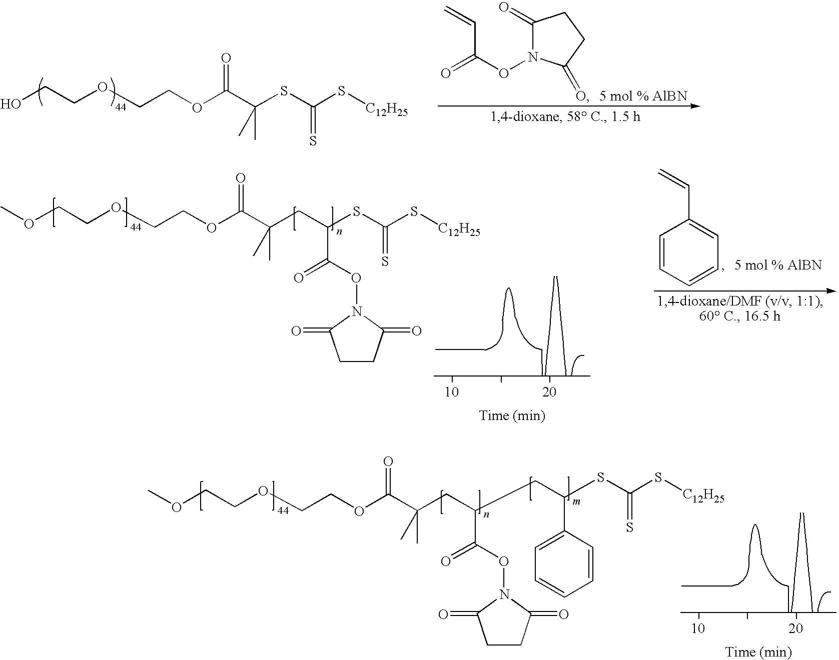

### Scheme 1 of Example 5

Preparation of amphiphilic triblock copolymers. Insertions are DMF SEC profiles for the diblock (top) and triblock (bottom) copolymers.

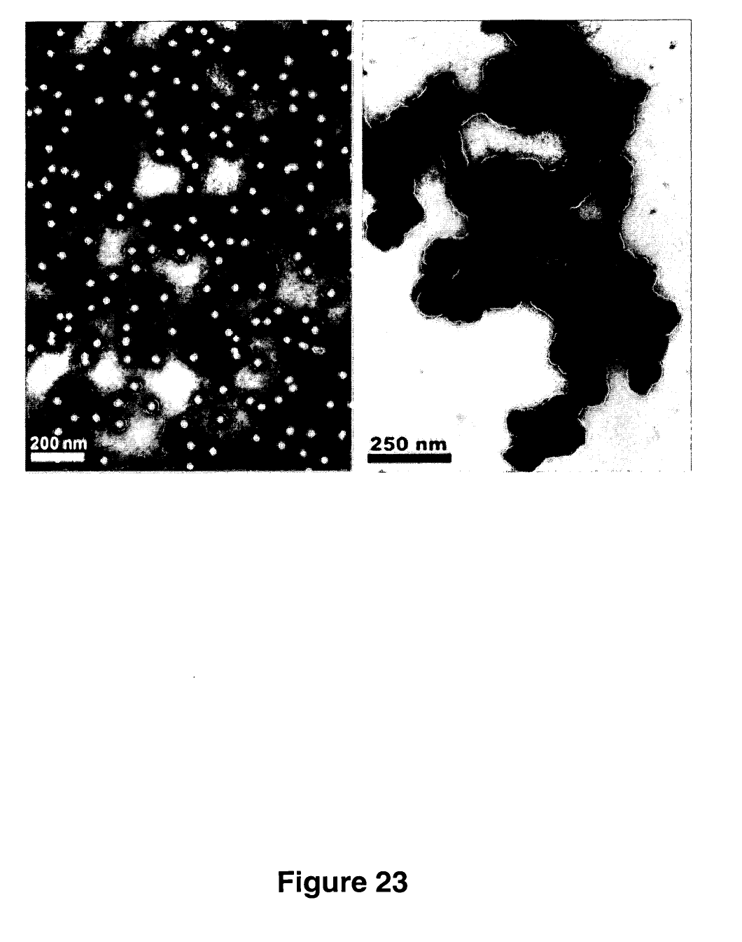

A typical self assembly protocol was employed consisting of addition of water, a selective solvent for PEO, to the polymer precursor solution in DMF, a common solvent for all blocks. Interestingly, compound 4 provided micelles with hydrodynamic diameter of ca. 50 nm, while vesicles with hydrodynamic diameter of ca. 160 nm were generated from the assembly of compound 5 (See, FIG. 23). FIG. 23 provides TEM images of micelles (left) generated from compounds 4 of Example 5 and vesicles (right) generated from compound 5 of Example 5.

The crosslinking/functionalization efficiency for cross linkers 1 and 2 was almost identical, although the hydrophilicity of cross linker 2 was increased. A maximum of 30% actual crosslinking extent was achieved at each nominal extent (20%, 50%, and 100%, respectively). Dramatic improvement to a maximum of 60% actual crosslinking extent at each nominal extent was achieved while using cross linker 3, a crosslinker bearing positive charge. This improvement could be attributed to strong electrostatic interactions between the guanidine moities of the bifunctional bis-arginyl-pyrazine 3, and copolymer NAS-derived carboxylates, generated by partial hydrolysis of active esters during the micellization process. The present invention includes the use of a variety of cross linking moities having one or more natural or non-natural amino acid groups, particularly one or more basic amino acids, such as arginine, lysine, histidine, ornithine, and homoarginine. Thus, pre-coordination of cross linker 3 with the micelles/vesicles via guanidine-carboxylate complexes, resulted in a vast enhancement of inter-strand amide crosslinking reaction efficiency. The morphology of all of these nanoobjects was maintained for micelles and vesicles after crosslinking at the nominal 20% and 50% extents, while different morphologies were observed for crosslinked micelles at the nominal 100% extents.

Photophysical properties of these photonic nanoparticles and vesicles were then measured. For cross linkers 1 and 2, only the nominal 100% crosslinked nanoparticles exhibited similar UV-Vis profiles as the crosslinkers themselves while a blue shift (ca. 35 nm) was observed for the nominal 20% crosslinked micelles. For cross linker 3, blue shift (ca. 40 nm) was also observed for nominal 20% crosslinked micelles, but the nominal 50% crosslinked nanoparticles already displayed identical maximum UV-Vis absorption at 440 nm as the crosslinker. All of these nano-objects showed pH-sensitive fluorescence enhancements up to 300% in the range of pH 5.5 to 8.5. There were no obvious hydrodynamic diameter variations of these nanoparticles and vesicles in the surveyed pH range, as measured by DLS.

A novel amphiphilic triblock copolymer system having a functionalized PNAS segment was established. Further treatments of this functional polymer led to functionalized nanostructures bearing interesting stoichiometric and pH-sensitive photophyscial properties. This method also allowed for the facile quantification of actual crosslinking extents.

This Example highlights the usefulness of controlled radical polymerization of functional monomers to provide well-defined, reactive block copolymers that can be transformed into functional nanoscale objects. Employing reversible addition-fragmentation chain transfer (RAFT) polymerization, well-defined amphiphilic triblock copolymers poly(ethylene oxide)-b-poly(N-acryloxysuccinim ide)-b-polystyrene (PEO-b-PNAS-b-PS) were obtained. These polymer precursors were assembled into highly functionalizable nanoparticles and nano-scale vesicles in aqueous media. After in situ crosslinking with a series of pyrazine-based diamino crosslinkers through amidation, it was revealed that the reaction efficiency varied with the composition and properties of the crosslinkers. The photophysical properties of the pyrazine fluorophore (i.e. UV absorption and fluorescence) were also found to be altered after covalent incorporation into the polymer assemblies. These results not only provided direct “visualization” of the extent of crosslinking, but also demonstrated that the photonic crosslinked nanostructures could be utilized for optical imaging and monitoring.

### REFERENCES

J. Xu, G. Sun, R. Rossin, A. Hagooly, Z. Li, K-I, Fukukawa, B. W. Messmore, D. A. Moore, M. J. Welch, C. J. Hawker, K. L. Wooley, “Labeling of polymer nanostructures for medical imaging: importance of cross-linking extent, spacer length, and charge density,” Macromolecules. 40, 2971-2973 (2007).
Q. Ma, E. E. Remsem, T. Kowalewski, J. Schaefer, K. L. Wooley, “Environmentally-responsive, entirely hydrophilic, shell-cross-linked (SCK) nanoparticles,” Nano Lett. 1, 651-655 (2001).
H. Cui, Z. Chen, S. Zhong, K. L. Wooley, D. J. Pochan, “Block copolymer assembly via kinetic control,” Science. 317, 647-650 (2007).
D. Benoit, V. Chaplinski, R. Braslau, C. J. Hawker, “Development of a universal alkoxyamine for “living” free radical polymerizations,” J. Am. Chem. Soc. 121, 3904-3920 (1999).
Joralemon, M. J.; O'Reilly, R. K.; Hawker, C. J.; Wooley K. L. J. Am. Chem. Soc. 2005, 127, 16892-16899.
Li, Yali; Sun, Guorong; Xu, Jinqi; Wooley, Karen L. Nanotechnology in Therapeutics (2007), 381-407.
Kai Qi, Qinggao Ma, Edward E. Remsen, Christopher G. Clark, Jr., Karen Wooley J. Am. Chem. Soc., 2004, 126, 6599.
Qi Zhang, Edward Remsen, Karen Wooley, J. Am. Chem. Soc. 2000, 122, 3642.
Greenspan, P; Fowler, S. D., Journal of Lipid Research 1985, 26, 781.
M. Barzoukas, M. Blanchard-Desce, J. Chem. Phys. 2000, 113, 3951.
R. K. O'Reilly, C. J. Hawker, K. L. Wooley, Chem. Soc. Rev., 2006, 35, 1068-1083.
A. Walther, A. S. Goldmann, R. S. Yelamanchili, M. Drechsler, H. Schmalz, A. Eisenberg, A. H. E. Muller, Macromolecules, 2008, 41, 3254-3260.
Z. Li, E. Kesselman, Y. Talmon, M. A. Hillmyer, T. P. Lodge, Science, 2004, 306, 98-101
I. W. Hamley, Nanotechnology, 2003, 14, R39—R54.
S. Liu, S. P. Armes, Angew. Chem. Int. Ed. 2002, 41, 1413-1416.
B. P. Binks, R. Murakami, S. P. Armes, S. Fujii, Angew. Chem. Int. Ed. 2005, 44, 4795-4798.
H. Huang; T. Kowalewski; E. E. Remsen; R. Gertzmann; K. L. Wooley, J. Am. Chem. Soc., 1997, 119, 11653-11659.
V. L. Alexeev, A. C. Sharma, A. V. Goponenko, S. Das, I. K. Lednev, C. S. Wilcox, D.
N. Finegold, S. A. Asher, Anal. Chem. 2003, 75, 2316-2323.
X. Xu, A. V. Goponenko, S. A. Asher, J. Am. Chem. Soc. 2008, 130, 3113-3119.

1. An optical agent comprising:
cross linked block copolymers, wherein each of the block copolymers comprises a hydrophilic block and a hydrophobic block; and
linking groups covalently cross linking at least a portion of the hydrophilic blocks of the block copolymers, wherein at least a portion of the linking groups comprise one or more photoactive moieties,
wherein the optical agent forms a supramolecular structure in aqueous solution, the supramolecular structure having an interior hydrophobic core and a covalently cross linked hydrophilic shell, wherein the interior hydrophobic core comprises the hydrophobic blocks of the block copolymers, and the covalently cross linked hydrophilic shell comprises the hydrophilic blocks of the block copolymers.

2. The optical agent of claim 1 wherein the supramolecular structure comprises a shell-cross linked micelle.

3. The optical agent of claim 1 wherein the one or more photoactive moieties comprise one or more fluorophores or chromophores.

4. The optical agent of claim 1 wherein the one or more photoactive moieties comprise one or more visible or near infrared dyes.

5. The optical agent of claim 1 wherein the one or more photoactive moieties comprise one or more fluorophores capable of excitation upon absorption of electromagnetic radiation having wavelengths selected over a range of 400 nanometers to 1300 nanometers, and capable of emission of electromagnetic radiation having wavelengths selected over a range of 400 nanometers to 1300 nanometers.

6. The optical agent of claim 1 wherein the one or more photoactive moieties comprise one or more fluorophores having a Stokes shift selected from the range of 10 nanometers to 200 nanometers.

7. The optical agent of claim 1 wherein the one or more photoactive moieties comprise a phenylxanthene, a phenothiazine, a phenoselenazine, a cyanine, an indocyanine, a squaraine, a dipyrrolo pyrimidone, an anthraquinone, a tetracene, a quinoline, a pyrazine, an acridine, an acridone, a phenanthridine, an azo dye, a rhodamine, a phenoxazine, an azulene, an azaazulene, a triphenyl methane dye, an indole, a benzoindole, an indocarbocyanine, a Nile Red dye, or a benzoindocarbocyanine.

8. The optical agent of claim 1 wherein the one or more photoactive moieties comprise a pyrazine.

9. The optical agent of claim 1 wherein the one or more photoactive moieties comprise one or more photoreactive moieties.

10. The optical agent of claim 1 wherein the one or more photoactive moieties comprise one or more phototherapeutic agents.

11. The optical agent of claim 1 wherein the one or more photoactive moieties comprise a cyanine, an indocyanine, a phthalocyanine, a rhodamine, a phenoxazine, a phenothiazine, a phenoselenazine, a fluorescein, a porphyrin, a benzoporphyrin, a squaraine, a corrin, a croconium, an azo dye, a methine dye, an indolenium dye, a halogen, an anthracyline, an azide, a C₁-C₂₀ peroxyalkyl, a C₁-C₂₀ peroxyaryl, a C₁-C₂₀ sulfenatoalkyl, a sulfenatoaryl, a diazo dye, a chlorine, a naphthalocyanine, a methylene blue, or a chalcogenopyrylium analogue.

12. The optical agent of claim 1 wherein the supramolecular structure is a micelle, a vesicle, a bilayer, a folded sheet, a tubular micelle, a toroidal micelle, or a discoidal micelle.

13. The optical agent of claim 1 further comprising a therapeutic agent at least partially encapsulated by the supramolecular structure, wherein the therapeutic agent is non-covalently associated with the hydrophobic core.

14. The optical agent of claim 13 wherein the therapeutic agent is a cyanine, an indocyanine, a phthalocyanine, a rhodamine, a phenoxazine, a phenothiazine, a phenoselenazine, a fluorescein, a porphyrin, a benzoporphyrin, a squaraine, a corrin, a croconium, an azo dye, a methine dye, an indolenium dye, a halogen, an anthracyline, an azide, a C₁-C₂₀ peroxyalkyl, a C₁-C₂₀ peroxyaryl, a C₁-C₂₀ sulfenatoalkyl, a sulfenatoaryl, a diazo dye, a chlorine, a naphthalocyanine, a methylene blue, or a chalcogenopyrylium analogue.

15. The optical agent of claim 1 further comprising one or more targeting ligands bonded to the hydrophilic blocks of at least a portion of the block copolymers.

16. The optical agent of claim 15 wherein the targeting ligand is a peptide, a protein, an oligonucleotide, an antibody, a carbohydrate, a hormone, a lipid, or a drug.

17. The optical agent of claim 1 wherein the optical agent is a shell-cross linked micelle having a cross sectional dimension selected from a range of 5 nanometers to 100 nanometers.

18. The optical agent of claim 1 wherein the hydrophilic block, hydrophobic block, or linking group comprises one or more functional groups responsive to pH, wherein the supramolecular structure undergoes a change in structure in response to a change in the pH of the aqueous solution.

19. The optical agent of claim 1 wherein the hydrophilic block, hydrophobic block, or linking group comprises one or more acidic or basic functional groups responsive to pH, wherein the supramolecular structure undergoes a change in volume in response to a change in the pH of the aqueous solution.

20. The optical agent of claim 1 wherein the mole ratio of the linking groups to monomers of the hydrophilic blocks is selected over a range of 1:100 to 75:100.

21. The optical agent of claim 1 wherein the block copolymers are diblock copolymers or triblock copolymers.

22. The optical agent of claim 1 wherein the hydrophobic block is a poly(p-hydroxystyrene) polymer block; a polystyrene polymer block; a polyacrylate polymer block, a poly(propylene glycol) polymer block; a poly(amino acid) polymer block; a poly(ester) polymer block; a poly (ε-caprolactone) polymer block, or a phospholipid; or a copolymer thereof.

23. The optical agent of claim 1 wherein the hydrophilic block is a poly(acrylic acid) polymer block, a poly(N-(acryloyloxy)succinimide) polymer block; a poly(N-acryloylmorpholine) polymer block; a poly(ethylene glycol) polymer block, poly(p-vinyl benzaldehyde) block or a poly(phenyl vinyl ketone) block; or a copolymer thereof.

24. The optical agent of claim 1 wherein the hydrophilic block is a poly(acrylic acid) polymer block, and the linking groups are bound to monomers of the poly(acrylic acid) polymer block by carboxamide bonds.

25-68. (canceled)
